(19) United States
(12) Patent Application Publication
(10) Pub. No.: US 2021/0389513 A1
(43) Pub. Date: Dec. 16, 2021

(54) LIQUID CRYSTAL OPTICAL ELEMENT AND FABRICATION METHOD THEREOF

(71) Applicant: Facebook Technologies, LLC, Menlo Park, CA (US)

(72) Inventors: Junren WANG, Redmond, WA (US); Ryan LI, Woodinville, WA (US); Lu LU, Kirkland, WA (US)

(21) Appl. No.: 16/899,642

(22) Filed: Jun. 12, 2020

(51) Int. Cl. G02B 5/30

(52) U.S. Cl. CPC G02B 5/3016

(57) ABSTRACT

An optical device is provided. The optical device includes a first birefringent film formed on a substrate, a first barrier film formed on the first birefringent film, and a second birefringent film formed on the first barrier film. The first birefringent film includes a first birefringent material. The second birefringent film includes a second birefringent material.

### TECHNICAL FIELD

The present disclosure generally relates to optical devices and, more specifically, to a liquid crystal optical element and a fabrication method thereof.

### BACKGROUND

Birefringent materials having a chirality have been used in various optical elements or devices. As a type of birefringent materials having a chirality, cholesteric liquid crystals (“CLCs”), also known as chiral nematic liquid crystals, have been used in optical elements, to reflect or transmit a circularly polarized incident light depending on the handedness of the incident light. For example, CLCs may be configured to primarily or substantially reflect a polarized light having a same handedness as that of a helical twist structure of the CLCs, and primarily or substantially transmit a polarized light having a handedness opposite to that of the helical twist structure of the CLCs. Due to the handedness selectivity of the CLCs, a CLC layer (or a CLC film, a CLC plate, etc.) or a CLC layer stack may function as a circular reflective polarizer. For example, a circular reflective polarizer including left-handed CLCs (“LHCLCs”) may primarily or substantially reflect a left-handed circularly polarized (“LHCP”) light and primarily or substantially transmit a right-handed circularly polarized (“RHCP”) light, and a circular reflective polarizer including right-handed CLCs (“RHCLCs”) may primarily or substantially reflect a right-handed circularly polarized (“RHCP”) light and primarily or substantially transmit a left-handed circularly polarized (“LHCP”) light. CLCs can be configured to function over a broad bandwidth (or spectrum) such that lights having different wavelengths within the spectrum can be reflected or transmitted. Circular reflective polarizers based on CLCs may be used as multifunctional optical components in a large variety of applications, such as polarization management components, brightness enhancement components, optical path-folding components, etc.

### SUMMARY

Consistent with an aspect of the present disclosure, an optical device is provided. The optical device includes a first birefringent film formed on a substrate, a first barrier film formed on the first birefringent film, and a second birefringent film formed on the first barrier film. The first birefringent film includes a first birefringent material. The second birefringent film includes a second birefringent material.

Consistent with another aspect of the present disclosure, a method for fabricating an optical device is provided. The method includes dispensing a first composition on a substrate and polymerizing the first composition to form a first birefringent film on the substrate. The first birefringent film includes a first birefringent material. The method also includes dispensing a second composition to form a first barrier film on the first birefringent film. The method further includes dispensing a third composition on the first barrier film and polymerizing the third composition to form a second birefringent film on the first barrier film. The second birefringent film includes a second birefringent material.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A illustrates a schematic diagram of a director configuration in cholesteric liquid crystals (“CLCs”), according to an embodiment of the present disclosure;

FIG. 1B illustrates polarization selective reflectivity of the CLCs, according to an embodiment of the present disclosure;

FIGS. 2A-2F illustrate schematic diagrams showing processes for fabricating a birefringent film stack, according to an embodiment of the present disclosure;

FIGS. 3A-3E illustrate cross-sectional views of birefringent films, according to various embodiments of the present disclosure;

FIGS. 4A-4D illustrate schematic diagrams showing processes for fabricating a birefringent film stack, according to another embodiment of the present disclosure;

FIGS. 5A-5F illustrate schematic exploded perspective views of birefringent film stacks, according to various embodiments of the present disclosure;

FIG. 6 illustrates a flow chart showing a method for fabricating a birefringent film stack, according to an embodiment of the present disclosure;

FIG. 7 illustrates a flow chart showing a method for fabricating a birefringent film stack, according to another embodiment of the present disclosure;

FIG. 8A illustrates a cross-sectional view of a birefringent film, according to an embodiment of the present disclosure;

FIG. 8B illustrates a portion of the cross-sectional view of the birefringent film shown in FIG. 8A, according to an embodiment of the present disclosure;

FIG. 8C illustrates a cross-sectional view of a birefringent film, according to another embodiment of the present disclosure;

FIG. 8D illustrates a cross-sectional view of a birefringent film, according to another embodiment of the present disclosure;

FIG. 9A illustrates a schematic diagram of a pancake lens assembly, according to an embodiment of the present disclosure;

FIG. 9B schematically illustrates a cross-sectional view of an optical path of the pancake lens assembly shown in FIG. 9A, according to an embodiment of the present disclosure;

FIG. 10A illustrates a diagram of a near-eye display (“NED”), according to an embodiment of the present disclosure; and

FIG. 10B illustrates a cross sectional view of a front body of the NED shown in FIG. 10A, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When the first element is shown or described as being disposed, formed, or otherwise arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed, formed, or otherwise arranged at any suitable orientation relative to the second element (e.g., over or above the second element, below or under the second element, left to the second element, right to the second element, behind the second element, in front of the second element, etc.).

When the first element is described as being formed “on” the second element, the first element may be directly or indirectly formed on the second element. The first element being directly formed on the second element indicates that no additional element (e.g., a separate adhesive layer or another optical film) is formed between the first element and the second element. The first element being indirectly formed on the second element indicates that there is one or more additional elements (e.g., a separate adhesive layer or film, an alignment structure or layer, etc.) between the first element and the second element. When the first element is described as being formed on the second element, the term “formed” means that the first element is fabricated on the second element, rather than being pre-formed or pre-fabricated elsewhere and then laminated (or attached, affixed, bonded, mounted) onto the second element through, e.g., an adhesive. In the present disclosure, “forming” a first element on a second element is different from “laminating” (or attaching, affixing, bonding, mounting) a pre-formed or pre-fabricated first element onto a second element. The term “film” as used herein may be exchangeable with the term “layer,” “coating,” or “plate.”

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“ROM”), a flash memory, etc.

The present disclosure provides a method for fabricating a birefringent film stack (or a stack of birefringent films) in simple and efficient processes. The fabricated birefringent film stack may include features such as thin thickness, compactness, improved surface uniformity and durability, and enhanced optical performance, etc. The fabrication method may include alternatingly forming a plurality of birefringent films (or layers) and a plurality of barrier films (or layers) on a surface of a substrate. One or more barrier films may be formed between two adjacent birefringent films. The barrier film may be configured with multiple functions. For example, the barrier film may function as a barrier to reduce or suppress molecule diffusion across adjacent birefringent films, thereby reducing or suppressing interactions or interferences between adjacent birefringent films. As a result, the barrier film disposed between adjacent birefringent films may reduce or suppress various deformations of the birefringent films, such as contraction (or shrink), and/or swelling (or expansion). Furthermore, the surface roughness may be reduced. Accordingly, the surface uniformity of the birefringent film stack may be improved.

In some embodiments, the barrier film may protect underlying films or layers from corrosion and contamination, thereby improving component durability and process yield. For example, the barrier film may also be configured to provide other barrier or protective functions against permeation of undesirable substance into the birefringent film, e.g., moisture, oxygen, corrosive species, and/or grease. In some embodiments, the barrier film may function as a primer layer to further improve the surface roughness and uniformity. In some embodiments, the barrier film may be configured to enhance a bonding or adhesion between two adjacent birefringent films. The barrier film may be rigid or flexible. The barrier film may be flat or curved. The barrier film may be isotropic or anisotropic. In some embodiments, the barrier film may have a refractive index matching with a refractive index (or refractive indices) of one or both birefringent films separated by the barrier film. In some embodiments, the barrier film may have a refractive index that does not math with a refractive index (or refractive indices) of one or both birefringent films separated by the barrier film to suppress a predetermined polarization. In some embodiments, the barrier film may be configured to improve the mechanical hardness while maintaining flexibility.

In some embodiments, the barrier film may include a water-borne barrier coating, a solvent-borne or solvent based barrier coating, a solventless or solvent-free barrier coating, a sol-gel barrier coating, or any combination thereof. The barrier coating may include an organic coating such as epoxies, alkyds, acrylics, etc., or an inorganic coating such as silicon dioxide, oxides, nitrides, carbides, etc., or an organic-inorganic hybrid coating, or a combination of an organic coating and an inorganic coating. In some embodiments, the barrier film may include or may be doped with ultraviolet (“UV”) stabilizers to improve the UV stability or reliability of the birefringent films. In some embodiments, the UV stabilizers may include UV absorbers and hindered-amine light stabilizers (“HALS”).

A barrier film or layer disclosed herein may be different from a typical adhesive film or layer, such as a liquid adhesive or an adhesive tape used in the conventional processes of laminating films. The molecule diffusion suppression function, the interaction (or interference) suppression function, and/or the primer function provided by the barrier film may not be provided by a typical adhesive film or layer. For example, at least the molecule diffusion suppression function and/or the interaction (or interference) suppression function of the barrier film may not be provided by the typical adhesive film. In some embodiments, the barrier film may also be provided with an alignment function. For example, the barrier film may include photosensitive materials (in addition to other materials for providing other functions) configured to provide an alignment function for aligning optically anisotropic molecules included in the birefringent film disposed on the barrier film. In such embodiments, the barrier film may also function as an alignment layer, film, or structure.

The birefringent film may include a liquid crystal polymer (“LCP”) film. The LCP film may include polymerized (or cross-linked) liquid crystals (“LCs”), polymer-stabilized LCs, photo-reactive LC polymers, or any combination thereof. The LCs may include nematic LCs, twist-bend LCs, chiral nematic LCs, smectic LCs, or any combination thereof. The birefringent film may include optically anisotropic molecules configured with a predetermined three-dimensional (“3D”) orientational pattern. In some embodiments, the birefringent film may include a birefringent material having a chirality. Optically anisotropic molecules of the birefringent material may be arranged in a helical twist structure. In some embodiments, the chirality of the birefringent material may be introduced by chiral dopants doped into a host birefringent material, e.g., a nematic liquid crystal (“LC”) host. In some embodiments, the chirality of the birefringent material may be a property of the birefringent material itself, such as an intrinsic molecular chirality. For example, the birefringent material may include chiral crystal molecules, or the birefringent material may include molecules having one or more chiral functional groups. In some embodiments, the birefringent material with a chirality may include twist-bend nematic LCs (or LCs in twist-bend nematic phase), in which the LC directors may exhibit periodic twist and bend deformations forming a conical helix with doubly degenerate domains having opposite handedness. The LC directors of twist-bend nematic LCs may be tilted with respect to the helical axis. Thus, twist-bend nematic phase may be considered as the generalized case of the conventional nematic phase in which the LC directors are orthogonal with respect to the helical axis.

In some embodiment, the fabrication method may also include forming a plurality of alignment structures (also referred to as alignment films or alignment layers) prior to forming the respective birefringent films, which may be formed on the alignment structures. For example, an alignment structure may be formed on a surface of the substrate before a birefringent film is formed on the alignment structure. When multiple birefringent films are formed, multiple alignment structures may be formed first, and the respective birefringent films may be formed on the respective alignment structures. In some embodiments, an alignment structure may be formed on a barrier film before a birefringent film is formed on the alignment structure. In some embodiments, a birefringent film may be formed directly on the respective alignment structure. That is, the birefringent film may be in direct contact with a surface of the respective alignment structure.

The respective alignment structure may provide a respective alignment (or alignment pattern) to molecules included in the respective birefringent film formed on the alignment structure. In some embodiments, the alignment structure may be configured to at least partially align optically anisotropic molecules of the birefringent material that are in close proximity to the alignment structure (including those in contact with the alignment structure in a predetermined alignment or alignment pattern. Molecules aligned in the alignment pattern may include a specific azimuthal angle in a plane perpendicular to a thickness direction and a specific pretilt angle (which may be in a range of [0°, 90° ]) relative to the plane. The 3D orientational pattern refers to overall orientations of the optically anisotropic molecules in the entire volume of the birefringent film. The alignment pattern refers to the orientations provided by the alignment structure to the optically anisotropic molecules that are in close proximity to the alignment structure (including those in contact with the alignment structure). When an alignment structure is included to at least partially align the optically anisotropic molecules, the 3D orientational pattern of the optically anisotropic molecules of the birefringent film may include the orientations of the optically anisotropic molecules that are in close proximity to the alignment structure, and also include the orientations of the molecules that are distant from the alignment structure in the volume of the birefringent film. In some embodiments, the 3D orientational pattern may be photo-induced, and the alignment structure may be omitted.

In a conventional technology, a birefringent film stack is typically fabricated by physically laminating pre-formed or pre-fabricated birefringent films together, e.g., in direct contact with one another or through an adhesive. The adhesive (e.g., a liquid adhesive) may be cured (e.g., thermally-cured or photo-cured) to solidify. The curing process may cause the adhesive to shrink or expand, depending on the property of the adhesive material, which in turn may cause the pre-fabricated films bonded by the adhesive also to shrink or expand. The shrinking or expansion in the pre-fabricated films may cause one or more optical properties (or parameters) of the pre-fabricated films to change, thereby degrading the optical performance. In addition, when laminating the pre-fabricated films, the films have to be positioned or aligned relative to one another at a predetermined precision. There are often errors in the positioning precision, which may adversely affect the optical performance. The application of the adhesive between films may also affect the positioning precision. Thus, the conventional laminating technology is inefficient for fabricating birefringent film stacks that include a relatively large number of films (e.g., three, four, five, six, seven, eight, nine, ten, or more than ten). In addition, as the number of films in a stack increases, the surface roughness of the stack fabricated by the conventional laminating technology further increases, and the optical performance further degrades.

The disclosed fabrication method includes forming a stack of birefringent films with one or more barrier films formed therebetween. In forming the stack, a first birefringent film may be formed on a substrate. In some embodiments, a first alignment structure may be formed on the substrate first, and the first birefringent film may be formed on the first alignment structure. A barrier film may be formed on the first birefringent film. A second birefringent film may be formed on the barrier film. In some embodiments, a second alignment structure may be formed on the barrier film first, then the second birefringent film may be formed on the second alignment structure. The processes may be repeated for forming additional birefringent films with barrier films formed therebetween.

The disclosed processes of forming one film over another, rather than laminating pre-fabricated films, can reduce the errors in the positioning precision of pre-fabricated films, as in the conventional technologies. The barrier film may represent a type of surface different from a surface of the birefringent film, and may be configured to have a surface and/or wetting property different from that of the surface of the birefringent film. Thus, with one or more barrier films formed between adjacent birefringent films (or between a birefringent film and an alignment film), interactions between the adjacent films (e.g., between two birefringent films or a birefringent film and an alignment film) can be suppressed or reduced by the barrier films. The barrier films may have a thickness in the range of 1 to 10 micrometers or even sub-micrometer (e.g., less than 1 micrometer). The barrier films are thinner than typical adhesive films used in the conventional laminating processes. Thus, the disclosed fabrication method may reduce the thickness of the birefringent film stack through using the barrier films. In addition, in some embodiments, by omitting a separate adhesive layer, the interface reflection within a birefringent film stack fabricated with the disclosed fabrication method may be reduced. The disclosed fabrication method may reduce the complexity of the manufacturing processes and improve the uniformity of the birefringent film stacks. For example, the disclosed method provides simplified processes for manufacturing birefringent film stacks having multiple birefringent films (e.g., 2-10 films or more than 10 films). As a result, manufacturing costs may be reduced, and quality of the birefringent film stacks can be improved.

The disclosed fabrication processes provide a robust process for mass production of birefringent film stacks at a lower cost and higher efficiency. For example, the multiple films or layers, such as birefringent films and barrier films (and alignment structures when included in the stack), may be formed on the substrate sequentially through suitable processes for the corresponding films. For example, in some embodiments, a first film may be formed on a substrate by disposing (e.g., coating, depositing, etc.) a first material or composition as a thin layer, and processing (e.g., curing, drying, rubbing, and/or subjecting to a light irradiation, etc.) to form the first film. A second film may be formed on the first film by disposing a second material or composition as a thin layer on the first film, and processing the coated thin layer to form the second film. The processes may be repeated for additional layers or films. In some embodiments, the barrier films may be formed by a suitable deposition method, such as a chemical vapor deposition (“CVD”) method, which may include depositing a material or composition to form the barrier film. The processing step may be omitted. The fabricated birefringent film stack may have a reduced weight, an improved surface roughness, and enhanced optical performance and reliability.

Optical characteristics of the fabricated birefringent film stack may be configured through configuring the optical characteristics of the birefringent films. For example, the optical characteristics of a birefringent film may be configured through configuring the helical twist structure of the birefringent film. The birefringent film stack may function as various optical elements for various applications in a number of technical fields, which are all within the scope of the present disclosure. In some embodiments, the birefringent film stack may function as a reflective polarizer configured to selectively reflect or transmit a circularly or an elliptically polarized incident light, depending on a handedness of the circularly or elliptically polarized incident light and a handedness of the helical twist structure of the birefringent film stack. The reflection band of the reflective polarizer may be configured through configuring the individual birefringent films, such as by choosing desirable birefringent materials included in each birefringent film, configuring the helical twist structure (e.g., pitch) of each birefringent film, configuring the thickness of each birefringent film, configuring the number of birefringent films, etc.

In some embodiments, the birefringent film stack may be configured to function as a broadband reflective polarizer, with a reflection band ranging from an ultraviolet (“UV”) spectrum to a visible spectrum and to an infrared (“IR”) spectrum. In some embodiments, the reflection band may be within the UV spectrum. In some embodiments, the reflection band may be within the visible spectrum. In some embodiments, the reflection band may be in the IR spectrum. In some embodiments, the reflection band may cover at least two of the UV spectrum, the visible spectrum, and the IR spectrum. In some embodiments, the birefringent film stack may be configured to function as a narrowband reflective polarizer to reflect lights in a predetermined narrow band in, e.g., the UV spectrum (or a portion of the UV spectrum), the visible spectrum (or a portion of the visible spectrum), or the IR spectrum (or a portion of the IR spectrum). In some embodiments, the birefringent film stack may function as a reflective polarizer configured to separate (or split) two circularly polarized components (e.g., a left-handed circularly polarized component and a right handed circularly polarized component) of an unpolarized incident light or a linearly polarized incident light. One circularly polarized component with a specific handedness may be primarily reflected by the birefringent film stack and the other circularly polarized component with an opposite handedness may be primarily transmitted by the birefringent film stack.

In some embodiments, the birefringent film stack disclosed in the present disclosure may function as an optical diffuser. In some embodiments, the optical diffuser may be configured to provide a directional scattering, rather than a random scattering, to an incident light. For example, the optical diffuser may be configured to primarily backwardly scatter a circularly polarized incident light having the same handedness as that of the helical twist structure of the birefringent film stack. The optical diffuser may be configured to primarily forwardly scatter a circularly polarized incident light having a handedness opposite to that of the helical twist structure of the birefringent film stack. The optical diffuser may be configured to improve uniformity of lights illuminating an object, and/or to improve visibility of an image created by an optical system including the birefringent film stack from a wider range of angles.

In some embodiments, the birefringent film stack may function as a grating stack including a plurality of diffraction gratings configured with various angular spectra and/or wavelength spectra. In some embodiments, the grating stack may be configured for spatial- and/or time-multiplexing different portions of a field of view (“FOV”) of a single-color image or a multi-color image. In some embodiments, the grating stack may be configured for spatial- and/or time-multiplexing different colors of a multi-color image.

In the following descriptions, for illustrative purposes, cholesteric liquid crystals (“CLCs”) are used as an example of the birefringent material. A cholesteric liquid crystal (“CLC”) layer stack is used as an example of the birefringent film stack. Nematic LC molecules are used as an example of the optically anisotropic molecules included in the birefringent material. In some embodiments, birefringent film stack may be fabricated based on other suitable birefringent material, following the same fabrication processes for the CLC layer stack described below.

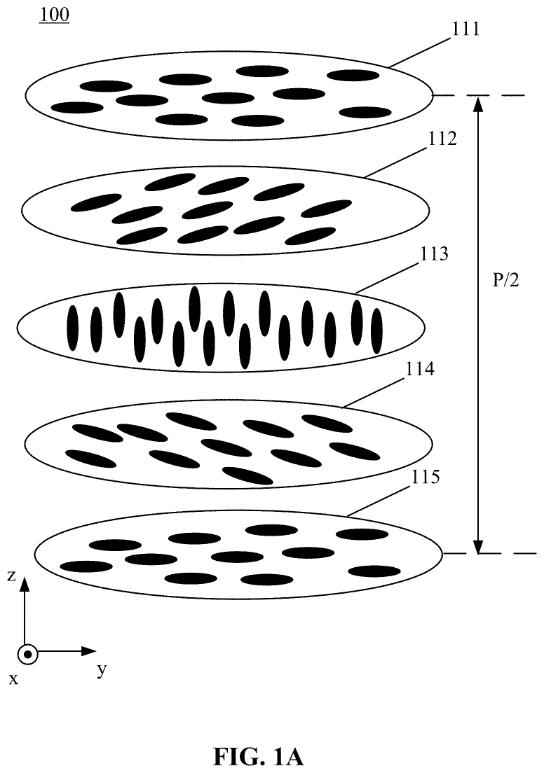

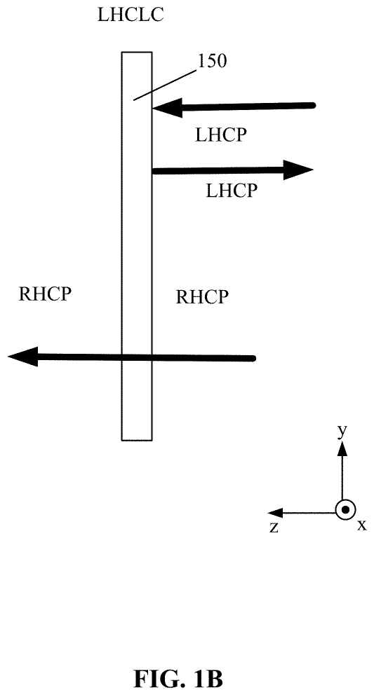

FIG. 1A illustrates a schematic diagram showing a director configuration 100 of CLCs. As shown in FIG. 1A, nematic LC molecules are represented by solid rods for illustrative purposes. CLCs may be disposed in multiple layers 111, 112, 113, 114, 115 with no positional ordering among the layers. For illustrative purposes, in the schematic diagram shown in FIG. 1A, the layers are shown as separate from one another to better illustrate the structure. Although five layers are shown, the number of layers is not limited to five, which may be any suitable number, such as one, two, three, four, six, seven, eight, nine, ten, etc. The nematic LC directors (e.g., long axes of the nematic LC molecules) may rotate between layers, along an axial direction (e.g., z-axis direction shown in FIG. 1A) of the layers, due to the presence of chiral dopants. In the same layer, the nematic LC directors may be oriented in the same direction. In some embodiments, the variation of the nematic LC directors along the axial direction (e.g., z-axis direction) between layers may be periodic.

The period of the variation of the nematic LC directors, i.e., an axial length or distance over which the nematic LC directors rotate by 360°, is also referred to as a helix pitch P. In some embodiments, the variation of the nematic LC directors may repeat at every half pitch (P/2), as the nematic LC directors at 0° and ±180° may be equivalent. The helix pitch P may determine a reflection band of the CLCs, i.e., a band of incidence wavelengths that may be reflected by the CLCs via Bragg Reflection. In some embodiments, the helix pitch P may be of the same order as wavelengths of visible lights. The reflection band of the CLCs may be centered at a wavelength λ₀=n*P, where n may be an average refractive index of the CLCs that may be calculated as n=(nₑ+nₒ)/2. Here, nₑ and nₒ represent the extraordinary and ordinary reflective indices of the nematic LCs, respectively, and P represents the helix pitch of the CLCs. A reflection bandwidth Δλ of the CLCs may be calculated as Δλ=Δn*P, which may be proportional to the birefringence Δn of the nematic LCs, where Δn=nₑ−nₒ.

FIG. 1B illustrates polarization selective reflectivity of the CLCs shown in FIG. 1A. For an incidence wavelength within the reflection band of the CLCs, a circularly polarized light with a handedness that is the same as the handedness of the helical twist structure of the CLCs may be primarily or substantially reflected. A circularly polarized light with a handedness that is different from (e.g., opposite to) the handedness of the helical twist structure of the CLCs may be primarily or substantially transmitted. For example, as shown in FIG. 1B, left-handed CLCs (“LHCLCs”) 150 may exhibit a high reflection characteristic (e.g., a high reflectance) for a left-handed circularly polarized (“LHCP”) incident light and a high transmission characteristic (e.g., a high transmittance) for a right-handed circularly polarized (“RHCP”) incident light. That is, for a light having an incidence wavelength within the reflection band of the LHCLCs 150, when the light is an LHCP light (or includes an LHCP light portion), the LHCLCs 150 may primarily or substantially reflect the LHCP light (or the LHCP light portion). When the light is an RHCP light (or includes an RHCP light portion), the LHCLCs 150 may primarily or substantially transmit the RHCP light (or the RHCP light portion). An unpolarized light or a linearly polarized light can be decomposed into an RHCP light (or an RHCP component or portion) and an LHCP light (or an LHCP component or portion), where each portion may be selectively reflected or transmitted depending on the handedness of the portion and the handedness of the helical twist structure of the CLCs. When the incidence wavelength is outside of the reflection band of the LHCLCs 150, a circularly polarized light may be transmitted by the LHCLCs 150 regardless of the handedness. Due to the handedness selectivity of the CLCs, a thin film of CLCs may function as a polarizing film, or a reflective polarizer (e.g., a circular reflective polarizer, an elliptical reflective polarizer).

A broadband CLC optical element (e.g., CLC reflective polarizer) may be provided as a single gradient-pitch CLC layer, a stack of single-pitch CLC layers, or a stack of gradient-pitch CLC layers, or a stack of one or more single-pitch CLC layers and one or more gradient-pitch CLC layers. A single gradient-pitch CLC layer may be fabricated based on at least one (e.g., all) of LCs, mono-functional chiral monomers, multi-functional monomers, or a photo-initiator. For example, in some embodiments, the single gradient-pitch CLC layer may be fabricated based on a combination (or mixture) of LCs, mono-functional chiral monomers, multi-functional monomers, and a photo-initiator. The single gradient-pitch CLC layer may be fabricated through a single coating approach, through which the mixture is coated on a substrate as a thin layer. The mixture coating may be cured when subject to an ultraviolet (“UV”) light irradiation to form the film. A photo-induced pitch gradient may be provided in the CLCs via a UV intensity gradient generated across the thin film in the thickness direction. After photo-polymerization, a single CLC layer including gradient-pitch CLCs (e.g., a single gradient-pitch CLC layer) is obtained. The single coating approach may have difficulty in producing a sufficiently large thickness for the CLC layer. Accordingly, it may be difficult to provide a sufficiently high extinction ratio for the broadband CLC reflective polarizer using the single coating approach. In addition, as the thickness of the single CLC layer increases, the surface uniformity of the CLC layer may become increasingly difficult to control.

Alternatively, in conventional technologies, broadband CLC reflective polarizers have also been fabricated through physically laminating (or stacking) multiple pre-formed or pre-fabricated single-pitch CLC layers together into a CLC layer stack using adhesives. Such fabrication processes of a CLC layer stack may be complex and inefficient. For example, it may be difficult to position the layers at a predetermined precision. Moreover, when multiple pre-fabricated CLC layers are directly laminated with one another using adhesives, diffusion may occur between the CLC layers. In addition, the laminating processes and/or the interactions (or interference) between the CLC layers may cause various deformations of the CLC layers, such as contraction (or shrink), and/or swelling (or expansion), which may cause the degradation of the optical performance of the CLC layer stack. In addition, as the number of the single-pitch CLC layers increases, the surface roughness of the CLC layer stack may become increasingly difficult to control. As a result, the surface uniformity and the optical performance of the CLC layer stack may further degrade. Furthermore, as the number of CLC layers increases in the stack, the thickness of the stack may be significantly increased due to the thickness of the adhesive layer between the CLC layers.

In view of the disadvantages associated with conventional laminating fabrication methods, the present disclosure provides a method for fabricating a thin and compact birefringent film stack with improved surface uniformity and optical performance, and a birefringent film fabricated based on the disclosed method. In the disclosed fabrication method, each layer or film is formed one over another on a substrate, rather than being pre-fabricated and then laminated together using adhesives. By forming the layers one by one in a stack, the surface uniformity can be better controlled. In addition, in the disclosed fabrication method, the birefringent films are separated by barrier films or layers formed therebetween. The barrier films or layers can effectively reduce or suppress the diffusion, interactions, and/or interference between adjacent birefringent films, thereby enhancing the optical performance of the stack. The barrier films have a small thickness, which does not significantly increase the thickness of the entire birefringent film stack.

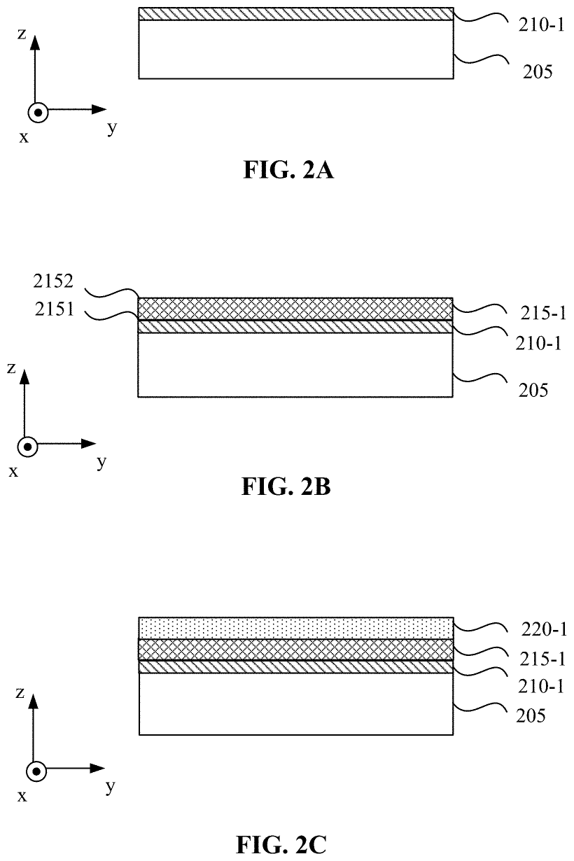

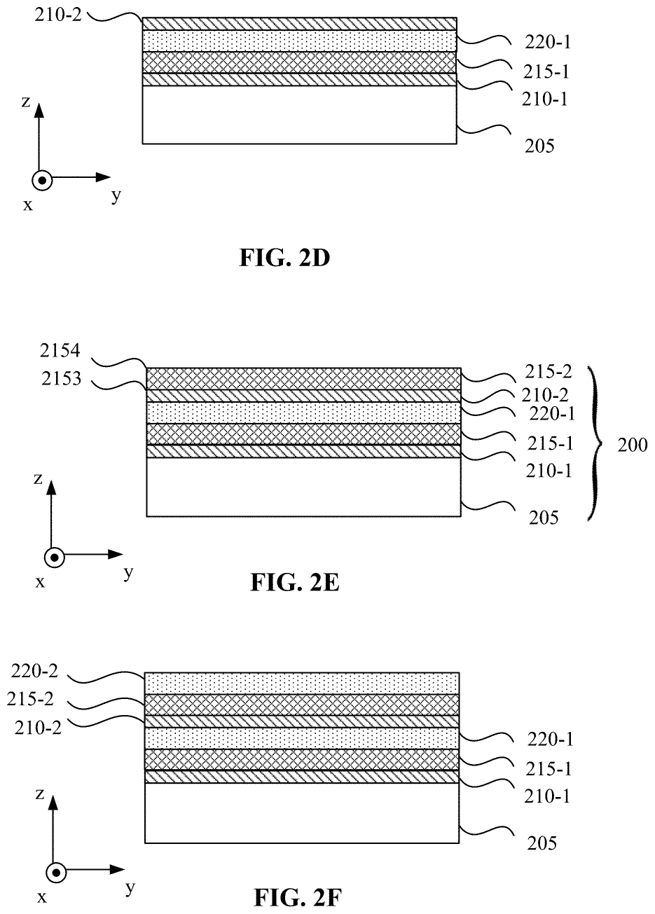

FIGS. 2A-2F illustrate schematic diagrams of processes for fabricating a birefringent film stack (e.g., a CLC layer stack), according to an embodiment of the present disclosure. For illustrative purposes, the substrate and different layers or films formed thereon are shown as having flat surfaces. In some embodiments, the substrate and different layers of films, including the barrier films, may have curved surfaces. As shown in FIG. 2A, a first alignment structure 210-1 may be formed at (e.g., on) a surface (e.g., a top surface) of a substrate 205. The first alignment structure 210-1 may be formed using any suitable methods. In some embodiments, the first alignment structure 210-1 may be formed by dispensing, e.g., coating or depositing, a first alignment material on the top surface of the substrate 205, and processing (e.g., curing, drying, rubbing, and/or subjecting to a light irradiation, etc.) the first alignment material to provide a predetermined alignment or alignment pattern.

The substrate 205 may provide support and protection to various layers, films, and/or structures formed thereon. In some embodiments, the substrate 205 may be at least partially transparent at least in the visible wavelength band (e.g., about 380 nm to about 700 nm). In some embodiments, the substrate 205 may also be at least partially transparent in at least a portion of the infrared (“IR”) band (e.g., about 700 nm to about 1 mm). The substrate 205 may include a suitable material that is at least partially transparent to lights of the above-listed wavelength ranges, such as, a glass, a plastic, a sapphire, or a combination thereof, etc. The substrate 205 may be rigid, semi-rigid, flexible, or semi-flexible. The substrate 205 may include a flat surface or a curved surface, on which the different films may be formed.

In some embodiments, the substrate 205 may be a part of another optical element or device (e.g., another opto-electrical element or device). For example, the substrate 205 may be a solid optical lens or a part of a solid optical lens. In some embodiments, the substrate 205 may be a part of a functional device, such as a display screen. In some embodiments, the substrate 205 may be used to fabricate, store, or transport the CLC layer stack. In some embodiments, the substrate 205 may be detachable or removable from the rest of the CLC layer stack after the rest of the CLC layer stack is fabricated or transported to another place or device. That is, the substrate 205 may be used in fabrication, transportation, and/or storage to support the CLC layer stack provided on the substrate 205, and may be separated or removed from the CLC layer stack when the fabrication of the CLC layer stack is completed, or when the CLC layer stack is to be implemented in an optical device. In some embodiments, the substrate 205 may not be separated from the CLC layer stack.

As shown in FIG. 2B, a first birefringent film 215-1 may be formed at (e.g., on) a surface (e.g., a top surface) of the first alignment structure 210-1. The first birefringent film 215-1 may be indirectly formed on the substrate 205, with the first alignment structure 210-1 formed therebetween. That is, the first birefringent film 215-1 may be formed on the first alignment structure 210-1. The first birefringent film 215-1 may be formed using any suitable methods, such as spin coating, depositing, etc. For example, the first birefringent film 215-1 may be formed by dispensing (e.g., coating, depositing, etc.) a birefringent material composition on the top surface of the first alignment structure 210-1. Optically anisotropic molecules in the birefringent material composition dispensed on the first alignment structure 210-1 may be aligned by the first alignment structure 210-1. The birefringent material composition may be processed (e.g., cured, polymerized, dried, etc.) to form the first birefringent film 215-1 having the predetermined alignment or alignment pattern provided by the first alignment structure 210-1. For discussion purposes, a CLC layer is used as an example of the disclosed birefringent film in the following descriptions. Hence, a birefringent film may also be referred to as a CLC layer.

The first alignment structure 210-1 may be configured to provide a predetermined alignment (or alignment pattern) to the first CLC layer 215-1. For example, LC molecules included in the first CLC layer 215-1 that are in direct contact with the first alignment structure 210-1 may be aligned by the first alignment structure 210-1 in the predetermined alignment pattern, and the remaining LC molecules in the first CLC layer 215-1 may be aligned according to neighboring (e.g., underlying) LC molecules that have been aligned by the first alignment structure 210-1. The predetermined alignment pattern provided by the first alignment structure 210-1 may include a planar (or homogeneous) alignment, a vertical (or homeotropic) alignment, an alignment between the planar (or homogeneous) alignment and the vertical (or homeotropic) alignment, or a hybrid alignment including both the planar (or homogeneous) alignment and the vertical (or homeotropic) alignment, etc.

The first alignment structure 210-1 may be any suitable alignment structure. For example, the first alignment structure 210-1 may include a polyimide layer, a photo-alignment material (“PAM”) layer, a nanostructure, an alignment network, or a combination thereof. In some embodiments, the first alignment structure 210-1 may include a PAM layer having one or more photo-alignment materials. In some embodiments, the photo-alignment materials may include photosensitive molecules that may undergo orientational ordering when subjected to a polarized light irradiation. In some embodiments, the photosensitive molecules may include elongated anisotropic photosensitive units (e.g., small molecules or fragments of polymeric molecules) that may be polarization sensitive. For example, the photosensitive units may be aligned by a light with a predetermined polarization, and may not be aligned by a light with a different (e.g., orthogonal) polarization.

In some embodiments, the first alignment structure 210-1 may be a PAM layer. The PAM layer may be formed on the top surface of the substrate 205 through any suitable methods. For example, the PAM layer may be formed on the top surface of the substrate 205 through dispensing, e.g., spin coating, one or more photo-alignment materials on the top surface the substrate 205 to form a thin film of the one or more photo-alignment materials. The thin film of the one or more photo-alignment materials may be exposed to a polarized light with a first polarization. For example, a light source may emit an unpolarized light (e.g., unpolarized UV, violet or blue light) with one or more wavelengths in the absorption band of the photosensitive materials. Polarization control optics including a polarization converter may receive the unpolarized light and output the polarized light with the first polarization. In some embodiments, the polarized light with the first polarization may be a linearly polarized light polarized in a first polarization direction. After being subjected to a sufficient exposure of the linearly polarized light with the first polarization, the photosensitive molecules in the thin film of the one or more photo-alignment materials may be substantially uniformly aligned in the first polarization direction.

In some embodiments, the first alignment structure 210-1 may include a mechanically rubbed polyimide layer. In some embodiments, the first alignment structure 210-1 may include a polyimide layer with anisotropic nanoimprint. In some embodiments, the first alignment structure 210-1 may include an alignment layer including a polyimide mixed with a liquid crystalline prepolymer. In some embodiments, the first alignment structure 210-1 may include a ferroelectric or ferromagnetic material configured to at least partially align LC molecules in a CLC layer in a presence of a magnetic field or an electric field. In some embodiments, the first alignment structure 210-1 may include an interpenetrating polymer network including an organic alignment material, an inorganic alignment material, or both.

After the first alignment structure 210-1 is formed on the top surface of the substrate 205, as shown in FIG. 2B, the first CLC layer 215-1 may be formed at (e.g., on) the top surface of the first alignment structure 210-1. The first alignment structure 210-1 may include a first surface (e.g., a bottom surface) facing the substrate 205 and an opposing second surface (e.g., a top surface). The first CLC layer 215-1 may be formed at the second surface (e.g., the top surface) of the first alignment structure 210-1.

The first CLC layer 215-1 may include a first birefringent material having a chirality. In some embodiments, the first CLC layer 215-1 may have a cholesteric order. For example, the first CLC layer 215-1 may include CLCs configured to have a first helical twist structure. The first CLC layer 215-1 may include a first surface 2151 (e.g., a bottom surface) facing the substrate 205 and an opposing second surface 2152 (e.g., a top surface). In some embodiments, a helical axis of the first helical twist structure may be substantially normal (e.g., perpendicular) to a surface (e.g., the first surface 2151 and/or the second surface 2152) of the first CLC layer 215-1. In some embodiments, a helical axis of the first helical twist structure may be substantially parallel to a surface (e.g., the first surface 2151 and/or the second surface 2152) of the first CLC layer 215-1.

The first alignment structure 210-1 may be configured to at least partially align LC molecules included in the first CLC layer 215-1 in a first pretilt angle. For example, the LC molecules that are in direct contact with the first alignment structure 210-1 (e.g., the LC molecules disposed in a first region within the first CLC layer 215-1 adjacent the first surface 2151) may be aligned by the first alignment structure 210-1 in the first pretilt angle, and the remaining LC molecules in the first CLC layer 215-1 may be aligned in the first pretilt angle according to neighboring (e.g., underlying) LC molecules that have been aligned by the first alignment structure 210-1. A pretilt angle may be defined as an angle between an LC director (e.g., long axis) of the LC molecules and a surface (e.g., the first surface 2151 and/or the second surface 2152) of the first CLC layer 215_1. In some embodiments, the pretilt angle may be defined as an angle between an LC director (e.g., long axis) of the LC molecule and a surface of the substrate 205 or the first alignment structure 210-1, which may be parallel with the surface of the first CLC layer 215-1.

In some embodiments, the LC molecules disposed adjacent the second surface 2152 of the first CLC layer 215-1 may be exposed to air. The pretilt angles of the LC molecules exposed to air may be controlled or configured by surfactants or other additive molecules (e.g., small weight molecules) added to the first birefringent material rather than by the first alignment structure 210-1 coupled to the first surface 2151 of the first CLC layer 215-1.

In some embodiments, the first CLC layer 215-1 may include a liquid crystal polymer (“LCP”) film. In some embodiments, the LCP film may include passive LCs that are not switchable (or reorientable) by an external field (e.g., an external electric field, magnetic field, or light field), such as polymerized (e.g., photopolymerized) CLCs. For example, when fabricating the LCP film including passive LCs, chiral reactive mesogens (“RMs”) with a photopolymerizable methacrylate group may be mixed with achiral RMs (as nematic LC host) and photo-initiators. In some embodiments, the achiral RMs may include monoacrylate monomer (“mRMs”) and diacrylate monomers (“dRMs”). The mixture may be coated on the first alignment structure 210-1. Then the mixture may be irradiated with, e.g., a UV light. Under sufficient UV light irradiation, the chiral RMs may be polymerized to generate a helical twist structure, and the achiral RMs may be polymerized to stabilize the generated helical twist structure.

In some embodiments, the LCP film may include active LCs that are switchable (or reorientable) by an external field (e.g., an external electric field, magnetic field, or light field). For example, the LCP film may include polymer-stabilized CLCs where active LCs may be disposed in a polymer network. Accordingly, the LCP film may be a polymer-stabilized cholesteric liquid crystal (“PSCLC”) film. For example, when fabricating the PSCLC film, nematic LCs may be mixed with at least one of mono-functional chiral monomers, multi-functional monomers, or photo-initiators. For example, the nematic LCs may be mixed with mono-functional chiral monomers, multi-functional monomers, and photo-initiators. The mixture or composition may be coated as a film on the first alignment structure 210-1. Then the mixture may be irradiated with, e.g., a UV light. After being subject to a sufficient UV exposure, the chiral monomers may be polymerized to generate a helical twist structure of the nematic LCs. The crosslinked multi-functional monomers after the polymerization may stabilize the generated helical twist structure of the nematic LCs.

In some embodiments, the LCP film may be formed on the first alignment structure 210-1 through any suitable methods. For example, the LCP film may be formed on the top surface of the first alignment structure 210-1 through dispensing, for example, spin coating, a cholesteric mixture or composition on the top surface of the first alignment structure 210-1 to form a thin layer of the cholesteric mixture. The thin layer of the cholesteric mixture may be subsequently polymerized to form the LCP film. The cholesteric mixture may include at least LCs and monomers. In some embodiments, the LCs may be polymerizable. For example, the LCs may include polymerizable functional groups. In some embodiment, the monomers may be polymerizable. In some embodiment, both the LCs and monomers may be polymerizable. In some embodiments, the thin layer of the cholesteric mixture may be photo-polymerized under, e.g., UV exposure. In some embodiments, the thin layer of the cholesteric mixture may be thermally polymerized at an elevated temperature. In some embodiments, the cholesteric mixture may also include additional materials, such as photo-initiators, chiral dopants, other monomers, or other LCs, etc.

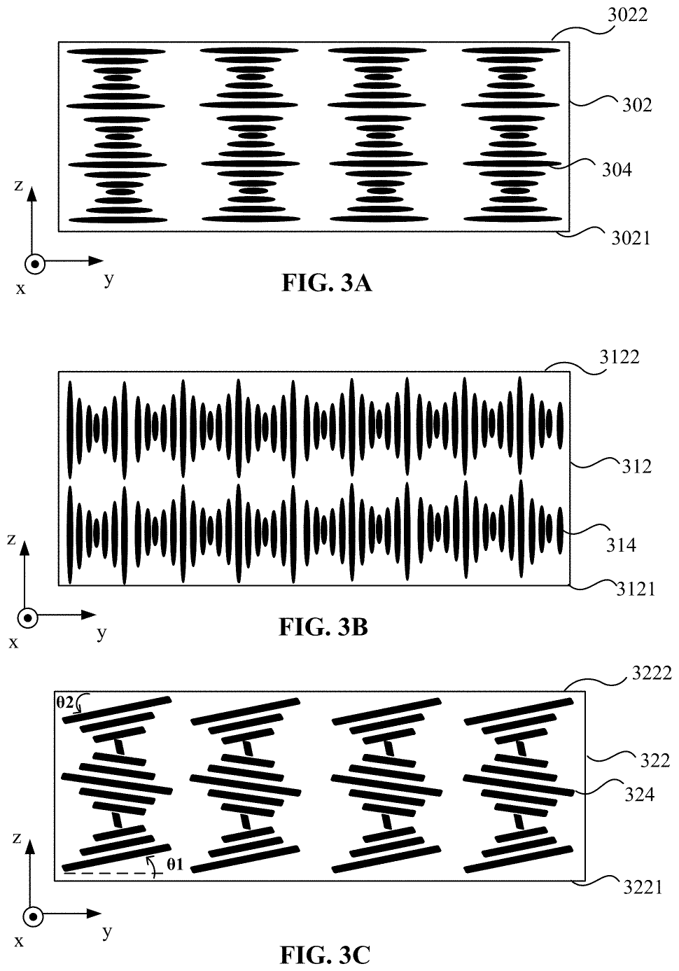

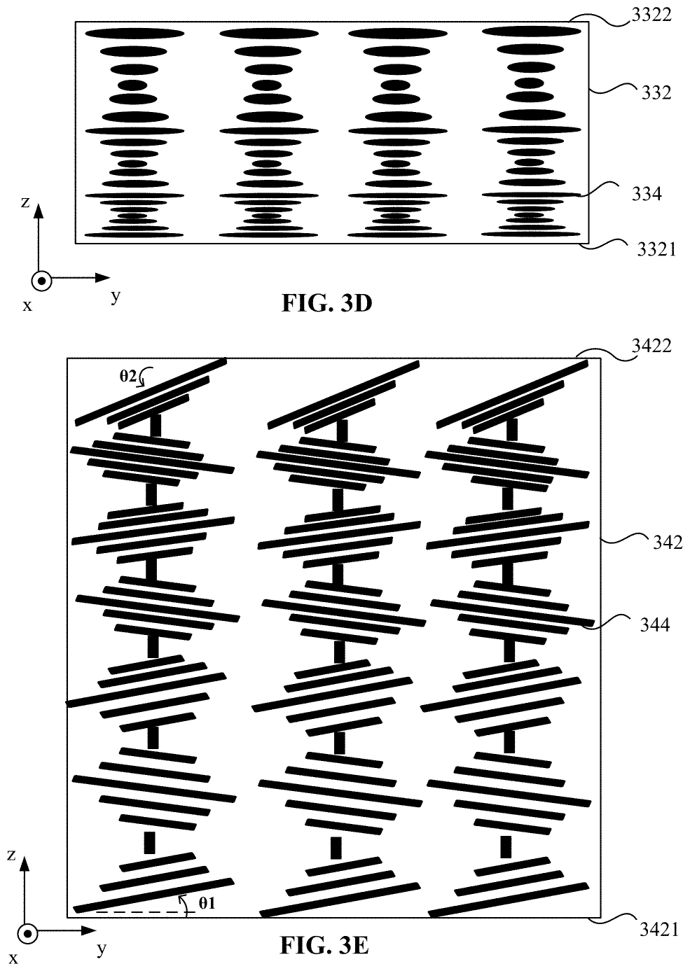

The first CLC layer 215-1 may have various helical twist structures. FIGS. 3A-3E illustrate cross-sectional views of CLC layers with different helical twist structures, according to various embodiments of the present disclosure. Each of the CLC layers shown in FIGS. 3A-3E may be an embodiment of the first CLC layer 215-1 shown in FIG. 2B. In each of FIGS. 3A-3E, the z-axis direction may be presumed to be the thickness direction of the CLC layer.

Referring to FIG. 3A, in some embodiments, a CLC layer 302 may include CLCs configured to have a helical twist structure of a constant helix pitch (e.g., repeat of a same, fixed helix pitch). Such a CLC layer 320 may be referred to as a single-pitch CLC layer. The CLC layer 302 may include LC molecules 304, a first surface 3021, and a second surface 3022. An alignment structure (e.g., the first alignment structure 210-1 shown in FIG. 2B) coupled to the CLC layer 302 may provide a substantially planar (or homogeneous) alignment to the CLC layer 302, in which the LC molecules 304 may be configured to have relatively small pretilt angles, e.g., about 0° to about 10°, or about 0° to about −10°. The small pretilt angles are not shown in FIG. 3A. For the simplicity of illustration, the LC molecules configured in small pretilt angles are shown as substantially parallel to the surface (3021 or 3022) of the CLC layer 302 in FIG. 3A.

In the present disclosure, whether an angle is a positive angle or a negative angle is determined by a terminal side of the angle. Presuming that the terminal side of the angle is the side where the LC director is located, a positive angle is the angle when the terminal side is rotated in a counter-clockwise direction, and a negative angle is the angle when the terminal side is rotated in a clockwise direction. A helical axis of the helical twist structure may be substantially normal (e.g., perpendicular) to a surface (e.g., the first surface 3021 and/or the second surface 3022) of the CLC layer 302. The helical twist structure (or a helical superstructure) of the CLC layer 302 may be a helicoidal superstructure, in which the LC molecules 304 rotate around the helical axis (e.g., the z-axis), and the LC directors (i.e., long axes) of the LC molecules 304 are substantially perpendicular to the helical axis.

In some embodiments, when the LC molecules 304 in the CLC layer 302 are substantially planarly aligned, the CLC layer 302 may function as a polarizing film having a handedness selectivity. For example, the CLC layer 302 may primarily or substantially reflect a polarized light having a same handedness as that of the helical twist structure of the CLC layer 302, and primarily or substantially transmit a polarized light having a handedness opposite to that of the helical twist structure of the CLC layer 302. In some embodiments, the CLC layer 302 may be configured to separate (or split) two circularly polarized components (e.g., a left-handed circularly polarized component and a right-handed circularly polarized component) of an unpolarized incident light or a linearly polarized incident light. One circularly polarized component having a same handedness as that of the helical twist structure of the CLC layer 302 may be primarily reflected by the CLC layer 302, and the other circularly polarized component having a handedness opposite to that of the helical twist structure of the CLC layer 302 may be primarily transmitted by the CLC layer 302. The reflection band of the single-pitch CLC layer 302 may be relatively narrow, e.g., an about 10-nm reflection band.

In some embodiments, as shown in FIG. 3B, a CLC layer 312 may include CLCs configured to have a fingerprint structure. The CLC layer 312 may be a single-pitch CLC layer having a single, constant (or fixed) pitch in a direction parallel to a surface of the CLC layer 312, e.g., the y-axis direction in FIG. 3B. The CLC layer 312 may include LC molecules 314, a first surface 3121 and a second surface 3122. A helical axis of the helical twist structure of the CLC layer 312 may be substantially parallel to a surface (e.g., the first surface 3121 and/or the second surface 3122) of the CLC layer 312. An alignment structure (e.g., the first alignment structure 210_1) coupled to the CLC layer 312 may provide a substantially vertical (or homeotropic) alignment to the CLC layer 312. LC molecules 314 may be configured to have relatively large pretilt angles, e.g., about 80° to about 90° or about −90° to about −80°. In some embodiments, the CLC layer 312 including CLCs arranged in the fingerprint structure may function as a diffraction grating configured for dispersing light, steering beam, etc. Although not shown in FIG. 3B, the CLC layer 312 may have a varying pitch (e.g., a gradient pitch) in the helical axis direction (e.g., in the y-axis direction). Thus, the CLC layer 312 may be a gradient-pitch CLC layer 312 having a fingerprint structure.

In some embodiments, as shown in FIG. 3C, a CLC layer 322 may include CLCs configured to have a helical twist structure of a constant helix pitch (e.g., repeat of a same, fixed helix pitch) having intermediate pretilt angles (a floor pretilt angle θ1 and a ceiling pretilt angle θ2). The floor pretilt angle θ1 and the ceiling pretilt angle θ2 may be substantially the same, or may be different. The CLC layer 322 may be a single-pitch CLC layer 322 having a constant pitch. The CLC layer 322 may include LC molecules 324, a first surface 3221, and a second surface 3222. An alignment structure (e.g., the first alignment structure 210-1) coupled to the CLC layer 322 may provide an alignment between the vertical (or homeotropic) alignment and the planar (or homogeneous) alignment to the LC molecules 324. Thus, the LC molecules 324 in the CLC layer 322 may be configured with intermediate pretilt angles with respect to the first surface 3221 or the second surface 3222, e.g., about 10° to about 80° or about −80° to about −10°. That is, each of the floor pretilt angle θ1 and the ceiling pretilt angle θ2 may be within the range of about 10° to about 80° or within the range of about −80° to about −10°.

A helical axis of the helical twist structure may be substantially normal (e.g., perpendicular) to a surface (e.g., the first surface 3221 and/or the second surface 3222) of the CLC layer 322. The helical twist structure (or a helical superstructure) of the CLC layer 322 may be a heliconical structure, in which the LC molecules 324 may rotate around the helical axis, and the LC directors of the LC molecules may have oblique angles (e.g., oblique acute angles) with respective to the helical axis (e.g., with respect to the z-axis). The heliconical structure may also be referred to as an oblique helicoidal superstructure. Similar to the CLC layer 302 shown in FIG. 3A, the CLC layer 322 in which the LC molecules 324 are configured in intermediate pretilt angles may function as a polarizing film having a handedness selectivity and a relatively narrow reflection band. Compared to the CLC layer 302 in which the LC molecules 304 are configured to have relatively small pretilt angles (e.g., in a range of −10° to 10°), the CLC layer 322 in which the LC molecules 324 are configured to have intermediate pretilt angles (e.g., about 10° to about 80° or about −80° to about)−10° may have improved optical performance (e.g., suppressed light leakage) for both on-axis and off-axis incident lights. In addition, an extinction ratio of the polarizing film formed based on the CLC layer 322 having the intermediate pretilt angles may be improved for both on-axis and off-axis incident lights.

LC molecules at or near the first surface 3221 of the CLC layer 322 may have the floor pretilt angle θ1. LC molecules at or near the second surface 3222 of the CLC layer 322 may have the ceiling pretilt angle θ2. The floor pretilt angle θ1 and the ceiling pretilt angle θ2 may be the same, or may be different, may have the same sign or may have different signs. In some embodiments, although FIG. 3C shows that that floor pretilt angle θ1 and the ceiling pretilt angle θ2 are both positive angles (presuming that the counter-clockwise direction is the positive direction), the floor pretilt angle θ1 and the ceiling pretilt angle θ2 may both be negative angles (i.e., angles in clockwise direction) or may have different signs (e.g., one being positive, another being negative). In some embodiments, each of the floor pretilt angle θ1 and the ceiling pretilt angle θ2 may be in the range of about 25° to about 50°, about −50° to about −25°, about 30° to about 40°, or about −40° to about −30°. In some embodiments, each of the floor pretilt angle θ1 and the ceiling pretilt angle θ2 may be about 30° (or −30°). In some embodiments, each of the floor pretilt angle θ1 and the ceiling pretilt angle θ2 may be about 40° (or −40°). In some embodiments, one of the floor pretilt angle θ1 and the ceiling pretilt angle θ2 may be about 30°, and the other one of the floor pretilt angle θ1 and the ceiling pretilt angle θ2 may be about 40°. In some embodiments, one of the floor pretilt angle θ1 and the ceiling pretilt angle θ2 may be about −30°, and the other one of the floor pretilt angle θ1 and the ceiling pretilt angle θ2 may be about −40°.

In some embodiments, as shown in FIG. 3D, a CLC layer 332 may include CLCs configured to have a helical twist structure of a varying (e.g., non-constant) helix pitch, e.g., a gradient helix pitch. The CLC layer 332 may include LC molecules 334, a first surface 3321, and a second surface 3322. A helical axis of the helical twist structure may be substantially normal (e.g., perpendicular) to a surface (e.g., the first surface 3321 and/or the second surface 3322) of the CLC layer 332. In some embodiments, the helix pitch may gradually increase or decrease in a predetermined direction (e.g., in a helical axis direction, or the z-axis direction). For illustrative purposes, in the embodiment shown in FIG. 3D, the varying helix pitch is shown as gradually increasing along the helical axis of the CLC layer 332, e.g., along the +z-axis direction as shown in FIG. 3D.

Although not shown in FIG. 3D, an alignment structure (e.g., the first alignment structure 210-1) may be coupled to the CLC layer 332. The alignment structure may provide a substantially planar alignment to the CLC layer 332, in which the LC molecules 334 may be configured to have relatively small pretilt angles, e.g., about 0° to about 10° or about 0° to about −10°. The small pretilt angles are not shown in FIG. 3D. For the simplicity of illustration, the LC molecules configured with the small pretilt angles are shown as substantially parallel to the surface (3321 or 3322) of the CLC layer 332 in FIG. 3D. The helical twist structure (or a helical superstructure) of the CLC layer 332 may be a helicoidal superstructure, in which LC molecules 334 may rotate around the helical axis (e.g., the z-axis), and the LC directors (i.e., long axes) of the LC molecules 304 may be substantially perpendicular to the helical axis. The CLC layer 332 in which the LC molecules 334 are substantially planarly aligned may function as a polarizing film having a handedness selectivity. Compared to the single-pitch CLC layer 302 shown in FIG. 3A and the single-pitch CLC layer 322 shown in FIG. 3C, the varying helix pitch configuration of the CLC layer 332 may result in a broad reflection band with a single layer.

In some embodiments, as shown in FIG. 3E, a CLC layer 342 may include CLCs configured to have a helical twist structure of a varying (e.g., non-constant) helix pitch, e.g., a gradient helix pitch. The CLC layer 342 may include LC molecules 344, a first surface 3421, and a second surface 3422. An alignment structure (e.g., the first alignment structure 210-1) coupled to the CLC layer 342 may provide an alignment between the vertical (or homeotropic) alignment and the planar (or homogeneous) alignment to the LC molecules 344. For example, the LC molecules 344 in the CLC layer 342 may be configured to have intermediate pretilt angles (floor pretilt angle θ1 and the ceiling pretilt angle θ2), e.g., about 10° to about 80° or about −80° to about −10°. That is, each of the floor pretilt angle θ1 and the ceiling pretilt angle θ2 may be within the range of about 10° to about 80° or within the range of about −80° to about −10°.

A helical axis of the helical twist structure may be substantially normal (e.g., perpendicular) to a surface (e.g., the first surface 3421 and/or the second surface 3422) of the CLC layer 342. The helical twist structure (or a helical superstructure) of the CLC layer 342 may be a heliconical structure, in which the LC molecules 344 may rotate around the helical axis (e.g., the z-axis), and the LC directors of the LC molecules may have oblique angles (e.g., oblique acute angles) with respective to the helical axis. The CLC layer 342 in which the LC molecules 344 are configured with intermediate pretilt angles may function as a polarizing film having a handedness selectivity and a relatively broad reflection band. Compared to the CLC layer 332 shown in FIG. 3D in which the LC molecules 334 are configured with relatively small pretilt angles (e.g., in a range of −10° to 10°), the CLC layer 342 shown in FIG. 3E in which the LC molecules 344 are configured with intermediate pretilt angles (e.g., about 10° to about 80° or about −80° to about)−10° may have improved optical performance (e.g., suppressed light leakage) for both on-axis and off-axis incident lights. In addition, an extinction ratio of the CLC layer 342 functioning as a polarizing film may be improved for both on-axis and off-axis incident lights.

LC molecules at or near the first surface 3421 of the CLC layer 342 may be configured with the floor pretilt angle θ1. LC molecules at or near the second surface 3422 of the CLC layer 342 may be configured with the ceiling pretilt angle θ2. The floor pretilt angle θ1 and the ceiling pretilt angle θ2 may be the same, or may be different. In some embodiments, although FIG. 3E shows that that floor pretilt angle θ1 and the ceiling pretilt angle θ2 are both positive angles (presuming that the counter-clockwise direction is the positive direction), the floor pretilt angle θ1 and the ceiling pretilt angle θ2 may both be negative angles (i.e., angles in clockwise direction) or may have different signs (e.g., one being positive, another being negative). In some embodiments, each of the floor pretilt angle θ1 and the ceiling pretilt angle θ2 may be in the range of about 25° to about 50°, about −50° to about −25°, about 30° to about 40°, or about −40° to about −30°. In some embodiments, each of the floor pretilt angle θ1 and the ceiling pretilt angle θ2 may be about 30° (or −30°). In some embodiments, each of the floor pretilt angle θ1 and the ceiling pretilt angle θ2 may be about 40° (or −40°). In some embodiments, one of the floor pretilt angle θ1 and the ceiling pretilt angle θ2 may be about 30° (or −30°), and the other one of the floor pretilt angle θ1 and the ceiling pretilt angle θ2 may be about 40° (or −40°).

Returning to FIG. 2C, after the first CLC layer 215-1 is formed on the first alignment structure 210-1, a first barrier film 220-1 may be formed at (e.g., on) a surface of the first CLC layer 215-1. The first CLC layer 215-1 may have a first surface (e.g., bottom surface) facing the substrate 205 and an opposing second surface (e.g., top surface). The first barrier film 220-1 may be formed on the second surface of the first CLC layer 215-1. The first barrier film 220-1 may be formed by dispensing (e.g., coating, depositing, etc.) a barrier material composition onto the top surface of the first alignment structure 210-1. In some embodiments, the barrier material composition may be processed (e.g., cured, polymerized, dried, etc.) to form the first barrier film 220-1. In some embodiments, the barrier material composition may be deposited (e.g., via chemical vapor deposition) on the top surface of the first alignment structure 210-1 to form the first barrier film 220-1 directly without being further processed (such as being cured, polymerized, or dried). The first barrier film 220-1 may be configured to function as a barrier to reduce or suppress diffusion and/or interactions between the first CLC layer 215-1 and another layer formed in the subsequent process, such as a second alignment structure 210-2 shown in FIG. 2D or another CLC layer. The first barrier film 220-1 may reduce or suppress various deformations (e.g., the contraction or shrink, and/or swelling or expansion) of the first CLC layer 215-1. In some embodiments, the first barrier film 220-1 may also be configured to provide other barrier functions against permeation of undesirable substance into the first CLC layer 215-1, e.g., moisture, oxygen, and/or grease.

In some embodiments, the first barrier film 220-1 may include a water-borne barrier coating, a solvent-borne barrier coating, a solventless barrier coating, a sol-gel barrier coating, or any combination thereof. For example, the first barrier film 220-1 may include a water-borne or solvent-borne barrier coating, which may be formed on the first CLC layer 215-1 through dispensing (e.g., coating, depositing, etc.) a thin layer of a water-borne barrier or solvent-borne coating composition onto the second surface the first CLC layer 215-1. In some embodiments, the solvent in the solvent-borne coating composition may include a small amount of ethanol, methanol, or a combination thereof. The thin layer of the water-borne or solvent-borne barrier coating composition may be cured or dried (e.g., thermally cured or dried) to form the first barrier film 220-1. In some embodiments, the first barrier film 220-1 may be formed by dispensing and curing a plurality of water-borne or solvent-borne barrier coatings. For example, a first water-borne or solvent-borne coating composition may be dispensed (e.g., coated, deposited, etc.) onto a surface of the first CLC layer 215-1 to pre-coat the first CLC layer 215-1. The first water-borne or solvent-borne coating composition may be cured. A second water-borne or solvent-borne coating composition may be dispensed over the cured first water-borne barrier coating composition. The second water-borne or solvent-borne coating composition may be cured. Additional layers of water-borne or solvent-borne coating compositions may be dispensed over the first CLC layer 215-1 and cured to form the first barrier film 220-1. In some embodiments, the first barrier film 220-1 may be formed with a single coating or layer of water-borne or solvent-borne barrier coating composition.

In some embodiments, the first barrier film 220-1 may include a solventless barrier coating or solvent-free barrier coating, such as an acrylate barrier coating. A solventless or solvent-free material or composition does not necessarily indicate that the material or composition is completely free of a solvent. The material or composition may include a small amount of solvent (which may be negligible), and may still be regarded as a solventless or solvent-free according to typical standards used in the related art. The solventless barrier coating may be formed on the first CLC layer 215-1 through a solventless coating method, such as through compression coating, hot-melt coating, supercritical fluid spray coating, electrostatic coating, dry powder coating, physical vapor deposition coating, chemical vapor deposition coating, or photocurable coating, etc. A solventless barrier coating may eliminate potential issues associated with the use of solvents, such as solvent exposure, solvent disposal, and/or residual solvent in a product. Solventless processing may reduce an overall process cost as expensive processes of solvent disposal/treatment may be omitted. In addition, solventless processing may also significantly reduce the processing time as the step of drying/evaporation of the solvent may be omitted. Most solventless coating methods, except for hot-melt coating, may be performed without the step of heating and, thus, may provide an alternative technology to coating temperature-sensitive products.

After the first barrier film 220-1 is formed on the first CLC layer 215-1, as shown in FIG. 2D, the second alignment structure 210-2 may be formed at (e.g., on) the first barrier film 220-1. The first barrier film 220-1 may have a first surface (e.g., a bottom surface) facing the substrate 205 and an opposing second surface (e.g., a top surface). The second alignment structure 210-2 may be formed on the second surface of the first barrier film 220-1. The second alignment structure 210-2 may be formed by dispensing, e.g., spin coating, a second alignment material on the first barrier film 220-1, and processing (e.g., curing, drying, rubbing, and/or subjecting to a light irradiation) the second alignment material to provide a predetermined alignment or alignment pattern. Similar to the first alignment structure 210-1, the second alignment structure 210-2 may be configured to provide a predetermined alignment to a birefringent film (e.g., a CLC layer), which is to be disposed at (e.g., on) a surface of the second alignment structure 210-2 in the subsequent process. For example, the second alignment structure 210-2 may be configured to align LC molecules that are in direct contact with the second alignment structure 210-2. The remaining LC molecules in the CLC layer may be aligned according to neighboring (e.g., underlying) LC molecules that have been aligned by the second alignment structure 210-2. Descriptions of the second alignment structure 210-2 can refer to the above descriptions of the first alignment structure 210-1. The first alignment structure 210-1 and the second alignment structure 210-2 may provide the same alignment or different alignments to the respective CLC layer disposed thereon. The first alignment structure 210-1 and the second alignment structure 210-2 may include the same alignment material or different alignment materials.

In some embodiments, the first barrier film 220-1 and the second alignment structure 210-2 may be integrally formed as a single film. In some embodiments, the alignment material (e.g., a photo-alignment material) and the barrier material composition may be mixed and the mixture may be dispensed (e.g., coated) to the top surface of the first birefringent film 215-1 to form a single film providing both the barrier function and the predetermined alignment pattern to another birefringent film to be formed thereon. In some embodiments, a material composition having both the barrier function and the alignment function may be dispensed (e.g., coated) onto the top surface of the first birefringent film 215-1 to form a single film providing both the barrier function and the predetermined alignment pattern to a birefringent film to be formed thereon.

Although not shown, an additional barrier film may be formed on the substrate 205 before the first alignment structure 210-1 is formed. That is, the first alignment structure 210-1 may be formed on a barrier film. The barrier film disposed between the substrate 205 and the first alignment structure 210-1 may be similar to the barrier film 220-1, or may include a material that is different from the material included in the barrier film 220-1. In some embodiments, the barrier film formed on the substrate 205 before the first alignment structure 210-1 is formed may be a soluble synthetic polymer film that includes, for example, polyvinyl alcohol (“PVA”). In some embodiments, after the rest of the CLC layer stack is fabricated or transported to another place or device, the substrate 205 may be detached or removed from the rest of the CLC layer stack through dissolving the soluble synthetic polymer film.

In some embodiments, the barrier film formed on the substrate 205 may be integrally formed with the first alignment structure 210-1 as a single film in a manner similar to that described above with respect to the first barrier film 220-1 and the second alignment structure 210-2. For example, the first alignment structure 210-1 may be a photo-alignment layer configured to provide both the barrier function (e.g., having a material that can provide a desired barrier function) and the alignment function to the first CLC layer 215-1 disposed thereon. Thus, the barrier film and the first alignment structure 210-1 may be formed from a single material composition as a single film. In some embodiments, the single film providing both barrier function and alignment function may be a soluble layer. The single film may be formed on the substrate 205 and the first CLC layer 215-1 may be formed on the single film. In some embodiments, after the rest of the CLC layer stack is fabricated or transported to another place or device, the substrate 205 and single film providing both the barrier function and the alignment function may be detached or removed from the rest of the CLC layer stack through dissolving the soluble layer.

Referring to FIG. 2E, after the second alignment structure 210-2 is formed at (e.g., on) the first barrier film 220-1, a second birefringent film 215-2 may be formed at (e.g., on) the second alignment structure 210-2. For discussion purposes, a CLC layer is used as an example of any birefringent film disclosed herein. Thus, the second birefringent film 215-2 may also be referred to as a second CLC layer 215-2. The second CLC layer 215-2 may include a first surface (e.g., bottom surface) 2153 facing the substrate 205 and a second, opposing surface (e.g., top surface) 2154.

The second CLC layer 215-2 may be formed on the second surface of the second alignment structure 210-2. The second alignment structure 210-2 may be configured to at least partially align LC molecules included in the second CLC layer 215-2 to have a second pretilt angle. For example, the LC molecules in direct contact with the second alignment structure 210-2 (e.g., the LC molecules disposed in a first region adjacent the first surface 2153 of the second CLC layer 215-2) may be aligned by the second alignment structure 210-2, and the remaining LC molecules in the second CLC layer 215-2 may be aligned according to neighboring LC molecules that have been aligned by the second alignment structure 210-2. In some embodiments, the LC molecules disposed adjacent the second surface 2154 of the second CLC layer 215-2 may be exposed to air. The pretilt angles of the LC molecules exposed to air may be controlled or configured by surfactants or other additive molecules (e.g., small weight molecules) added to the first birefringent material rather than by first alignment structure 210-1 coupled to the first surface 2153 of the second CLC layer 215-2.

In some embodiments, after the second CLC layer 215-2 is formed on the second alignment structure 210-2, a CLC layer stack 200 including two CLC layers 215-1 and 215-2 is fabricated. In some embodiments, the CLC layer stack 200 may not include the substrate 205. That is, the substrate 205 may be removed or separated from the rest of the CLC layer stack 200 after the various layers or films have been formed on the substrate 205. To separate the substrate 205, a water-soluble adhesive layer (e.g., polyvinyl alcohol) may be formed on the top surface of the substrate 205 before the first alignment structure 210-1 is formed on the substrate 205. That is, the water-soluble adhesive layer may be formed on the substrate 205, and the first alignment structure 210-1 may be formed on the water-soluble adhesive layer. After the various CLC layers are formed, the substrate 205 and the adhesive layer may be separated from the rest of the CLC layer stack 200 through dissolving the adhesive layer. In some embodiments, the water-soluble adhesive layer may be integrally formed with the first alignment structure 210-1, e.g., as a single water-soluble photo-alignment layer. Thus, in some embodiments, the substrate 205 and the first alignment structure 210-1 may be removed from the rest of the CLC layer stack 200 through dissolving the water-soluble single photo-alignment layer.

In some embodiments, one or more adhesive layers or films may be formed between different films, layers, or structures during the processes shown in FIGS. 2A-2F. For example, an adhesive film may be formed on the top surface of the first barrier film 220-1, and the second alignment structure 210-2 may be formed on the adhesive film.

In some embodiments, the barrier film(s) included in the CLC layer stack 200 may be configured to provide refractive index matching for the neighboring layers (or films, structures) formed on or below the barrier film(s). For example, the first barrier film 220-1 may be configured to have a first refractive index substantially matching with the refractive index of the first CLC layer 215-1 at a first interface (e.g., at a lower surface of the first barrier film 220-1) between the first barrier film 220-1 and the first CLC layer 215-1. The first barrier film 220-1 may also have a second refractive index substantially matching with the refractive index of the second alignment structure 210-2 at a second interface (e.g., at a top surface of the first barrier film 220-2) between the first barrier film 220-1 and the second alignment structure 210-2 (and the second CLC layer 215-2). The first barrier film 220-1 may also have a gradient transition (or profile) between the first refractive index and the second refractive index within the first barrier film 220-1 between the first interface and the second interface. From the first interface to the second interface within the first barrier film 220-1, the refractive index of the first barrier film 220-1 may gradually change from the first refractive index to the second refractive index.

In some embodiments, multiple barrier films included in the CLC layer stack 200 may be configured with a refractive index different from the refractive indices of one or both of the neighboring layers (or films, structures) formed on and/or below the barrier films. The thicknesses of the multiple barrier films may be configured to produce a destructive interference in a light having a predetermined first polarization to suppress an output of a light with an undesirable polarization, and/or produce a constructive interference in a light having a predetermined second polarization different from (e.g., orthogonal to) the predetermined first polarization to enhance an output of a light with a desirable polarization. For example, when the CLC layer stack 200 includes right-handed CLC layers, the thicknesses of the barrier films may be configured to produce a destructive interference in an LHCP light to suppress an output of the LHCP light, and produce a constructive interference in an RHCP light to enhance an output of the RHCP light.

Similar to the first CLC layer 215-1, the second CLC layer 215-2 may have various helical twist structures, such as that of the CLC layer 302 shown in FIG. 3A, the CLC layer 312 shown in FIG. 3B, the CLC layer 322 shown in FIG. 3C, the CLC layer 332 shown in FIG. 3D, or the CLC layer 342 shown in FIG. 3E. In some embodiments, the second CLC layer 215-2 may include an LCP film, which may include passive LCs and/or active LCs. The properties and formation of the second CLC layer 215-2 may be similar to those of the first CLC layer 215-1, and detailed descriptions of the second CLC layer 215-2 can refer to the descriptions of the first CLC layer 215-1 rendered above in connection with FIGS. 2B-2C and FIGS. 3A-3E.

The first CLC layer 215-1 and the second CLC layer 215-2 may have the same thickness or different thicknesses. The first CLC layer 215-1 and the second CLC layer 215-2 may be fabricated from the same cholesteric mixture or different cholesteric mixtures. The first CLC layer 215-1 and the second CLC layer 215-2 may include the same birefringent material or different birefringent materials. In some embodiments, each of the CLC layers 215-1 and 215-2 may include a mixture of different birefringent materials. The LC molecules of the first CLC layer 215-1 and the LC molecules of the second CLC layer 215-2 may be aligned in the same pretilt angle or different pretilt angles. For example, presuming that the floor pretilt angle θ1 and the ceiling pretilt angle θ2 are substantially the same, when the LC molecules included in the first CLC layer 215-1 are configured to have the first pretilt angle θa, and the LC molecules included in the second CLC layer 215-2 are configured to have the second pretilt angle θb, the first pretilt angle θa and the second pretilt angle θb may be the same or different.

The first CLC layer 215-1 and the second CLC layer 215-2 may have the same helical twist structure or different helical twist structures. In some embodiments, each of the first CLC layer 215-1 and the second CLC layer 215-2 may have a respective constant helix pitch. In some embodiments, the constant pitches of the first CLC layer 215-1 and the second CLC layer 215-2 may be the same. In some embodiments, the constant pitches of the first CLC layer 215-1 and the second CLC layer 215-2 may be different. The first CLC layer 215-1 and the second CLC layer 215-2 may have narrow reflection bandwidths each configured for lights of a specific narrow wavelength range. In some embodiments, the reflection bands of the first CLC layer 215-1 and the second CLC layer 215-2 may not overlap with each other. In some embodiments, the reflection bands of the first CLC layer 215-1 and the second CLC layer 215-2 may overlap (e.g., slightly overlap) with each other, such that an overall reflection band of the CLC layer stack 200 may be continuous and broad.

In some embodiments, each of the first CLC layer 215-1 and the second CLC layer 215-2 may have a respective varying (e.g., gradient) helix pitch. The gradient pitch configurations in the first CLC layer 215-1 and the second CLC layer 215-2 may be the same, or may be different. For example, in some embodiments, each of the first CLC layer 215-1 and the second CLC layer 215-2 may have a respective starting pitch, a respective ending pitch, and a respective pitch distribution function f( ). The respective gradient pitch distribution may be expressed as Gₚ=f (starting pitch, ending pitch). For the first CLC layer 215-1 and the second CLC layer 215-2, in some embodiments, the starting pitches, the ending pitches, and the pitch distribution functions f( ) may be the same. In some embodiments, at least one of the starting pitches, the ending pitches, or the pitch distribution functions f( ) may be different. In some embodiments, the first CLC layer 215-1 and the second CLC layer 215-2 may each have a reflection bandwidth configured for lights of a specific broad wavelength band. In some embodiments, the reflection bands of the first CLC layer 215-1 and the second CLC layer 215-2 may not overlap with each other. In some embodiments, the reflection bands of the first CLC layer 215-1 and the second CLC layer 215-2 may overlap (e.g., slightly overlap) with each other, such that an overall reflection band of the stack of the first CLC layer 215-1 and the second CLC layer 215-2 may be further broadened. In some embodiments, one of the first CLC layer 215-1 and the second CLC layer 215-2 may have a varying (e.g., gradient) helix pitch, such as one of configurations shown in FIG. 3D or FIG. 3E, and the other may have a constant helix pitch, such as one of configurations shown in FIGS. 3A-3C.

In some embodiments, as shown in FIG. 2F, a second barrier film 220-2 may be formed at (e.g., on) a surface of the second CLC layer 215-2. The second barrier film 220-2 may be a part of the CLC layer stack 200. The second barrier film 220-2 may be formed on the second surface 2154 (e.g., top surface) of the second CLC layer 215-2. The properties and formation of the second barrier film 220-2 may be similar to those of the first barrier film 220-1, and detailed descriptions of the second barrier film 220-2 may refer to the above descriptions of the first barrier film 220-1. The first barrier film 220-1 and the second barrier film 220-2 may have the same thickness or different thicknesses. The first barrier film 220-1 and the second barrier film 220-2 may include the same type of barrier coatings or different types of barrier coating. For example, both of the first barrier film 220-1 and the second barrier film 220-2 may include the same type of barrier coatings, such as water-borne barrier coatings, solvent-borne barrier coatings, solventless barrier coatings, or sol-gel barrier coating. In some embodiments, the first barrier film 220-1 and the second barrier film 220-2 may include different types of barrier coatings. When including the same type of barrier coatings, the first barrier film 220-1 and the second barrier film 220-2 may be fabricated from the same material or different materials. The first barrier film 220-1 and the second barrier film 220-2 may be fabricated through the same coating method or different coating methods.

In some embodiments, although not shown, a third alignment structure may be formed at (e.g., on) the top surface of the second barrier film 220-2, and a third birefringent film (e.g., a third CLC layer) may be formed at (e.g., on) the top surface of the third alignment structure. In similar manners, additional barrier films, alignment structures, and birefringent films (e.g., CLC layers) may be formed. The number of layers of birefringent films, barrier films, and alignment structures can be any suitable number, such as four, five, six, seven, eight, nine, ten, etc.

In some embodiments, when the top surface of the second barrier film 220-2 is exposed to air, the second barrier film 220-2 may provide index matching for the air and the second CLC layer 215-2. For example, the second barrier film 220-2 may be configured to have a first refractive index substantially matching with the refractive index of the second CLC layer 215-2 at a first interface (e.g., at the bottom surface of the second barrier film 220-2) between the second barrier film 220-2 and the second CLC layer 215-2. The second barrier film 220-2 may have a second refractive index substantially matching with the refractive index of the air at a second interface (e.g., at the top surface of the second barrier film 220-2) between the second barrier film 220-2 and the air. The second barrier film 220-2 may also have a gradient transition between the first refractive index and the second refractive index within the second barrier film 220-2 between the first interface and the second interface. From the first interface to the second interface with in the second barrier film 220-2, the refractive index of the second barrier film 220-2 may gradually change from the first refractive index to the second refractive index.

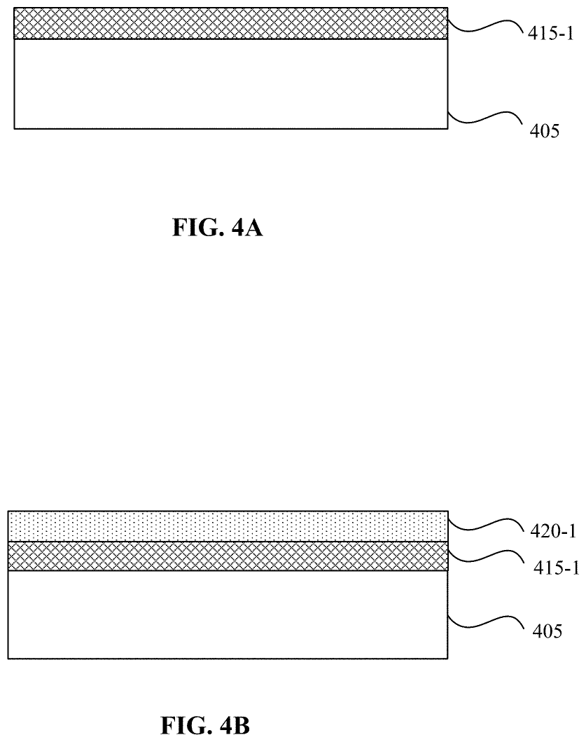

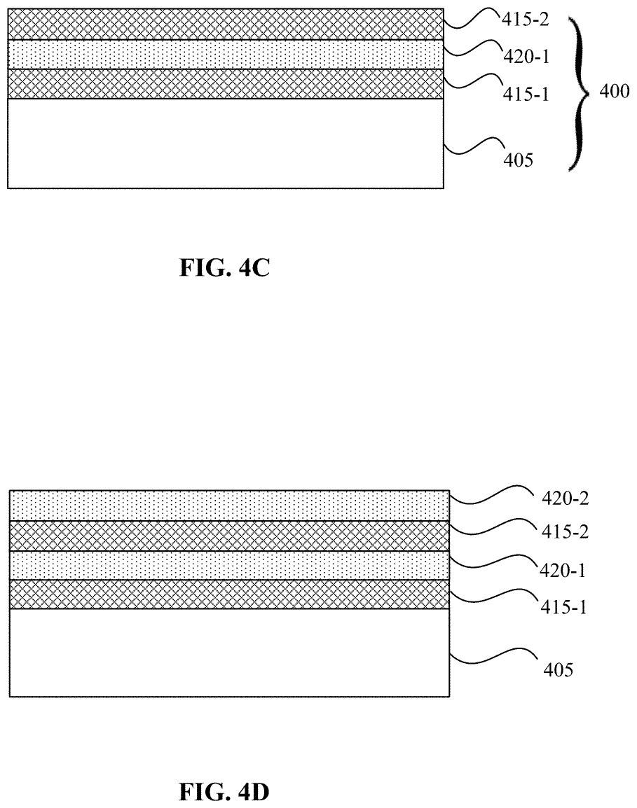

FIGS. 4A-4D illustrate schematic diagrams showing processes for fabricating a birefringent film stack (e.g., a CLC layer stack), according to another embodiment of the present disclosure. The fabrication processes shown in FIGS. 4A-4D may include steps or processes similar to those shown in FIGS. 2A-2F. The CLC layer stack fabricated based on the processes shown in FIGS. 4A-4D may include elements similar to those included in the CLC layer stack fabricated based on the processes shown in FIGS. 2A-2F. Descriptions of the similar steps and similar elements can refer to the descriptions rendered above in connection with FIGS. 2A-2F. Although the substrate and films or layers are shown as having flat surfaces, in some embodiments, the substrate and films or layers formed thereon may include curved surfaces.

As shown in FIG. 4A, a first birefringent film 415-1 may be formed at (e.g., on) a surface of a substrate 405. The substrate 405 may be an embodiment of the substrate 205 shown in FIGS. 2A-2F. The first birefringent film 415-1 may be formed directly on the substrate 405 without an alignment structure formed first on the substrate 405. The first birefringent film 415-1 may include a first birefringent material having a chirality. The first birefringent material may have an induced birefringence and an alignment provided through a polarized light irradiation. For discussion purposes, a CLC layer is used as an example of the first birefringent film 415-1. Thus, the first birefringent film 415-1 may also be referred to as a first CLC layer 415-1. The first birefringent film 415-1 may have a cholesteric order. For example, the first birefringent film 415-1 may have a suitable helical twist structure disclosed herein, such as those shown in FIGS. 3A-3E. Detailed descriptions of the various helical twist structures may refer to the descriptions rendered above in connection with FIGS. 3A-3E.

In some embodiments, the first CLC layer 415-1 may be formed through dispensing (e.g., coating, depositing, etc.) a thin layer of a cholesteric mixture on a surface (e.g., a top surface) of the substrate 405, and exposing the thin layer of the cholesteric mixture to a polarized light irradiation. The cholesteric mixture may include one or more polarization sensitive materials, which may be initially substantially isotropic (i.e., substantially isotropic before the exposure process), and may exhibit an induced (e.g., photo-induced) optical anisotropy after being exposed to the polarized light irradiation. That is, the molecules of polarization sensitive materials may be initially substantially isotropic (i.e., before the exposure process), and become optically anisotropic after the exposure. The molecules of the polarization sensitive materials may include one or more polarization sensitive groups, such as an azobenzene group, a cinnamate group, a coumarin group, or any combination thereof, etc. In some embodiments, the one or more polarization sensitive materials may include photopolymers. Exposing the cholesteric mixture to the polarized light irradiation may photo-polymerize the cholesteric mixture.

After being sufficiently exposed to a polarized light irradiation, due to an effect of photoinduced anisotropy, birefringence may be induced in the polarization sensitive material. The optically anisotropic molecules may be aligned in a predetermined alignment pattern according to the polarized light irradiation. Such an alignment process may be referred to bulk-mediated photo-alignment. Thus, alignment structures, such as 210-1 and 210-2 shown in FIGS. 2A-2F may be omitted. In some embodiments, the cholesteric mixture may also include chiral dopants. In some embodiments, the polarization sensitive material may have an intrinsic molecular chirality. For example, the molecules of the polarization sensitive material may include a chiral group, such as a menthyl fragment, and the process of bulk-mediated photo-alignment may not affect the chiral group included in the molecules.

After the first CLC layer 415-1 is formed on the surface of the substrate 405, as shown in FIG. 4B, a first barrier film 420-1 may be formed at (e.g., on) a surface of the first CLC layer 415-1. For example, the first CLC layer 415-1 may have a first surface (e.g., bottom surface) facing the substrate 405 and an opposing second surface (e.g., top surface). The first barrier film 420-1 may be formed on the second surface (e.g., top surface) of the first CLC layer 415-1. The first barrier film 420-1 may be an embodiment of the first barrier film 220-1 shown in FIGS. 2C-2F. Descriptions of the properties and forming process of the first barrier film 420-1 may refer to the descriptions of those of the first barrier film 220-1. In some embodiments, the first barrier film 420-1 may be configured to provide a barrier between the first CLC layer 415-1 and another layer formed in the subsequent process, such as a second CLC layer 415-2 shown in FIG. 4C. The first barrier film 420-1 may be configured to reduce or suppress diffusion and/or interactions between the first CLC layer 415-1 and another layer formed in the subsequent process, such as the second CLC layer 415-2 shown in FIG. 4C. The first barrier film 420-1 may reduce or suppress the contraction (or shrink) and/or swelling (or expansion) of the first CLC layer 415-1 and the second CLC layer 415-2. In some embodiments, the first barrier film 420-1 may also be configured to provide other functions, such as the barrier functions against permeation of undesirable substance into the first CLC layer 415-1, e.g., moisture, oxygen, and/or grease.

In some embodiments, the first barrier film 420-1 may provide index matching between the first CLC layer 415-1 and the second CLC layer 415-2. For example, the first barrier film 420-1 may be configured to have a first refractive index substantially matching with the refractive index of the first CLC layer 415-1 at a first interface (e.g., at the bottom surface of the first barrier film 420-1) between the first barrier film 420-1 and the first CLC layer 415-1. The first barrier film 420-1 may have a second refractive index substantially matching with the refractive index of the second CLC layer 415-2 at a second interface (e.g., at the top surface of the first barrier film 420-1) between the first barrier film 420-1 and the second CLC layer 415-2. The first barrier film 420-1 may further have a gradient transition between the first refractive index and the second refractive index within the first barrier film 420-1 between the first interface and the second interface. From the first interface to the second interface inside the first barrier film 420-1, the refractive index of the first barrier film 420-1 may gradually change from the first refractive index to the second refractive index.

In some embodiments, the first barrier film 420-1 may include a water-borne barrier coating, a solvent-borne barrier coating, a solventless barrier coating, a sol-gel coating, or any combination thereof. In some embodiments, the first barrier film 420-1 may include a water-borne barrier coating, which may be formed on the first CLC layer 415-1 through dispensing (e.g., coating, depositing, etc.) a thin layer of water-borne barrier coating composition on the first CLC layer 415-1. The thin layer of the water-borne barrier coating composition may be processed (e.g., cured, polymerized, dried, etc.). In some embodiments, the first barrier film 420-1 may include a solventless barrier coating, such as an acrylate barrier coating. The solventless barrier coating may be formed on the first CLC layer 415-1 through a solventless coating method, such as compression coating, hot-melt coating, supercritical fluid spray coating, electrostatic coating, dry powder coating, physical vapor deposition coating, chemical vapor deposition coating, or photocurable coating, etc. In some embodiments, the solventless barrier coating may be formed through dispensing (e.g., coating, etc.) a thin layer of a solventless barrier composition on the first CLC layer 415-1. The thin layer of the solventless barrier coating composition may be processed (e.g., cured, polymerized, dried, etc.) to form the solventless barrier coating. In some embodiments, the solventless barrier coating may be formed on the first CLC layer 415-1 through depositing (e.g., physical vapor deposition coating, chemical vapor deposition coating, etc.) a thin layer of a solventless barrier composition on the first CLC layer 415-1 without further processing (e.g., curing, polymerizing, or drying).

After the first barrier film 420-1 is formed on the first birefringent film 415-1, as shown in FIG. 4C, a second birefringent film 415-2 may be formed at (e.g., on) the first barrier film 420-1. The first barrier film 420-1 may have a first surface (e.g., bottom surface) facing the substrate 405 and an opposing second surface (e.g., top surface). The second birefringent film 415-2 may be formed on the second surface of the first barrier film 420-1. Descriptions of the properties and forming process of the second birefringent film 415-2 may refer to the descriptions of those of the first birefringent film 415-1. Similar to the first birefringent film 415-1, the second birefringent film 415-2 may include a second birefringent material having a chirality. The second birefringent material may be similar to the first birefringent material included in the first birefringent film 415-1. For example, the second birefringent material may have an induced birefringence and an alignment provided through a polarized light irradiation. The second birefringent film 415-2 may have a suitable helical twist structure disclosed herein, such as those shown in FIGS. 3A-3E. Detailed descriptions of the various helical twist structures may refer to the descriptions rendered above in connection with FIGS. 3A-3E. For discussion purposes, a CLC layer is used as an example of the second birefringent film 415-2. Thus, the second birefringent film 415-2 may also be referred to as a second CLC layer 415-2. In some embodiments, after the second CLC layer 415-2 is formed on the first barrier film 420-1, a CLC layer stack 400 including two CLC layers 415-1 and 415-2 is fabricated. In some embodiments, the properties and formation of the second CLC layer 415-2 may be similar to those of the first CLC layer 415-1. Detailed descriptions of the second CLC layer 415-2 can refer to the descriptions of the first CLC layer 415-1 rendered above in connection with FIG. 4A.

The first CLC layer 415-1 and the second CLC layer 415-2 may have the same thickness or different thicknesses. The first CLC layer 415-1 and the second CLC layer 415-2 may be fabricated from the same cholesteric mixture or different cholesteric mixtures. The first CLC layer 415-1 and the second CLC layer 415-2 may include the same birefringent material or different birefringent materials. The LC molecules of the first CLC layer 415-1 and the LC molecules of the second CLC layer 415-2 may be configured in the same pretilt angle or different pretilt angles. Presuming that in each CLC layer, the floor pretilt angle and the ceiling pretilt angle are the same, when the LC molecules in the first CLC layer 415-1 are configured in the first pretilt angle θa, and the LC molecules in the second CLC layer 415-2 are configured in the second pretilt angle θb, the first pretilt angle θa and the second pretilt angle θb may be the same or may be different.

The first CLC layer 415-1 and the second CLC layer 415-2 may have the same helical twist structure or different helical twist structures. In some embodiments, each of the first CLC layer 415-1 and the second CLC layer 415-2 may have a respective constant helix pitch. For example, each of the first CLC layer 415-1 and the second CLC layer 415-2 may have one of the CLC structures shown in FIGS. 3A-3C. The respective constant helix pitches of the first CLC layer 415-1 and the second CLC layer 415-2 may be the same or may be different. The first CLC layer 415-1 and the second CLC layer 415-2 may have narrow reflection bandwidths each configured for lights of a specific narrow wavelength range. In some embodiments, the reflection bands of the first CLC layer 415-1 and the second CLC layer 415-2 may not overlap with each other. In some embodiments, the reflection bands of the first CLC layer 415-1 and the second CLC layer 415-2 may overlap (e.g., slightly overlap) with each other, such that an overall reflection band of the CLC layer stack 400 may be continuous and broad.

In some embodiments, the CLC layer stack 400 may not include the substrate 405. That is, the substrate 405 may be removed or separated from the rest of the CLC layer stack 400 after the various layers or films have been formed on the substrate 405. To separate the substrate 405, a water-soluble adhesive layer (e.g., polyvinyl alcohol) may be formed on the top surface of the substrate 405 before the first CLC layer 415-1 is formed on the substrate 405. That is, the water-soluble adhesive layer may be formed on the substrate 405, and the first CLC layer 415-1 may be formed on the water-soluble adhesive layer. After the various CLC layers are formed, the substrate 405 may be separated from the rest of the CLC layer stack 400 by dissolving the water-soluble adhesive layer.

In some embodiments, each of the first CLC layer 415-1 and the second CLC layer 415-2 may have a varying (e.g., gradient) helix pitch. That is, the first CLC layer 415-1 and the second CLC layer 415-2 may be varying-pitch CLC layers. The varying helix pitches of the first CLC layer 415-1 and the second CLC layer 415-2 may be the same or may be different. For example, the helix pitches of the first CLC layer 415-1 and the second CLC layer 415-2 may have different gradient pitch profiles or configurations. As described above, at least one of the starting pitches, the ending pitches, or the pitch distribution functions f( ) may be different for the first CLC layer 415-1 and the second CLC layer 415-2. In some embodiments, the first CLC layer 415-1 and the second CLC layer 415-2 may each have a reflection band configured for lights of a specific broad wavelength band. In some embodiments, the reflection bands of the first CLC layer 415-1 and the second CLC layer 415-2 may not overlap with each other. In some embodiments, the reflection bands of the first CLC layer 415-1 and the second CLC layer 415-2 may overlap (e.g., slightly overlap) with each other, such that an overall reflection band of the CLC layer stack 400 may be further broadened. In some embodiments, one of the first CLC layer 415-1 and the second CLC layer 415-2 may be a gradient-pitch CLC layer, e.g., one of the CLC layers shown in FIGS. 3D and 3E, and the other may be a constant-pitch CLC layer, e.g., one of the CLC layers shown in FIGS. 3A-3C.

In some embodiments, as shown in FIG. 4D, a second barrier film 420-2 may be formed at (e.g., on) a surface of the second CLC layer 415-2. The second barrier film 420-2 may be a part of the CLC layer stack 400. The second CLC layer 415-2 may have a first surface (e.g., bottom surface) facing the substrate 405 and a second, opposing surface (e.g., top surface). The second barrier film 420-2 may be formed on the second surface of the second CLC layer 415-2. The properties and formation of the second barrier film 420-2 may be similar to those of the first barrier film 420-1. Detailed descriptions of the second barrier film 420-2 may refer to the above descriptions of the first barrier film 420-1.

The first barrier film 420-1 and the second barrier film 420-2 may have the same thickness or different thicknesses. The first barrier film 420-1 and the second barrier film 420-2 may include the same type of barrier coatings or different types of barrier coatings. For example, in some embodiments, both the first barrier film 420-1 and the second barrier film 420-2 may include the same type of barrier coatings. In some embodiments, the first barrier film 420-1 and the second barrier film 420-2 may include different types of barrier coatings. When including the same type of barrier coatings, the first barrier film 420-1 and the second barrier film 420-2 may be formed from the same material or different materials. The first barrier film 420-1 and the second barrier film 420-2 may be formed though the same method or different methods. In some embodiments, although not shown, a third birefringent film (e.g., a third CLC layer) may be formed at (e.g., on) a surface of the second barrier film 420-2. In some embodiments, additional birefringent films (e.g., CLC layers) and barrier films may be formed following similar processes. The number of birefringent films and barrier films may be any suitable number, such as two, three, four, five, six, seven, eight, nine, ten, etc.

In some embodiments, when the top surface of the second barrier film 420-2 is exposed to air, the second barrier film 420-2 may provide index matching for the air and the second CLC layer 415-2. For example, the second barrier film 420-2 may be configured to have a first refractive index substantially matching with the refractive index of the second CLC layer 415-2 at a first interface (e.g., at the bottom surface of the second barrier film 420-2) between the second barrier film 420-2 and the second CLC layer 415-2. The second barrier film 420-2 may include a second refractive index substantially matching with the refractive index of the air at a second interface (e.g., at the top surface of the second barrier film 420-2) between the second barrier film 420-2 and the air. The second barrier film 420-2 may also have a gradient transition between the first refractive index and the second refractive index within the second barrier film 420-2 between the first interface and the second interface. From the first interface to the second interface within the second barrier film 420-2, the refractive index of the second barrier film 420-2 may gradually change from the first refractive index to the second refractive index.

In some embodiments, multiple barrier films included in the CLC layer stack 400 may be configured with a refractive index different from the refractive indices of one or both of the neighboring layers (or films, structures) formed on and/or below the barrier films. The thicknesses of the multiple barrier films may be configured to produce a destructive interference in a light having a predetermined first polarization to suppress an output of a light with an undesirable polarization, and produce a constructive interference in a light having a predetermined second polarization different from (e.g., orthogonal to) the predetermined first polarization to enhance an output of a light with a desirable polarization. For example, when the CLC layer stack 400 includes right-handed CLC layers, the thicknesses of the multiple barrier films may be configured to produce a destructive interference in an LHCP light to suppress an output of the LHCP light, and produce a constructive interference in an RHCP light to enhance an output of the RHCP light.

In the processes shown in FIGS. 2A-2F and FIGS. 4A-4D, various films, layers, or structures of a birefringent film stack (e.g., CLC layer stack) are formed onto the substrate one over another, by dispensing (e.g., coating, depositing, etc.) a respective composition or mixture to the substrate (or the underlying film formed in a preceding process) and processing (e.g., curing, drying, etc.) the composition or mixture to obtain a respective film, layer, or structure. The processes of forming such films, layers, and structures of the CLC layer stack are different from, and have advantage over, conventional processes of laminating pre-formed or pre-fabricated films, layers, or structures together, e.g., using an adhesive (e.g., a liquid adhesive or a solid adhesive tape). Forming films, layers, or structures of a CLC layer stack one over another according to the disclosed fabrication method can resolve various issues and difficulties associated with the conventional processes of laminating pre-fabricated films, layers, and structures, such as the surface uniformity degradation caused by physical lamination, performance degradation caused by errors in positioning different layers one over another, reliability degradation, fabrication time and complexity increase, etc.

The disclosed processes shown in FIGS. 2A-2F and FIGS. 4A-4D simplify the fabrication processes of the CLC layer stack including a number of CLC layers (e.g., more than 10 CLC layers). As a result, the disclosed fabrication method provides a robust process for mass production of CLC layer stacks with a reduced weight, an improved surface roughness, and enhanced optical performance and reliability. In addition, the disclosed fabrication method may reduce the thickness of the CLC layer stack by forming the barrier films that are thinner than conventional adhesive films. The reduction in the thickness of the CLC layer stack may reduce an optical path difference of lights reflected by the respective CLC layers in the CLC layer stack. For example, a CLC layer stack configured for a visible wavelength range may include three CLC layers having a reflection band in the wavelength ranges of blue, green, and red lights, respectively. The three CLC layers may reflect circularly polarized blue, green, and red lights, respectively.

In conventional technologies, adhesive films are used to laminate the CLC layers. When a circularly polarized visible light is incident onto the CLC layer stack, the optical path difference of any two of the reflected blue, green, and red lights may be large. When the reflected blue, green, and red lights are superimposed at the output side of the CLC layer stack, color separation may be observed in a conventional CLC layer stack. The optical path difference may further increase as an incidence angle of the circularly polarized visible light increases, which may further increase the color separation in the conventional CLC layer stack. In the present disclosure, through forming the thinner barrier films (as compared to conventional adhesive films) between adjacent CLC layers, the optical path difference of lights reflected by any two of the three CLC layers may be reduced. For example, the optical path difference of any two of the three reflected blue, green, and red lights may be reduced. Thus, when the reflected blue, green, and red lights are superimposed at the output side of the CLC layer stack, color separation in the visible light may be reduced.

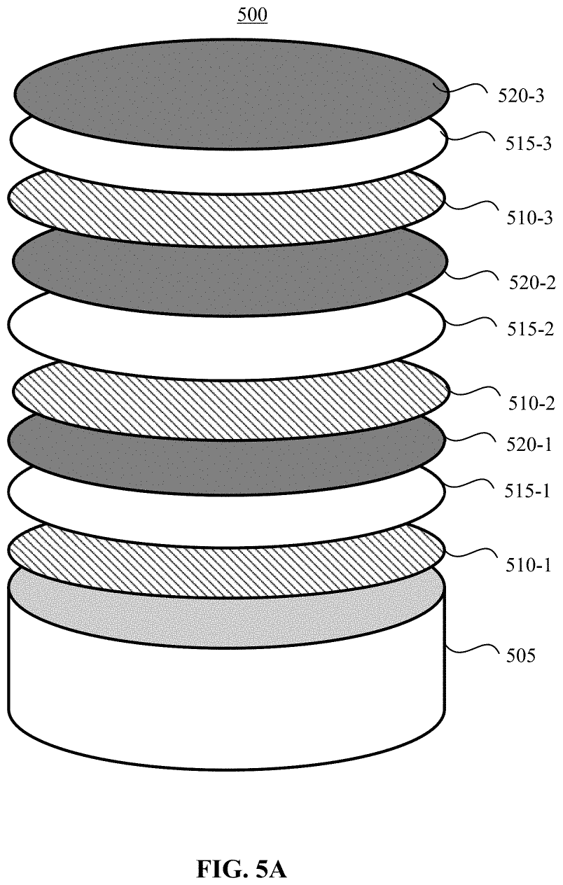

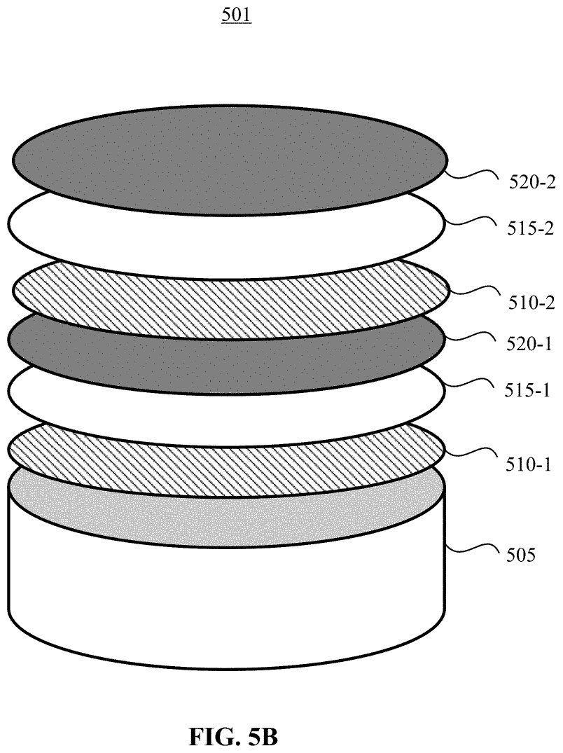

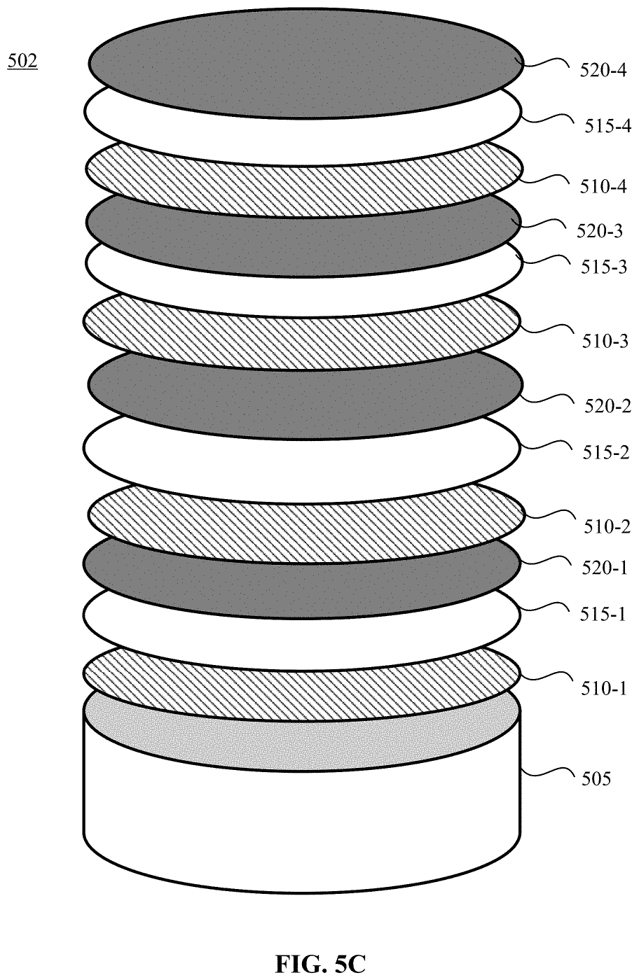

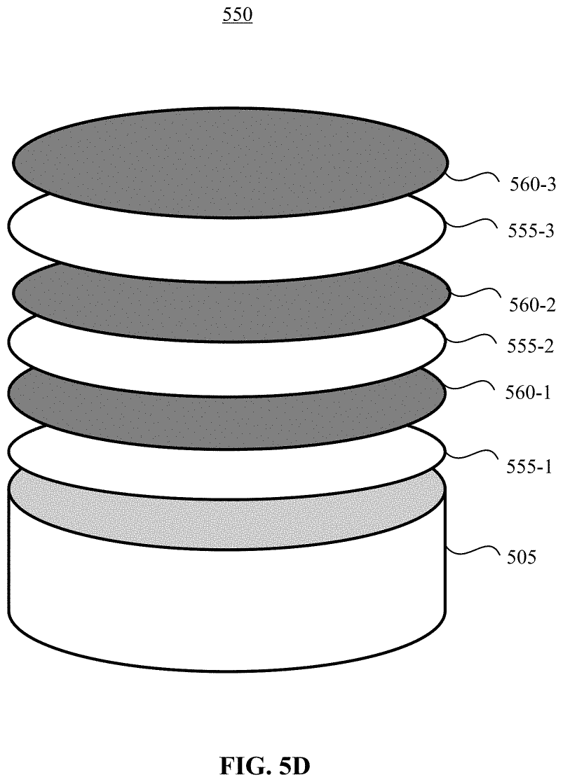

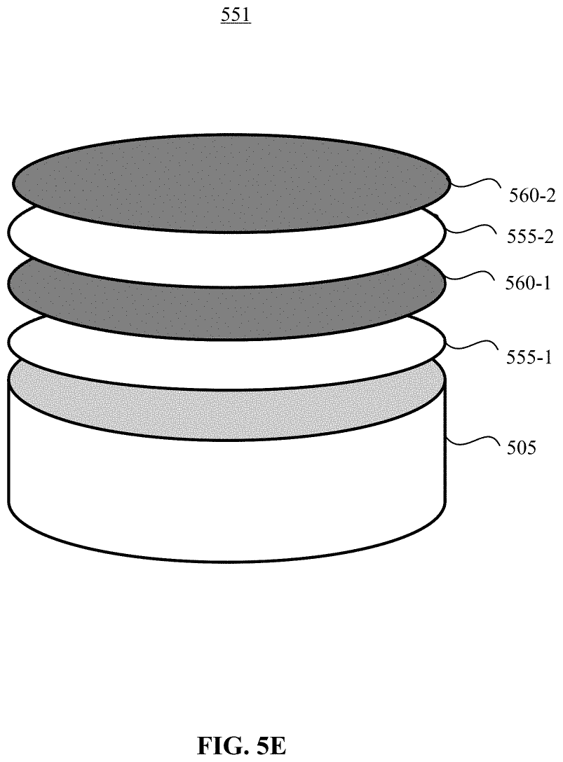

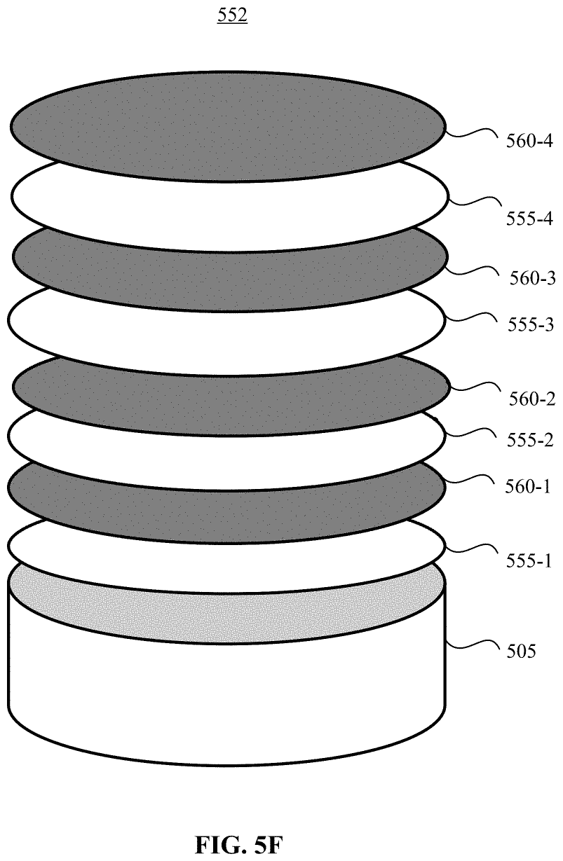

FIGS. 5A-5F illustrate schematic perspective views of birefringent film stacks in accordance with various embodiments of the present disclosure. The birefringent film stacks may be fabricated based on any suitable processes. In some embodiments, the birefringent film stacks shown in FIGS. 5A-5F may be fabricated through the disclosed fabrication processes, such as those shown in FIGS. 2A-2F or FIGS. 4A-4D. In other words, in some embodiments, each of the birefringent film stacks shown in FIGS. 5A-5F may be fabricated by forming individual films one over another on the substrate 505, as illustrated in FIGS. 2A-2F or FIGS. 4A-4D, rather than being physically laminating pre-fabricated films together using adhesives, as in conventional technologies. It is understood that although in the following descriptions, the birefringent film stacks shown in FIGS. 5A-5F may be described as being fabricated using the disclosed fabrication methods, the birefringent film stacks shown in FIGS. 5A-5F may not be limited to being fabricated through the disclosed fabrication methods. For discussion purposes, in FIGS. 5A-5F, a CLC layer stack is used as an example of the birefringent film stack, and CLC layers are used as examples of the birefringent films. Thus, each of the birefringent film stacks shown in FIGS. 5A-5F may also be referred to as a CLC layer stack. In the birefringent film stacks shown in FIGS. 5A-5F, although the substrate and films or layers formed thereon are shown as having flat surfaces, in some embodiments, the substrate and the films or layers may have curved surfaces.

FIG. 5A illustrates a schematic perspective view of a birefringent film stack 500. The birefringent film stack 500 may be fabricated using any suitable processes, such as the processes disclosed in the present disclosure. In some embodiments, the birefringent film stack 500 may be fabricated using the method or processes described above in connection with FIGS. 2A-2F. For discussion purposes, the birefringent film stack 500 is also referred to as a CLC layer stack 500. As shown in FIG. 5A, the CLC layer stack 500 may include a plurality of alignment structures, a plurality of CLC layers, and a plurality of barrier films alternatingly disposed (e.g., formed) on a surface of a substrate 505. The number of the alignment structures can be any suitable number, such as 1, 2, 3, 4, 5, etc. The number of the CLC layers can be any suitable number, such as 1, 2, 3, 4, 5, etc. The number of the barrier films can be any suitable number, such as 1, 2, 3, 4, 5, etc. For illustrative purposes, FIG. 5A shows that the CLC layer stack 500 includes three alignment structures 510-1, 510-2, and 510-3, three CLC layers 515-1, 515-2, and 515-3, and three barrier films 520-1, 520-2, and 520-3 alternatingly disposed (e.g., formed) on a top surface of the substrate 505. The CLC layer stack 500 may include additional alignment structures, CLC layers, and/or barrier films.

The substrate 505 may be an embodiment of the substrate 205 shown in FIGS. 2A-2F or the substrate 405 shown in FIGS. 4A-4D. The thickness of the substrate 505 may be in the order of millimeters (“mm”), e.g., 1-10 mm. In some embodiments, at least one (e.g., each) CLC layer may be disposed (e.g., formed) between a corresponding alignment structure and a corresponding barrier film. In some embodiments, a CLC layer may be directly formed on a surface of the corresponding alignment structure, and may be in direct contact with the corresponding alignment structure. A corresponding barrier film may be directly formed on the CLC layer, and may be in direct contact with the CLC layer. In some embodiments, the corresponding barrier film may be indirectly formed on the underlying CLC layer. For example, another optical film may be formed between the underlying CLC layer and the barrier film formed on the CLC layer. Although not shown, in some embodiments, one or more adhesive layers may be formed on a top surface of a suitable layer or film, such as on a barrier film, a CLC layer, or an alignment structure.

In the birefringent film stack 500 shown in FIG. 5A, a CLC layer may have a first surface (e.g., bottom surface) facing the substrate and a second, opposing surface (e.g., top surface). The corresponding alignment structure may be disposed (e.g., formed) at (e.g., on) the first surface of the CLC layer, and the corresponding barrier film may be disposed (e.g., formed) at (e.g., on) the second surface of the CLC layer. At least one (e.g., each) CLC layer may include a birefringent material having a chirality. In some embodiments, at least one (e.g., each) CLC layer may have a cholesteric order. For example, at least one (e.g., each) CLC layer may include CLCs configured to have a helical twist structure. The CLC layer may be configured to have various helical twist structures, such as that of the CLC layer 302 shown in FIG. 3A, that of the CLC layer 312 shown in FIG. 3B, that of the CLC layer 322 shown in FIG. 3C, that of the CLC layer 332 shown in FIG. 3D, or that of the CLC layer 342 shown in FIG. 3E. For example, a helical axis of the helical twist structure may be substantially normal (e.g., perpendicular) to a surface of the CLC layer. In some embodiments, a helical axis of the first helical twist structure may be substantially parallel to a surface of the CLC layer.

In some embodiments, the CLC layer may have a helical twist structure of a constant helix pitch (e.g., repeat of a same, fixed helix pitch within the CLC layer). Such a CLC layer may be referred to as a single-pitch CLC layer. In some embodiments, the CLC layer may have a helical twist structure of a varying (e.g., non-constant) helix pitch, e.g., a gradient helix pitch. Such a CLC layer may be referred to as a gradient-pitch CLC layer. In some embodiments, the helical twist structure (or a helical superstructure) of the CLC layer may be a helicoidal superstructure, in which LC molecules may rotate around the helical axis. The LC directors (i.e., long axes) of the LC molecules may be substantially perpendicular to the helical axis. In some embodiments, the helical twist structure (or a helical superstructure) of the CLC layer may be a heliconical superstructure, in which LC molecules may rotate around the helical axis. The LC directors (i.e., long axes) of the LC molecules may have oblique angles (e.g., oblique acute angles) with respective to the helical axis. In some embodiments, at least one (e.g., each) CLC layer may include an LCP film. In some embodiments, the LCP film may include passive LCs that are not switchable (or not reorientable) by an external field (e.g., an external electric field, magnetic field, or light field), such as polymerized (e.g., photo-polymerized) CLCs. In some embodiments, the LCP film may include active LCs that are switchable (or reorientable) by an external field (e.g., an external electric field, magnetic field, or light field), such as polymer-stabilized CLCs where active LCs may be disposed in a polymer network.

The CLC layers in the CLC layer stack 500 may include the same birefringent material or different birefringent materials. For example, at least two CLC layers may include different birefringent materials. The thickness of the CLC layer may be in the order of micrometer (“μm”), e.g., 1-5 μm, 5-10 μm, 10-15 μm, or 15-20 μm. The CLC layers may have the same thickness or different thicknesses. For example, at least two CLC layers may have different thicknesses. The LC molecules in the CLC layers may be configured to have the same pretilt angle or different pretilt angles. Presuming that the floor pretilt angle and the ceiling pretilt angle in each CLC layer are substantially the same, and LC molecules in each CLC layer are configured in a respective pretilt angle, in some embodiments, the LC molecules in at least two CLC layers may have different pretilt angles. In some embodiments, the pretilt angles of the LC molecules in all of the CLC layers may vary from layer to layer. For example, the pretilt angles of the LC molecules in the CLC layers may gradually increase or decrease from layer to layer, in a thickness direction (e.g., z-axis direction) of the CLC layer stack 500. In some embodiments, the pretilt angles of the LC molecules in the CLC layers may vary randomly. In some embodiments, the pretilt angles of the LC molecules in at least two (e.g., all) CLC layers may be the same.

The CLC layers may have the same helical twist structure or different helical twist structures. For example, at least two CLC layers may have different helical twist structures. In some embodiments, each CLC layer may include a constant helix pitch. That is, each CLC layer included in the CLC layer stack 500 may have any of the constant pitch structures shown in FIGS. 3A-3C with a respective constant pitch. In some embodiments, the constant helix pitches of all of the plurality of single-pitch CLC layers may vary from layer to layer. In some embodiments, at least two helix pitches of the plurality of single-pitch CLC layers may be different. In some embodiments, at least two (e.g., all) of the constant helix pitches of the single-pitch CLC layers may be the same. When single-pitch CLC layers are included, the single-pitch CLC layers may have narrow reflection bandwidths each configured to cover a specific narrow wavelength range. In some embodiments, the single-pitch CLC layers may be optically coupled to corresponding narrowband (e.g., 30-nm bandwidth) light sources configured to emit lights in different colors (e.g., different wavelengths). In some embodiments, the reflection bands of the single-pitch CLC layers may not overlap with each other. In some embodiments, the reflection bands of the single-pitch CLC layers may overlap (e.g., slightly overlap) with each other, such that an overall reflection band of the CLC layer stack may be continuous and broad.

For example, as shown in FIG. 5A, each of the CLC layers 515-1, 515-2, and 515-3 may have a reflection band in the wavelength ranges of blue, green, and red lights, respectively, and the CLC layer stack 500 may achieve a reflection band covering the entire visible wavelength range. The stack configuration of the three CLC layers 515-1, 515-2, and 515-3 as shown in FIG. 5A is for illustration only. Other suitable configurations may be used. In some embodiments, each of the CLC layers 515-1, 515-2, and 515-3 may have a reflection band in the wavelength ranges of blue, red, and green lights, respectively. In some embodiments, each of the CLC layers 515-1, 515-2, and 515-3 may have a reflection band in the wavelength ranges of green, red, and blue lights, respectively. In some embodiments, each of the CLC layers 515-1, 515-2, and 515-3 may have a reflection band in the wavelength ranges of green, blue, and red lights, respectively. In some embodiments, each of the CLC layers 515-1, 515-2, and 515-3 may have a reflection band in the wavelength ranges of red, green, and blue lights, respectively. In some embodiments, each of the CLC layers 515-1, 515-2, and 515-3 may have a reflection band in the wavelength ranges of red, blue, and green lights, respectively. In some embodiments, each of the CLC layer stack 500 may achieve a reflection band covering at least one of a UV spectrum, a visible spectrum, or an IR spectrum. In some embodiments, a substrate or a protective layer (or film) may be disposed on the CLC layer 515-3 to provide support and/or protection. In some embodiments, the third barrier film 520-3 may be omitted.

In some embodiments, each CLC layer may include a varying (e.g., gradient) helix pitch. For example, each CLC layer included in the CLC layer stack 500 may be an embodiment of any of the gradient-pitch CLC layers shown in FIGS. 3D and 3E. In some embodiments, at least two (e.g., all) of the varying helix pitches (or gradient pitch profile, configuration, or distribution) in at least two (e.g., all) of the varying-pitch CLC layers may be different. For example, in the varying-pitch CLC layers having different varying helix pitches, at least one of the starting pitches, the ending pitches, or the pitch distribution functions f( ) may be different between layers. In some embodiments, at least two (e.g., all) of the varying helix pitches in at least two (e.g., all) of the varying-pitch CLC layers may be the same. For example, for any two varying-pitch CLC layers having the same gradient pitch, the starting pitches, the ending pitches, and the pitch distribution functions f( ) may be the same. In some embodiments, the varying-pitch CLC layers may each have a reflection band configured to cover a specific wavelength band. In some embodiments, the reflection bands of the varying-pitch CLC layers may or may not overlap with one another.

In some embodiments, the plurality of CLC layers included in the CLC layer stack 500 may include at least one single-pitch CLC layer and at least one gradient-pitch CLC layer. For example, the CLC layer stack 500 may include at least one CLC layer having a structure similar to any of those shown in FIGS. 3A-3C, and at least one CLC layer having a structure similar to any of those shown in FIGS. 3D and 3E. In some embodiments, the CLC layer stack 500 may include at least two CLC layers 302 shown in FIG. 3A stacked together. For example, at least two (e.g., each) of the first CLC layer 515-1, the second CLC layer 515-2, and the third CLC layer 515-3 may be an embodiment of the CLC layer 302 with a respective constant pitch. The constant pitches of the at least two (e.g., each) of the first CLC layer 515-1, the second CLC layer 515-2, and the third CLC layer 515-3 may be the same or different. In some embodiments, all of the CLC layers 515-1, 515-2, and 515-3 may be an embodiment of the CLC layer 302 with a respective constant pitch. The constant pitches may be the same or may be different. In some embodiments, two layers of the CLC layers 515-1, 515-2, and 515-3 may be an embodiment of the CLC layer 302 with a respective constant pitch, and the third layer of the CLC layers 515-1, 515-2, and 515-3 may be an embodiment of the CLC layer 312, the CLC layer 322, the CLC layer 332, or the CLC layer 342. When the third layer is a constant pitch layer (e.g., CLC layer 312 or 322), the constant pitches of the three CLC layers 515-1, 515-2, and 515-3 may be the same or may be different (e.g., at least two constant pitches may be different).

In some embodiments, the CLC layer stack 500 may include at least two CLC layers 312 shown in FIG. 3B stacked together. For example, each of the first CLC layer 515-1, the second CLC layer 515-2, and the third CLC layer 515-3 may be an embodiment of the CLC layer 312 with a respective constant pitch. The constant pitches may be the same or may be different. In some embodiments, two layers of the CLC layers 515-1, 515-2, and 515-3 may be an embodiment of the CLC layer 312 with a respective constant pitch, and the third layer of the CLC layers 515-1, 515-2, and 515-3 may be an embodiment of the CLC layer 302, the CLC layer 322, the CLC layer 332, or the CLC layer 342. When the third layer is a constant pitch layer (e.g., CLC layer 302 or 322), the constant pitches of the three CLC layers 515-1, 515-2, and 515-3 may be the same or may be different (e.g., at least two constant pitches may be different).

In some embodiments, the CLC layer stack 500 may include at least two CLC layers 322 shown in FIG. 3C stacked together. For example, each of the first CLC layer 515-1, the second CLC layer 515-2, and the third CLC layer 515-3 may be an embodiment of the CLC layer 322 with a respective constant pitch. The constant pitches may be the same or may be different. In some embodiments, two layers of the CLC layers 515-1, 515-2, and 515-3 may be an embodiment of the CLC layer 322 with a respective constant pitch, and the third layer of the CLC layers 515-1, 515-2, and 515-3 may be an embodiment of the CLC layer 302, the CLC layer 312, the CLC layer 332, or the CLC layer 342. When the third layer is a constant pitch layer (e.g., CLC layer 302 or 312), the constant pitches of the three CLC layers 515-1, 515-2, and 515-3 may be the same or may be different (e.g., at least two constant pitches may be different).

In some embodiments, the CLC layer stack 500 may include at least two gradient-pitch CLC layer 332 shown in FIG. 3D stacked together. For example, at least two (e.g., each) of the first CLC layer 515-1, the second CLC layer 515-2, and the third CLC layer 515-3 may be an embodiment of the gradient-pitch CLC layer 332 with a respective gradient pitch (or gradient pitch profile, configuration, or distribution). The gradient pitches (or gradient pitch profiles, configurations, or distributions) of at least two of the first CLC layer 515-1, the second CLC layer 515-2, and the third CLC layer 515-3 may be the same or different. When the gradient pitches are different, at least one of the starting pitches, the ending pitches, or the pitch distribution functions f( ) may be different. In some embodiments, two layers of the CLC layers 515-1, 515-2, and 515-3 may be an embodiment of the gradient-pitch CLC layer 332 with a respective gradient pitch (or gradient pitch profile, configuration, or distribution), and the third layer of the CLC layers 515-1, 515-2, and 515-3 may be an embodiment of the CLC layer 302, the CLC layer 312, the CLC layer 322, or the CLC layer 342. When the third layer is another gradient-pitch layer (e.g., CLC layer 342), the gradient pitches (or gradient pitch profiles, configurations, or distributions) of the three CLC layers 515-1, 515-2, and 515-3 may be the same or may be different (e.g., at least two gradient pitches may be different).

In some embodiments, the CLC layer stack 500 may include at least two CLC layer 342 shown in FIG. 3E stacked together. For example, at least two (e.g., each) of the first CLC layer 515-1, the second CLC layer 515-2, and the third CLC layer 515-3 may be an embodiment of the gradient-pitch CLC layer 342 with a respective gradient pitch (or gradient pitch profile, configuration, or distribution). The gradient pitches (or gradient pitch profiles, configurations, or distributions) of at least two of the first CLC layer 515-1, the second CLC layer 515-2, and the third CLC layer 515-3 may be the same or different. When the gradient pitches are different, at least one of the starting pitches, the ending pitches, or the pitch distribution functions f( ) may be different. In some embodiments, two layers of the CLC layers 515-1, 515-2, and 515-3 may be an embodiment of the gradient-pitch CLC layer 342 with a respective gradient pitch (or gradient pitch profile, configuration, or distribution), and the third layer of the CLC layers 515-1, 515-2, and 515-3 may be an embodiment of the CLC layer 302, the CLC layer 312, the CLC layer 322, or the CLC layer 332. When the third layer is another gradient-pitch layer (e.g., CLC layer 332), the gradient pitches (or gradient pitch profiles, configurations, or distributions) of the three layers 515-1, 515-2, and 515-3 may be the same or may be different (e.g., at least two gradient pitches may be different).

In some embodiments, the CLC layer stack 500 may include a combination of CLC layers selected from FIGS. 3A-3E stacked together. For example, the CLC layer stack 500 may include two or more constant-pitch CLC layers selected from those shown in FIGS. 3A-3C stacked together. For example, the CLC layer stack 500 may include three CLC layers 302 stacked together. In some embodiments, the CLC layer stack 500 may include three CLC layers 312 stacked together. In some embodiments, the CLC layer stack 500 may include three CLC layers 322 stacked together. In some embodiments, the CLC layer stack 500 may include two CLC layers 302 and one CLC layer 312. In some embodiments, the CLC layer stack 500 may include two CLC layers 302 and one CLC layer 322. In some embodiments, the CLC layer stack 500 may include two CLC layers 312 and one CLC layer 302. In some embodiments, the CLC layer stack 500 may include two CLC layers 312 and one CLC layer 322. In some embodiments, the CLC layer stack 500 may include two CLC layers 322 and one CLC layer 302. In some embodiments, the CLC layer stack 500 may include two CLC layers 322 and one CLC layer 312. Each layer in the CLC layer stack 500 may include a respective constant pitch. The constant pitches of the three layers may all be the same, all be different from one another, or may have two same values and one different value.

In some embodiments, the CLC layer stack 500 may include two or more gradient-pitch CLC layers shown in FIG. 3D and FIG. 3E stacked together. In some embodiments, the CLC layer stack 500 may include three CLC layers 332. In some embodiments, the CLC layer stack 500 may include three CLC layers 342. In some embodiments, the CLC layer stack 500 may include two CLC layers 332 and one CLC layer 342. In some embodiments, the CLC layer stack 500 may include two CLC layers 342 and one CLC layer 332. Each gradient-pitch CLC layer may have a respective gradient pitch (or gradient pitch profile, configuration, or distribution). The gradient pitches (or gradient pitch profiles, configurations, or distributions) of the different CLC layers may all be the same or all be different. In some embodiments, at least two gradient pitches may be the same and at least one gradient pitch may be different from the at least two same gradient pitches. When the gradient pitches are different, at least one of the starting pitches, the ending pitches, or the pitch distribution functions f( ) may be different.

In some embodiments, the CLC layer stack 500 may include one or more constant-pitch CLC layers selected from FIGS. 3A-3C and one or more gradient-pitch CLC layers selected from FIG. 3D and FIG. 3E stacked together. For example, the CLC layer stack 500 may include one CLC layer 302, one CLC layer 312, and one CLC layer 322. In some embodiments, the CLC layer stack 500 may include one CLC layer 302, one CLC layer 312, and one CLC layer 332. In some embodiments, the CLC layer stack 500 may include one CLC layer 302, one CLC layer 312, and one CLC layer 342. In some embodiments, the CLC layer stack 500 may include one CLC layer 302, one CLC layer 322, and one CLC layer 332. In some embodiments, the CLC layer stack 500 may include one CLC layer 302, one CLC layer 332, and one CLC layer 342. In some embodiments, the CLC layer stack 500 may include one CLC layer 312, one CLC layer 322, and one CLC layer 332. In some embodiments, the CLC layer stack 500 may include one CLC layer 312, one CLC layer 322, and one CLC layer 342. In some embodiments, the CLC layer stack 500 may include one CLC layer 312, one CLC layer 332, and one CLC layer 342. In some embodiments, the CLC layer stack 500 may include one CLC layer 322, one CLC layer 332, and one CLC layer 342.

In some embodiments, the CLC layer stack 500 may include a combination of two CLC layers 302 and one CLC layer 312, a combination of two CLC layers 302 and one CLC layer 322, a combination of two CLC layers 302 and one CLC layer 332, or a combination of two CLC layers 302 and one CLC layer 342. In some embodiments, the CLC layer stack 500 may include a combination of two CLC layers 312 and one CLC layer 302, a combination of two CLC layers 312 and one CLC layer 322, a combination of two CLC layers 312 and one CLC layer 332, or a combination of two CLC layers 312 and one CLC layer 342. In some embodiments, the CLC layer stack 500 may include a combination of two CLC layers 322 and one CLC layer 302, a combination of two CLC layers 322 and one CLC layer 312, a combination of two CLC layers 322 and one CLC layer 332, or a combination of two CLC layers 322 and one CLC layer 342. In some embodiments, the CLC layer stack 500 may include a combination of two CLC layers 332 and one CLC layer 302, a combination of two CLC layers 332 and one CLC layer 312, a combination of two CLC layers 332 and one CLC layer 322, or a combination of two CLC layers 332 and one CLC layer 342. In some embodiments, the CLC layer stack 500 may include a combination of two CLC layers 342 and one CLC layer 302, a combination of two CLC layers 342 and one CLC layer 312, a combination of two CLC layers 342 and one CLC layer 322, or a combination of two CLC layers 342 and one CLC layer 332. The two same type of layers may have the same constant (or gradient) pitch or different constant (or gradient) pitches.

The alignment structure disclosed herein may be configured to provide a predetermined alignment to the LC molecules of the birefringent film (e.g., CLC layer) that are in direct contact with the alignment structure (e.g., the birefringent film may be directly formed on a surface of the alignment structure). The predetermined alignment may be a planar (homogeneous) alignment, a vertical (homeotropic) alignment, an alignment between the planar (homogeneous) alignment and the vertical (homeotropic) alignment, or a hybrid alignment including both the planar (homogeneous) alignment and the vertical (homeotropic) alignment, etc. The alignment structure may be configured to at least partially align LC molecules in the birefringent film in a predetermined pretilt angle. For example, the LC molecules in direct contact with the alignment structure may be aligned by the alignment structure, and the remaining LC molecules in the birefringent film may be aligned according to neighboring (e.g., underlying) LC molecules that have been aligned by the alignment structure. The alignment structure may include a polyimide layer, a PAM layer, a nanostructure, an alignment network, or a combination thereof.

The alignment structures may be configured to provide the same alignment or different alignments to the birefringent films formed thereon respectively. For example, at least two alignment structures may provide different alignments to two birefringent films formed thereon respectively. The alignment structures may include the same alignment material or different alignment materials. For example, at least two alignment structures may include different alignment materials. The thickness of the alignment structure may be in the order of μm, e.g., 1-10 μm. The alignment structures may have the same thickness or different thicknesses. For example, at least two alignment structures may have different thicknesses.

In some embodiments, the barrier film may be configured to provide a barrier between the birefringent film and another film (e.g., an alignment structure or another birefringent film) formed in the subsequent process. For example, the barrier film may be configured to reduce or suppress diffusion, interactions, and/or interference between a birefringent film located under and formed before the barrier film in a preceding process and another film located on and formed after the barrier film in a subsequent process, such as another alignment structure and/or another birefringent film. The barrier film may reduce or suppress the contraction (or shrink) and/or swelling (or expansion) of a birefringent film and another film (which may be an alignment structure or another birefringent film) that are separated by the barrier film. In some embodiments, the barrier film may also be configured to provide other functions, such as barrier functions against permeation of undesirable substance into the birefringent film, e.g., moisture, oxygen, and/or grease. In some embodiments, the barrier film may include a water-borne barrier coating, a solvent-borne barrier coating, a solventless barrier coating, a sol-gel coating, or any combination thereof. The barrier films in the stack may include the same type of barrier coatings, which may include the same material or different materials. For example, at least two barrier films may include different types of barrier coatings. The thickness of the barrier film may be 1-10 micrometers or even sub-micrometer (e.g., less than 1 micrometer). The barrier films in the stack may have the same thickness or different thicknesses. For example, at least two barrier films may have different thicknesses.

In some embodiments, the substrate 505 may include, as an integral part, an alignment structure configured to align LC molecules included in the CLC layer 515-1 in predetermined pretilt angles. That is, the alignment structure 510-1 may be integrally formed with the substrate 505. In some embodiments, the alignment structure 510-1 and/or the substrate 505 may be detachable or removable from the rest of the CLC layer stack 500 after the rest of the CLC layer stack 500 is fabricated or transported to another place or device. That is, the alignment structure 510-1 and/or the substrate 505 may be used in fabrication, transportation, and/or storage to support the films provided on the substrate 505, and may be separated or removed from the CLC layer 515-1 when the fabrication of the CLC layer stack 500 is completed, or when the CLC layer stack 500 is to be implemented in an optical device. Thus, the final product of the CLC layer stack 500 may not include the alignment structure 510-1 and/or the substrate 505. In some embodiments, for separating the substrate 505 and/or the alignment structure 510-1, the alignment structure 510-1 may be made of a water-soluble material, e.g., a water-soluble photo-alignment material. After the rest of the CLC layer stack 500 is fabricated, the alignment structure 510-1 may be dissolved, thereby separating the substrate 505 from the rest of the CLC layer stack 500.

FIG. 5B illustrates a schematic perspective view of a CLC layer stack 501 in accordance with an embodiment of the present disclosure. The CLC layer stack 501 may be fabricated using any suitable processes, for example, the method or processes disclosed herein. In some embodiments, the CLC layer stack 501 may be fabricated using the processes described above in connection with FIGS. 2A-2F. The CLC layer stack 501 may be similar to the CLC layer stack 500, except that the CLC layer stack 501 may include two CLC layers 515-1 and 515-2. As shown in FIG. 5B, the CLC layer stack 501 may include the first alignment structure 510-1 formed on the substrate 505, the first CLC layer 515-1 formed on the first alignment structure 510-1, the first barrier film 520-1 formed on the first CLC layer 515-1, the second alignment structure 510-2 formed on the first barrier film 520-1, the second CLC layer 515-2 formed on the second alignment structure 510-2, and the second barrier film 520-2 formed on the second CLC layer 515-2. In some embodiments, the CLC layer stack 501 may not include the second barrier film 520-2. Descriptions of the same or similar elements can refer to the above descriptions rendered in connection with FIG. 5A.

FIG. 5C illustrates a schematic perspective view of a CLC layer stack 502 in accordance with an embodiment of the present disclosure. The CLC layer stack 502 may be fabricated using any suitable processes, for example, the method or processes disclosed herein. In some embodiments, the CLC layer stack 502 may be fabricated using the processes described above in connection with FIGS. 2A-2F. The CLC layer stack 502 may be similar to the CLC layer stack 500, except that the CLC layer stack 502 may further include a fourth alignment structure 510-4 formed on the third barrier film 520-3, a fourth CLC layer 515-4 formed on the fourth alignment structure 510-4, and a fourth barrier film 520-4 formed on the fourth CLC layer 515-4. In some embodiments, the fourth barrier film 520-4 may be omitted. The first, second, third, and fourth CLC layers 515-1, 515-2, 515-3, and 515-4 may be any one or any combination of CLC layers 302, 312, 322, 332, and 342 shown in FIGS. 3A-3E. The fourth alignment structure 510-4 may have a structure and/or property similar to or different from that of the first, second, and third alignment structures 510-1, 510-2, and 510-3. The fourth barrier film 520-4 may have a structure and/or property similar to or different from that of the first, second, and third barrier film 520-1, 520-2, and 520-3.

In some embodiments, each of the first, second, third, and fourth CLC layers 515-1, 515-2, 515-3, and 515-4 may have a reflection band in the wavelength ranges of blue, green, orange, and red lights. The correspondence between the reflection bands of the first, second, third, and fourth CLC layers 515-1, 515-2, 515-3, and 515-4 and the blue, green, orange, and red lights may have any suitable correspondence. For example, the reflection bands of the CLC layers 515-1, 515-2, 515-3, and 515-4 may correspond to the blue, green, orange, and red lights, respectively. In some embodiments, the reflection bands of the CLC layers 515-1, 515-2, 515-3, and 515-4 may correspond to the blue, green, orange, and red lights, respectively. In some embodiments, the reflection bands of the CLC layers 515-1, 515-2, 515-3, and 515-4 may correspond to the blue, green, red, and orange lights, respectively. In some embodiments, the reflection bands of the CLC layers 515-1, 515-2, 515-3, and 515-4 may correspond to the blue, orange, green, and red lights, respectively. In some embodiments, the reflection bands of the CLC layers 515-1, 515-2, 515-3, and 515-4 may correspond to the blue, orange, red, and green lights, respectively. In some embodiments, the reflection bands of the CLC layers 515-1, 515-2, 515-3, and 515-4 may correspond to the blue, red, orange, and green lights, respectively. In some embodiments, the reflection bands of the CLC layers 515-1, 515-2, 515-3, and 515-4 may correspond to the blue, red, green, and orange lights, respectively. In some embodiments, the reflection bands of the CLC layers 515-1, 515-2, 515-3, and 515-4 may correspond to the green, blue, red, and orange lights, respectively.

In some embodiments, the reflection bands of the CLC layers 515-1, 515-2, 515-3, and 515-4 may correspond to the green, blue, orange, and red lights, respectively. In some embodiments, the reflection bands of the CLC layers 515-1, 515-2, 515-3, and 515-4 may correspond to the green, orange, blue, and red lights, respectively. In some embodiments, the reflection bands of the CLC layers 515-1, 515-2, 515-3, and 515-4 may correspond to the green, orange, red, and blue lights, respectively. In some embodiments, the reflection bands of the CLC layers 515-1, 515-2, 515-3, and 515-4 may correspond to the green, red, orange, and blue lights, respectively. In some embodiments, the reflection bands of the CLC layers 515-1, 515-2, 515-3, and 515-4 may correspond to the green, red, blue, and orange lights, respectively.

In some embodiments, the reflection bands of the CLC layers 515-1, 515-2, 515-3, and 515-4 may correspond to the orange, red, blue, and green lights, respectively. In some embodiments, the reflection bands of the CLC layers 515-1, 515-2, 515-3, and 515-4 may correspond to the orange, red, green, and blue lights, respectively. In some embodiments, the reflection bands of the CLC layers 515-1, 515-2, 515-3, and 515-4 may correspond to the orange, green, blue, and red lights, respectively. In some embodiments, the reflection bands of the CLC layers 515-1, 515-2, 515-3, and 515-4 may correspond to the orange, green, red, and blue lights, respectively. In some embodiments, the reflection bands of the CLC layers 515-1, 515-2, 515-3, and 515-4 may correspond to the orange, blue, green, and red lights, respectively. In some embodiments, the reflection bands of the CLC layers 515-1, 515-2, 515-3, and 515-4 may correspond to the orange, blue, red, and green lights, respectively.

In some embodiments, the reflection bands of the CLC layers 515-1, 515-2, 515-3, and 515-4 may correspond to the red, blue, green, and orange lights, respectively. In some embodiments, the reflection bands of the CLC layers 515-1, 515-2, 515-3, and 515-4 may correspond to the red, blue, orange, and green lights, respectively. In some embodiments, the reflection bands of the CLC layers 515-1, 515-2, 515-3, and 515-4 may correspond to the red, orange, green, and blue lights, respectively. In some embodiments, the reflection bands of the CLC layers 515-1, 515-2, 515-3, and 515-4 may correspond to the red, orange, blue, and green lights, respectively. In some embodiments, the reflection bands of the CLC layers 515-1, 515-2, 515-3, and 515-4 may correspond to the red, green, orange, and blue lights, respectively. In some embodiments, the reflection bands of the CLC layers 515-1, 515-2, 515-3, and 515-4 may correspond to the red, green, blue, and orange lights, respectively.

FIG. 5D illustrates a schematic perspective view of a CLC layer stack 550 in accordance with an embodiment of the present disclosure. The CLC layer stack 550 may be fabricated using any suitable processes, for example, the processes or method disclosed herein. In some embodiments, the CLC layer stack 550 may be fabricated based on the processes or method described above in connection with FIGS. 4A-4D. The CLC layer stack 550 may include elements similar to those included in the CLC layer stack 500 shown in FIG. 5A. Descriptions of the similar elements can refer to the above descriptions rendered in connection with FIG. 5A. As shown in FIG. 5D, the CLC layer stack 550 may include a plurality of CLC layers and a plurality of barrier films alternatingly disposed on a surface of the substrate 505.

Different from the embodiment shown in FIG. 5A, the CLC layer stack 550 shown in FIG. 5D may not include separate alignment structures formed below a corresponding CLC layer. The alignment of the LC molecules in the CLC layers may be achieved through an external field, such as a light field. The material for forming the CLC layer may include a cholesteric mixture that may include one or more polarization sensitive materials. The polarization sensitive materials may initially be substantially isotropic (i.e., substantially isotropic before the exposure process), and may exhibit an induced (e.g., photo-induced) optical anisotropy after being exposed to the polarized light irradiation. That is, the molecules of polarization sensitive materials may initially be substantially isotropic (i.e., before the exposure process), and become optically anisotropic after the exposure to the polarized light irradiation. In some embodiments, the molecules of the polarization sensitive materials may include one or more polarization sensitive groups, such as an azobenzene group, a cinnamate group, a coumarin group, or any combination thereof, etc. The cholesteric mixture may be dispensed (e.g., spin coated) onto a surface of the substrate 505 or another layer. The cholesteric mixture may be exposed to a polarized light irradiation to provide the alignment for the LC molecules. In some embodiments, the cholesteric mixture may become polymerized after exposed to sufficient polarized light irradiation.

For illustrative purposes, FIG. 5D shows that the CLC layer stack 550 may include three CLC layers 555-1, 555-2, and 555-3, and three barrier films 560-1, 560-2, and 560-3 alternatingly disposed on a surface of the substrate 505. The CLC layer stack 550 may include additional CLC layers and barrier films. The number of CLC layers is not limited to three, and can be any suitable number, such as two, four, five, seven, eight, nine, ten, etc. The number of barrier films is not limited to three, and can be any suitable number, such as two, four, five, six, seven, eight, nine, ten, etc. For example, in some embodiments, the barrier film 560-3 may be omitted. Descriptions of the similar structures and the fabrication processes can refer to the above descriptions in connection with FIGS. 4A-4D, FIGS. 5A-5C.

In some embodiments, the CLC layer stack 550 may function as a reflective polarizer. The reflection bands of the three CLC layers 555-1, 555-2, and 555-3 may correspond to the red, green, and blue lights. The correspondence between the reflection bands of the three CLC layers 555-1, 555-2, and 555-3 and the red, green, and blue lights can refer to the above descriptions of the correspondence between the reflection bands of the three CLC layers 515-1, 515-2, and 515-3 and the red, green, and blue lights.

FIG. 5E illustrates a CLC layer stack 551 in accordance with an embodiment of the present disclosure. The CLC layer stack 551 may be fabricated using any suitable processes, such as the processes or method disclosed herein. In some embodiments, the CLC layer stack 551 may be fabricated based on the processes or method described above in connection with FIGS. 4A-4D. The CLC layer stack 551 may be similar to the CLC layer stack 550, except that the CLC layer stack 551 may include two CLC layers 555-1 and 555-2, and two barrier films 560-1 and 560-2 alternatingly formed one over another on a surface of the substrate 505. In some embodiments, the barrier film 560-2 may be omitted. Descriptions of the similar structures and the fabrication processes can refer to the above descriptions provided in connection with FIGS. 4A-4D and FIGS. 5A-5D.

FIG. 5F illustrates a CLC layer stack 552 in accordance with an embodiment of the present disclosure. The CLC layer stack 552 may be fabricated using any suitable processes, such as the processes or method disclosed herein. In some embodiments, the CLC layer stack 552 may be fabricated using the processes or method described above in connection with FIGS. 4A-4D. The CLC layer stack 552 may be similar to the CLC layer stack 550, except that the CLC layer stack 552 may include an additional fourth CLC layer 555-4 formed on the third barrier film 560-3, and an additional fourth barrier film 560-4 formed on the fourth CLC layer 555-4. In some embodiments, the reflection bands of the first, second, third, and fourth CLC layers 555-1, 555-2, 555-3, and 555-4 may correspond to the red, green, blue, and orange lights. The correspondence may be any suitable correspondences similar to those described above in connection with the first, second, third, and fourth CLC layers 515-1, 515-2, 515-3, and 515-4 and the red, green, blue, and orange lights.

In the CLC layer stacks 550, 551, and 552, at least one (e.g., each) CLC layer may include a birefringent material having a chirality. The birefringent material may have an induced birefringence and an alignment provided through a polarized light irradiation. Each CLC layer may be configured to have various helical twist structures, such as that of the CLC layer 302 shown in FIG. 3A, that of the CLC layer 312 shown in FIG. 3B, that of the CLC layer 322 shown in FIG. 3C, that of the CLC layer 332 shown in FIG. 3D, or that of the CLC layer 342 shown in FIG. 3E. In some embodiments, each of the CLC layers may be a single-pitch CLC layer. In some embodiments, each of the CLC layers may be a gradient-pitch CLC layer. In some embodiments, the CLC layers may include at least one single-pitch CLC layer and at least one gradient-pitch CLC layer. Various combinations of the CLC layers 302, 312, 322, 332, and 342 described above may be applied to the CLC layer stacks 550, 551, and 552. The overall reflection band of the CLC layer stack 550, 551, and 552 may be configured through configuring the helical twist structures of the respective CLC layers.

A barrier film included in the CLC layer stack 550, 551, and 552 may be similar to the barrier film shown in FIGS. 5A-5C. In some embodiments, the barrier film may be configured to provide a barrier between two adjacent layers or films. For example, a barrier film may be configured to reduce or suppress interactions between two adjacent CLC layers, thereby reducing or suppressing the contraction (or shrink) and/or swelling (or expansion) of the CLC layers. In some embodiments, the barrier film may also be configured to provide other barrier functions against permeation of undesirable substance into the birefringent film, e.g., moisture, oxygen, and/or grease. In some embodiments, the barrier film may include a water-borne barrier coating, a solvent-borne or solvent based barrier coating, a solventless barrier coating, a sol-gel barrier coating, or any combination thereof. The barrier films may include the same material or different materials. For example, at least two barrier films may include different materials. The thickness of the barrier film may be 1-10 micrometers or even sub-micrometer (e.g., less than 1 micrometer). The barrier films may have the same thickness or different thicknesses. For example, at least two barrier films may have different thicknesses.

The CLC layer stack 500, 501, 502, 550, 551, or 552 may function as various optical elements for various applications in a number of fields, which are all within the scope of the present disclosure. In some embodiments, the CLC layer stack 500, 501, 502, 550, 551, or 552 may function as a reflective polarizer configured to selectively reflect or transmit a circularly or an elliptically polarized incident light, depending on a handedness of the circularly or elliptically polarized incident light and a handedness of the helical twist structure of the CLC layer stack 500, 501, 502, 550, 551, or 552. For example, when each of the CLC layers included in the CLC layer stack 500, 501, 502, 550, 551, or 552 has a left-handed (or right-handed) helical twist structure, the handedness of the helical twist structure of the CLC layer stack 500, 501, 502, 550, 551, or 552 may be left-handed (or right-handed). Accordingly, the CLC layer stack 500, 501, 502, 550, 551, or 552 may function as a left-handed (or a right-handed) CLC reflective polarizer. A left-handed CLC reflective polarizer may be configured to primarily reflect a left-handed circularly or elliptically polarized incident light, and primarily transmit a right-handed circularly or elliptically polarized incident light. A right-handed CLC reflective polarizer may be configured to primarily reflect a right-handed circularly or elliptically polarized incident light, and primarily transmit a left-handed circularly or elliptically polarized incident light.

The reflection band of the CLC reflective polarizer may be configured through configuring the CLC layers, such as choosing desirable birefringent materials included in respective CLC layers, configuring the helical twist structures (e.g., pitches) of respective CLC layers, etc. In some embodiments, the CLC layer stack 500, 501, 502, 550, 551, or 552 may function as a narrowband reflective polarizer, which may be desirable in narrowband applications. In some embodiments, the CLC layer stack 500, 501, 502, 550, 551, or 552 may function as a broadband reflective polarizer, with a reflection band covering at least one of the UV spectrum, visible spectrum, or the IR spectrum.

In some embodiments, the CLC layer stack 500, 501, 502, 550, 551, or 552 may function as a reflective polarizer configured to separate (or split) two circularly polarized components (e.g., a left-handed circularly polarized component and a right handed circularly polarized component) of an unpolarized incident light or a linearly polarized incident light. One circularly polarized component may be primarily reflected by the reflective polarizer and another circularly polarized component with an opposite handedness may be primarily transmitted by the reflective polarizer. For example, a left-handed CLC reflective polarizer may be configured to primarily reflect a left-handed circularly polarized component of an unpolarized incident light, and primarily transmit a right-handed circularly polarized component of the unpolarized incident light. A right-handed CLC reflective polarizer may be configured to primarily reflect a right-handed circularly polarized component of an unpolarized incident light, and primarily transmit a left-handed circularly polarized component of the unpolarized incident light.

In some embodiments, the CLC layer stack 500, 501, 502, 550, 551, or 552 may function as an optical diffuser. In some embodiments, the optical diffuser may be configured to provide a directional scattering, rather than a random scattering, to an incident light. For example, the optical diffuser may be configured to primarily backwardly scatter a circularly polarized incident light having the same handedness as that of the helical twist structure of the CLC layer stack 500, 501, 502, 550, 551, or 552. The optical diffuser may be configured to primarily forwardly scatter a circularly polarized incident light having a handedness opposite to that of the helical twist structure of the CLC layer stack 500, 501, 502, 550, 551, or 552. The optical diffuser may be configured to improve uniformity of lights illuminating an object, or improve visibility of an image created by an optical system including the CLC layer stack 500, 501, 502, 550, 551, or 552 from a wider range of angles.

In some embodiments, the CLC layer stack 500, 501, 502, 550, 551, or 552 may function as a grating stack including a plurality of diffraction gratings configured with different angular selectivity and/or wavelength selectivity. In some embodiments, the grating stack may be used for spatial- and/or time-multiplexing different portions of a field of view (“FOV”) of a single-color image or a multi-color image. In some embodiments, the grating stack may be used for spatial- and/or time-multiplexing different colors of a multi-color image.

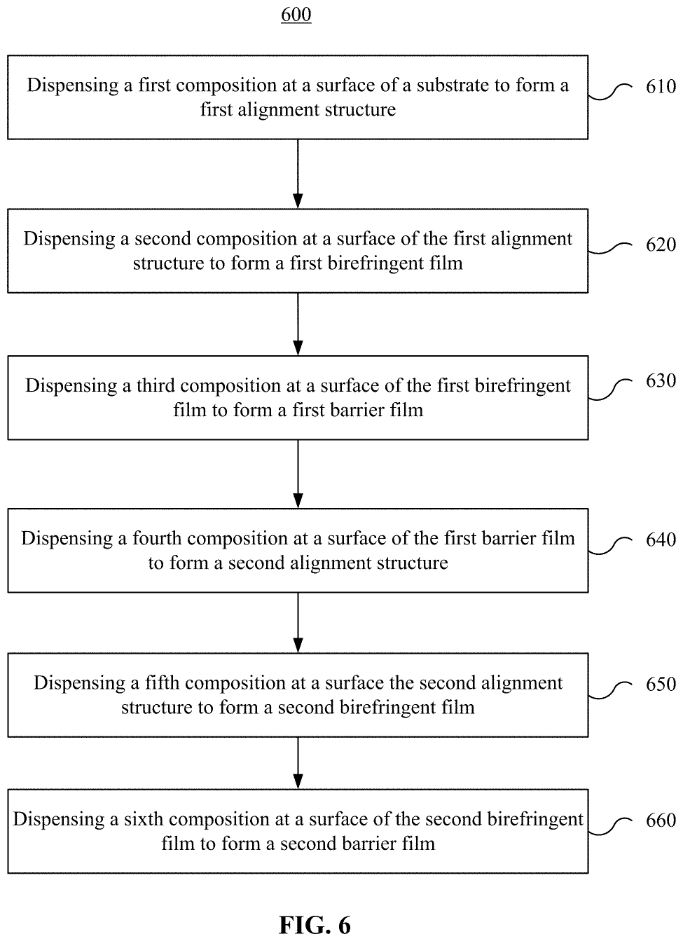

FIG. 6 illustrates a flow chart showing a method 600 for fabricating a birefringent film stack (e.g., a CLC layer stack), according to an embodiment of the present disclosure. As shown in FIG. 6, the method 600 may include forming a plurality of films, layers, or structures on a substrate. The method 600 may include forming one or more barrier films alternatingly with two or more birefringent films (or two or more pairs of a birefringent film and an alignment structure). Various processes may be used for forming the different films, layers, or structures. For example, the various films, layers, or structures may be formed through dispensing (e.g., coating, depositing, etc.) a corresponding composition or mixture, and processing (e.g., curing, drying, rubbing, and/or subjecting to a light irradiation, etc.) the composition to change a state or a property of the composition or mixture (e.g., liquid to solid, polymerization, isotropy to anisotropy, alignment, etc.). Detailed descriptions of the materials for the composition or mixture and the processes of forming the various films, layers, or structures may refer to the descriptions rendered above, e.g., including those rendered in connection with FIGS. 2A-2F.

As shown in FIG. 6, the method 600 may include dispensing (e.g., coating, depositing, etc.) a first composition at (e.g., on) a surface of a substrate to form a first alignment structure (Step 610). In some embodiments, forming the first alignment structure in Step 610 may also include processing (e.g., curing, drying, rubbing, and/or subjecting to a light irradiation, etc.) the first composition dispensed on the surface of the substrate to form the first alignment structure. The first composition may be any of the disclosed materials or compositions for forming an alignment structure. The method 600 may also include dispensing (e.g., coating, depositing, etc.) a second composition at (e.g., on) a surface of the first alignment structure to form a first birefringent film (Step 620). In some embodiments, forming the first birefringent film in Step 620 may also include processing (e.g., curing, drying, and/or subjecting to a light irradiation, etc.) the second composition dispensed on the surface of the first alignment structure to form the first birefringent film. The second composition may be any of the disclosed materials or compositions for forming a birefringent film.

The method 600 may also include dispensing (e.g., coating, depositing, etc.) a third composition at (e.g., on) a surface of the first birefringent film to form a first barrier film (Step 630). In some embodiments, forming the first barrier film in Step 630 may also include processing (e.g., curing, drying, and/or subjecting to a light irradiation, etc.) the third composition dispensed on the surface of the first birefringent film to form the first barrier film. In some embodiments, the first barrier film may be deposited (e.g., through physical vapor deposition, chemical vapor deposition, etc.) onto the first birefringent film without further processing. The third composition may be any of the disclosed materials or compositions for forming a barrier film. The method 600 may also include dispensing (e.g., coating, depositing, etc.) a fourth composition at (e.g., on) a surface of the first barrier film to form a second alignment structure (Step 640). In some embodiments, forming the second alignment structure in Step 640 may also include processing (e.g., curing, drying, rubbing, and/or subjecting to a light irradiation, etc.) the fourth composition dispensed on the surface of the first barrier film to form the second alignment structure. The fourth composition may be the same as or different from the first composition for forming the first alignment structure.

The method 600 may also include dispensing (e.g., coating, depositing, etc.) a fifth composition at (e.g., on) a surface of the second alignment structure to form a second birefringent film (Step 650). In some embodiments, forming the second birefringent film in Step 650 may also include processing (e.g., curing, drying, and/or subjecting to a light irradiation, etc.) the fifth composition dispensed on the surface of the second alignment structure to form the second birefringent film. The fifth composition may be the same as or different from the second composition for forming the first birefringent film.

The method 600 may also include dispensing (e.g., coating, depositing, etc.) a sixth composition at (e.g., on) a surface of the second birefringent film to form a second barrier film (Step 660). In some embodiments, forming the second barrier film in Step 660 may also include processing (e.g., curing, drying, and/or subjecting to a light irradiation, etc.) the sixth composition dispensed on the surface of the second birefringent film to form the second barrier film. In some embodiments, the second barrier film may be deposited (e.g., through physical vapor deposition, chemical vapor deposition, etc.) onto the second birefringent film without further processing. The sixth composition may be the same as or different from the third composition for forming the first barrier film.

In some embodiments, the method 600 may omit one or more steps shown in FIG. 6. For example, in some embodiments, the method 600 may not include Step 660. In some embodiments, the method 600 may include additional steps. For example, in some embodiments, the method 600 may also include dispensing (e.g., coating, depositing, etc.) a seventh composition at (e.g., on) a surface of the second barrier film to form a third alignment structure. The seventh composition may be the same as or different from the first composition for forming the first alignment structure, or the fourth composition for forming the second alignment structure. Forming the third alignment structure may also include processing the seventh composition in a manner similar to that in which the first composition is processed in forming the first alignment structure.

In some embodiments, the method 600 may also include dispensing (e.g., coating, depositing, etc.) an eighth composition at (e.g., on) a surface of the third alignment structure to form a third birefringent film. The eighth composition may be the same as or different from the second composition for forming the first birefringent film or the fifth composition for forming the second birefringent film. Forming the third birefringent film may also include processing the eighth composition in a manner similar to that in which the second composition is processed in forming the first birefringent film. In some embodiments, the method 600 may also include dispensing (e.g., coating, depositing, etc.) a ninth composition at (e.g., on) a surface of the third birefringent film to form a fourth barrier film. The ninth composition may be the same as or different from the third composition for forming the first barrier film or the sixth composition for forming the second barrier film. Forming the fourth barrier film may also include processing the ninth composition in a manner similar to that in which the third composition is processed to form the first barrier film.

In some embodiments, prior to Step 610, the method 600 may include dispensing (e.g., coating, depositing, etc.) a composition on the surface of the substrate to form a barrier film, and the first alignment structure may be formed on the barrier film. In some embodiments, prior to Step 610, the method 600 may include dispensing (e.g., coating, depositing, etc.) a soluble material on the surface of the substrate to form a soluble layer, and the first alignment structure may be formed on the soluble layer. The soluble layer may be water-soluble. When the birefringent film stack is fabricated, the soluble layer formed between the substrate and the first alignment structure may be dissolved to separate or remove the substrate from the rest of the birefringent film stack. In some embodiments, the soluble layer may be integrally formed with the first alignment structure as a single layer. When the birefringent film stack is fabricated, the soluble layer may be dissolved to separate the substrate and the first alignment structure from the rest of the birefringent film stack. In some embodiments, the soluble layer may be integrally formed with the barrier film formed prior to Step 610 as a single layer, or the soluble layer may be formed on the top surface of the substrate, the barrier film may be formed on the soluble layer, and the first alignment structure may be formed on the barrier film. When the birefringent film stack is fabricated, the soluble layer may be dissolved to separate the substrate and the barrier film formed prior to Step 610 from the rest of the birefringent film stack.

According to an embodiment, the present disclosure provides a product manufactured or fabricated by the method disclosed herein. For example, in one embodiment, the present disclosure provides a birefringent film stack (e.g., a CLC layer stack) fabricated using the method 600. The birefringent film stack may include a substrate, and a first alignment structure formed on a surface (e.g., a top surface) of the substrate by dispensing a first composition at the surface of the substrate. The first composition may be processed (e.g., cured, dried, rubbed, and/or subjected to a light irradiation, etc.) to form the first alignment structure. The birefringent film stack may include a first birefringent film formed on the first alignment structure by dispensing a second composition at a surface (e.g., a top surface) of the first alignment structure. The second composition may be processed (e.g., cured, dried, and/or subjected to a light irradiation, etc.) to form the first birefringent film. The birefringent film stack may include a first barrier film formed on the first birefringent film by dispensing a third composition at a surface (e.g., a top surface) of the first birefringent film. The third composition may be processed (e.g., cured, dried, and/or subjected to a light irradiation, etc.) to form the first barrier film.

In some embodiments, the first barrier film may be deposited (e.g., through physical vapor deposition, chemical vapor deposition, etc.) onto the first birefringent film without further processing. The birefringent film stack may include a second alignment structure formed on the first barrier film by dispensing a fourth composition at a surface (e.g., a top surface) of the first barrier film. The fourth composition may be processed (e.g., cured, dried, rubbed, and/or subjected to a light irradiation, etc.) to form the second alignment structure. The birefringent film stack may include a second birefringent film formed on the second alignment structure by dispensing a fifth composition at a surface (e.g., a top surface) of the second alignment structure. The fifth composition may be processed (e.g., cured, dried, and/or subjected to a light irradiation, etc.) to form the second birefringent film. The birefringent film stack may include a second barrier film formed on the second birefringent film by dispensing a sixth composition at a surface (e.g., a top surface) the second birefringent film. The sixth composition may be processed (e.g., cured, dried, and/or subjected to a light irradiation, etc.) to form the second barrier film. In some embodiments, the second barrier film may be deposited (e.g., through physical vapor deposition, chemical vapor deposition, etc.) onto the second birefringent film without further processing. The birefringent film stack fabricated using the disclosed fabrication method 600 may include additional alignment structures, birefringent films, and barrier films formed based on the disclosed processes. The birefringent film stacks 500, 501, and 502 may be examples of the products fabricated using the fabrication method 600 and variations of the method 600, which include additional steps to fabricate additional layers, films, or structures.

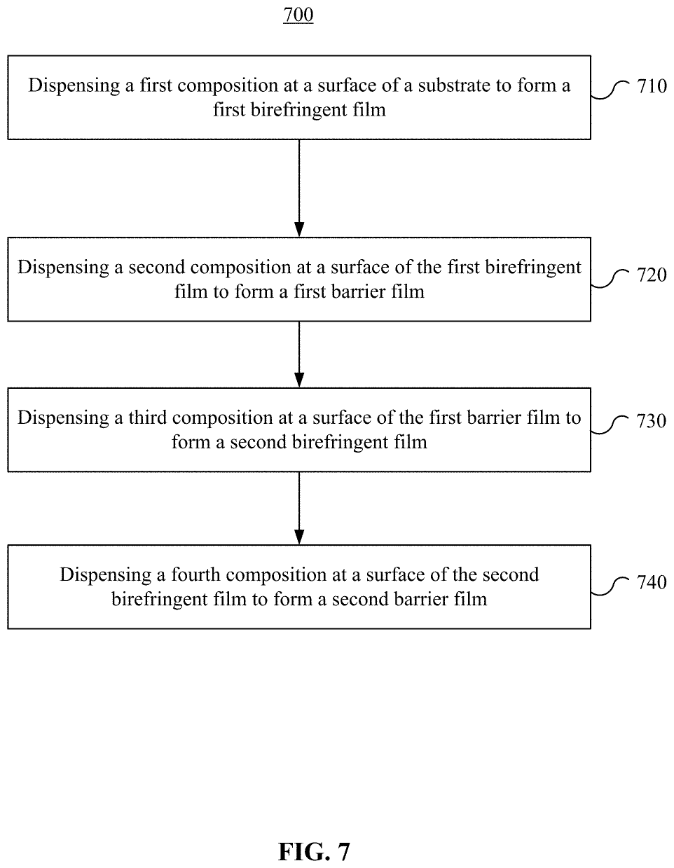

FIG. 7 illustrates a flow chart showing a method 700 for fabricating a birefringent film stack, according to an embodiment of the present disclosure. As shown in FIG. 7, the method 700 may include forming a plurality of films, layers, or structures on a substrate. For example, the method 700 may include forming one or more barrier films alternatingly with two or more birefringent films on the substrate. Various processes may be used for forming the different films, layers, or structures. For example, the various films, layers, or structures may be formed through dispensing (e.g., coating, depositing, etc.) a corresponding composition or mixture, and processing (e.g., curing, drying, rubbing, and/or subjecting to a light irradiation, etc.) the composition to change a state or a property of the composition or mixture (e.g., liquid to solid, polymerization, isotropy to anisotropy, alignment, etc.). Detailed descriptions of the materials for the composition or mixture and the processes of forming the various films, layers, or structures may refer to the descriptions rendered above (e.g., including those relating to FIGS. 4A-4D).

As shown in FIG. 7, the method 700 may include dispensing (e.g., coating, depositing, etc.) a first composition at (e.g., on) a surface of a substrate to form a first birefringent film (Step 710). For example, the first composition may include a cholesteric mixture or composition. Step 710 may include dispensing (e.g., spin coated) a thin layer of the cholesteric mixture or composition on a surface (e.g., a top surface) of the substrate. The thin layer of the cholesteric mixture or composition may be processed, e.g., exposed to a polarized light irradiation. The cholesteric mixture may include one or more polarization sensitive materials, which may initially be substantially isotropic (i.e., substantially isotropic before the exposure process), and may exhibit an induced (e.g., photo-induced) optical anisotropy after being exposed to the polarized light irradiation. That is, the molecules of polarization sensitive materials may initially be substantially isotropic (i.e., before the exposure process), and may become optically anisotropic when exposed to the polarized light irradiation. In some embodiments, the molecules of the polarization sensitive materials may include one or more polarization sensitive groups, such as an azobenzene group, a cinnamate group, a coumarin group, or any combination thereof, etc. After the cholesteric mixture is exposed to the polarized light irradiation, the birefringent film having a predetermined alignment (e.g., parallel or perpendicular to the polarization direction of the polarized light irradiation) and an photo-induced birefringence may be formed. In some embodiments, exposing the cholesteric mixture to the polarized light irradiation may also polymerize the cholesteric mixture.

The method 700 may also include dispensing (e.g., coating, depositing, etc.) a second composition at (e.g., on) a surface of the first birefringent film to form a first barrier film (Step 720). In some embodiments, forming the first barrier film in Step 720 may also include processing (e.g., curing, drying, and/or subjecting to a light irradiation, etc.) the first composition dispensed on the surface of the substrate to form the first barrier film. In some embodiments, the first barrier film may be deposited (e.g., through physical vapor deposition, chemical vapor deposition, etc.) onto the first birefringent film without further processing. The method 700 may also include dispensing (e.g., coating, depositing, etc.) a third composition at (e.g., on) a surface of the first barrier film to form a second birefringent film (Step 730). In some embodiments, the third composition may be processed (e.g., cured, dried, subjected to a light irradiation, and/or polymerized, etc.) to form the second birefringent film. The third composition may be the same as or different from the first composition. In some embodiments, the third composition may be substantially similar to the first composition, and the processes of forming the second birefringent film may be substantially similar to the processes of forming the first birefringent film in Step 710.

In some embodiments, the method 700 may also include dispensing (e.g., coating, depositing, etc.) a fourth composition at (e.g., on) a surface of the second birefringent film to form a second barrier film (Step 740). The fourth composition may be the same as or different from the second composition. In some embodiments, the fourth composition may be substantially the same as the second composition used in Step 720, and the processes of forming the second barrier film may be substantially the same as the processes of forming the first barrier film. In some embodiments, the fourth composition may be processed (e.g., cured, dried, subjected to a light irradiation, and/or polymerized, etc.) to form the second barrier film. In some embodiments, the second barrier film may be deposited (e.g., through physical vapor deposition, chemical vapor deposition, etc.) onto the second birefringent film without further processing.

In some embodiments, the method 700 may include additional steps for fabricating additional layers or films for the birefringent film stack. For example, in some embodiments, the method 700 may also include dispensing (e.g., coating, depositing, etc.) a fifth composition at (e.g., on) a surface of the second barrier film and processing the fifth composition to form a third birefringent film. The fifth composition may be the same as or different from the first composition for forming the first birefringent film or the third composition for forming the third birefringent film. In some embodiments, the fifth composition may be substantially the same as the first composition or the third composition, and the processes for forming the fifth birefringent film may be similar to the processes for forming the first birefringent film or the third birefringent film.

In some embodiments, the method 700 may also include dispensing (e.g., coating, depositing, etc.) a sixth composition at (e.g., on) a surface of the third birefringent film to form a third barrier film. In some embodiments, the sixth composition may be processed (e.g., cured, dried, subjected to a light irradiation, and/or polymerized, etc.) to form the third barrier film. In some embodiments, the third barrier film may be deposited (e.g., through physical vapor deposition, chemical vapor deposition, etc.) onto the third birefringent film without further processing. The sixth composition may be the same as or different from the second composition for forming the first barrier film, or the fourth composition for forming the second barrier film. In some embodiments, the sixth composition may be substantially the same as the second composition or the fourth composition, and the processes for forming the third barrier film may be substantially the same as the processes for forming the first barrier film or the second barrier film.

In some embodiments, the method 700 may include dispensing (e.g., coating, depositing, etc.) a seventh composition at (e.g., on) a surface of the third barrier film and processing the seventh composition to form a fourth birefringent film. The seventh composition may be the same as or different from the first composition for forming the first birefringent film, or the third composition for forming the second birefringent film, or the fifth composition for forming the third birefringent film. In some embodiments, the seventh composition may be substantially the same as the first composition, the third composition, or the fifth composition, and the processes for forming the fourth birefringent film may be substantially the same as the processes for forming the first birefringent film, the second birefringent film, or the third birefringent film.

In some embodiments, the method 700 may include dispensing (e.g., coating, depositing, etc.) an eighth composition at (e.g., on) a surface of the fourth birefringent film and processing the eighth composition to form a fourth barrier film. In some embodiments, the sixth composition may be processed (e.g., cured, dried, subjected to a light irradiation, and/or polymerized, etc.) to form the third barrier film. In some embodiments, the fourth barrier film may be deposited (e.g., through physical vapor deposition, chemical vapor deposition, etc.) onto the third birefringent film without further processing. The eighth composition may be the same as or different from the second composition for forming the first barrier film, or the fourth composition for forming the second barrier film, or the sixth composition for forming the third barrier film. In some embodiments, the eighth composition may be substantially the same as the second composition, the fourth composition, or the sixth composition, and the processes for forming the fourth barrier film may be substantially the same as the processes for forming the first barrier film, the second barrier film, or the third barrier film.

According to an embodiment, the present disclosure provides a product manufactured or fabricated by the method disclosed herein. For example, in one embodiment, the present disclosure provides a birefringent film stack (e.g., a CLC layer stack) fabricated using the method 700. The birefringent film stack may include a substrate, and a first birefringent film formed on a surface (e.g., a top surface) of the substrate by dispensing a first composition at the surface of the substrate. The first composition may include a cholesteric mixture or composition described above in connection with Step 710 and FIGS. 5D-5F. The first composition may be processed (e.g., cured, dried, and/or subjected to a polarized light irradiation) to form the first birefringent film, as described above in connection with Step 710 and FIGS. 5D-5F. The birefringent film stack may include a first barrier film formed on the first birefringent film by dispensing a second composition at a surface (e.g., a top surface) of the first birefringent film. The second composition may be processed (e.g., cured, dried, and/or subjected to a light irradiation, etc.) to form the first barrier film. The birefringent film stack may include a second birefringent film formed on the first barrier film by dispensing a third composition at a surface (e.g., a top surface) of the first barrier film. The third composition may be similar to the first composition, and the third composition may be processed to form the second birefringent film in a manner similar to that in which the first composition is processed to form the first birefringent film. The birefringent film stack may include a second barrier film formed on the second birefringent film by dispensing a fourth composition at a surface (e.g., a top surface) of the second birefringent film. The fourth composition may be similar to the second composition, and may be processed (e.g., cured, dried, and/or subjected to a light irradiation, etc.) in a similar manner to form the second barrier film.

In some embodiments, the birefringent film stack may include a third birefringent film formed on the second barrier film by dispensing a fifth composition at a surface (e.g., a top surface) of the second barrier film. The fifth composition may be processed in a manner similar to that in which the first composition to form the third birefringent film. In some embodiments, the birefringent film stack may include a third barrier film formed on the third birefringent film by dispensing a sixth composition at a surface (e.g., a top surface) the third birefringent film. The sixth composition may be similar to the second composition, and may be processed in a manner similar to that in which the second composition is processed, to form the third barrier film. In some embodiments, the birefringent film stack may include a fourth birefringent film formed by dispensing a seventh composition at a surface (e.g., a top surface) of the third barrier film. The seventh composition may be similar to the first composition, and may be processed in a manner similar to that in which the first composition is processed, to form the fourth birefringent film. In some embodiments, the birefringent film stack may include a fourth barrier film formed by dispensing an eighth composition at a surface (e.g., a top surface) of the fourth birefringent film. The eighth composition may be similar to the second composition, and may be processed in a manner similar to that in which the second composition is processed, to form the fourth barrier film. The birefringent film stack fabricated using the disclosed fabrication method 700 may include additional alignment structures, birefringent films, and barrier films formed based on the disclosed processes. The birefringent film stack 550, 551, and 552 may be examples of the products fabricated using the fabrication method 700 and variations of the method 700, which include additional steps to fabricate additional layers, films, or structures.

For discussion purposes, in the above description of the disclosed fabrication methods and the birefringent film stacks obtained by the disclosed fabrication methods, a CLC layer stack is used as an example of the birefringent film stack, and CLC layers are used as examples of the birefringent films. A fabricated birefringent film stack may function as a CLC optical element or component. The disclosed fabrication methods may also be used to fabricate birefringent film stacks other than CLC layer stacks, all of which are within the scope of the present disclosure. Any suitable birefringent film stacks may be fabricated using the disclosed fabrication methods. For example, the disclosed fabrication methods may be used to fabricate a birefringent film stack, where each birefringent film may be one of a CLC film, a Pancharatnam Berry Phase (“PBP”) film, a polarization volume hologram (“PVH”) film, a uniaxial or biaxial compensation film (e.g., A-plate, C-plate, O-plate), or a retardation film (e.g., with half-wave retardance, quarter-wave retardance), etc. One or more barrier films may be formed alternatingly with the birefringent films to separate the birefringent films, such that diffusion, interactions, and/or interference between adjacent birefringent films (and/or a birefringent film and an alignment structure) may be reduced or suppressed. The birefringent film stack fabricated using the disclosed method may function as a CLC optical element, a PBP optical element, a PVH optical element, a broadband quarter-wave plate or half-wave plate, or any combination thereof.

For example, in some embodiments, the birefringent film stack may include one more CLC layers stacked with one or more compensation films and one or more barrier films. A barrier film may be formed between two adjacent birefringent films (e.g., between CLC layers, between a CLC layer and a compensation film, or between compensation films). The compensation films may improve the optical performance of the CLC layers. For example, one or more 0-plates may be stacked with one or more CLC layers and one or more barrier films to improve the off-axis incidence angle performance of the birefringent film stack.

In some embodiments, the birefringent film stack may include one or more PBP or PVH films stacked with one or more retardation films and one or more barrier films. A barrier film may be formed between two adjacent birefringent films (e.g., between PBP or PVH films, between a PBP or PVH film and a retardation film, or between retardation films) to separate the birefringent films. For example, one or more retardation films with quarter-wave retardance or half-wave retardance may be stacked with one or more PBP or PVH films and one or more barrier films. In some embodiments, the birefringent film stack may include one or more PBP or PVH films stacked with one or more retardation films, one or more compensation films, and one or more barrier films. A barrier film may be formed between two adjacent birefringent films, e.g., between PBP or PVH films, between a PBP or PVH film and a retardation film, between retardation films, between compensation films, between a PBP or PVH film and a compensation film, or between a retardation film and a compensation film.

In some embodiments, the birefringent film stack may include one or more retardation film (e.g., with half-wave retardance, quarter-wave retardance) stacked with one or more compensation films and one or more barrier films. A barrier film may be formed between two adjacent birefringent films (e.g., between retardation films, between compensation films, or between a retardation film and a compensation film). For example, one or more A-plates may be stacked with one or more retardation films and one or more barrier films to form broadband quarter-wave plate or half-wave plate.

For discussion purposes, a PBP optical element is used as an example of the birefringent film stack that may be manufactured based on the disclosed method. The PBP optical element may be a PBP lens stack including a plurality of PBP lenses, a PBP grating stack including a plurality of PBP gratings, or a PBP prism stack including a plurality of PBP prisms, etc. In some embodiments, the birefringent film stack may include at least two birefringent films (e.g., at least two PBP layers or films), each of which may have a spatially varying optic axis in a plane perpendicular to a propagating direction of a light. Such a plane may also be referred to as a transverse plane. The spatially varying optic axis in the transverse plane may also be referred to as an “in-plane” varying optic axis. A rotation, direction, or orientation in the transverse plane may be referred to as an “in-plane” rotation, direction, or orientation. The birefringent film may include nematic LCs, or chiral nematic LCs (or LCs with chiral dopant). The spatially varying optic axis of the birefringent film may be realized by spatially varying directors of LC molecules (or LC directors) in the transverse plane. For example, the LC directors in the transverse plane may be configured to have periodic linear orientations, periodic radial orientations, periodic azimuthal orientations, or a combination thereof. Accordingly, the optic axis of the birefringent film may be configured to have a periodic linear orientation, a periodic radial orientation, a periodic azimuthal orientation, or a combination thereof within the birefringent film.

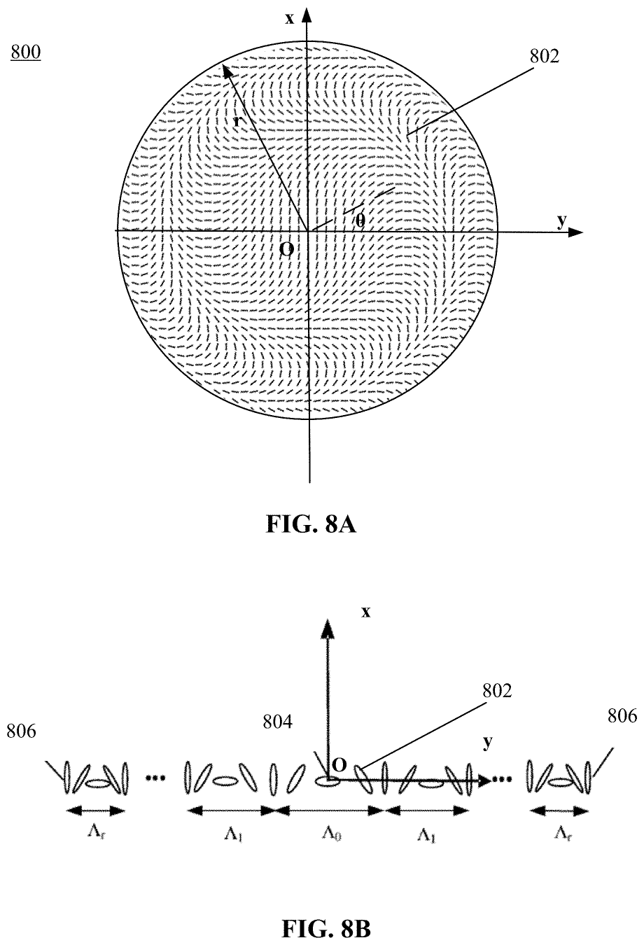

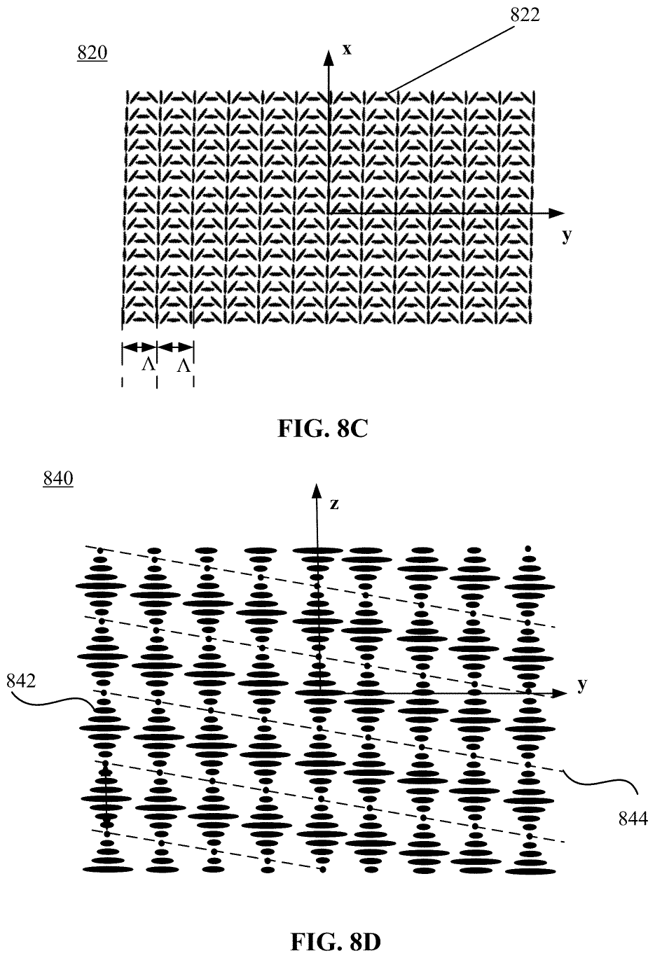

For illustrative purposes, FIGS. 8A-8D schematically illustrate sectional views of various orientations of LC directors in a birefringent film according to embodiments of the present disclosure. The z-axis direction is a propagating direction of a light. FIG. 8A schematically illustrates an x-y sectional view of orientations of LC directors in a birefringent film 800, according to an embodiment of the present disclosure. FIG. 8B illustrates of orientations of LC directors in a portion of the birefringent film 800 shown in FIG. 8A, according to an embodiment of the disclosure. The birefringent film 800 may function as a PBP element (e.g., a PBP lens). As shown in FIGS. 8A and 8B, the birefringent film 800 may be configured to provide a lens profile based on the in-plane orientations of directors of LC molecules 802, in which the phase difference may be T=2θ, where θ is the angle between the orientation of the director of the LC molecule 802 and the y-axis direction. The orientations of the directors of the LC molecules 802 may vary continuously from a center (0) 804 to an edge 806 of the birefringent film 800, with a variable pitch Λ. A pitch is defined as a distance between the LC molecules 802, in which the director of the LC molecule 802 is rotated by about 180° from an initial state. The pitch (Λ₀) at the center 804 may be the largest, and the pitch (Λᵣ) at the edge 806 may be the smallest, i.e., Λ₀>Λ₁> . . . >Λᵣ. In the x-y plane, when the birefringent film 800 functions as a PBP lens with a lens radius (r) and a lens focus (+/−f), the angle θ may satisfy

$$θ = \frac{π {r}^{2}}{2 f λ} ,$$

where λ is the wavelength of an incident light. The continuous in-plane rotation of the directors of the LC molecule 802 may accelerate from the center (O) 804 of the birefringent film 800 toward the edge 806, such that the period of the obtained periodic structure (e.g., pitch) may decrease.

The birefringent film 800 may function as a passive PBP lens 800 having two optical states: a focusing state and a defocusing state. The optical state of the passive PBP lens 800 may depend on the handedness of a circularly polarized light incident onto the passive PBP lens 800 and the handedness of the rotation of the directors of the LC molecule 802 in the birefringent film 800. In some embodiments, the passive PBP lens 800 may operate in a focusing state in response to an RHCP input light and may have a positive focus of ‘f’, and operate in a defocusing state in response to an LHCP input light and may have a negative focus of ‘−f.’ In addition, the passive PBP lens 800 may reverse the handedness of a circularly polarized light transmitted through the passive PBP lens 800 in addition to focusing/defocusing the light. In some embodiments, the passive PBP lens 800 may operate in a defocusing state in response to an LHCP input light, and operate in a focusing state in response to an RHCP input light.

FIG. 8C schematically illustrates an x-y sectional view of orientations of directors of LC molecules 822 in a portion of a birefringent film 820, according to an embodiment of the present disclosure. The birefringent film 820 may function as a transmissive PBP grating 820. As shown in FIG. 8C, the orientations of the directors of the LC molecules 822 may vary periodically and linearly along an in-plane direction (e.g., a y-axis direction in FIG. 8C). The in-plane orientations of the directors of the LC molecules 822 may vary in a linearly repetitive pattern along the y-axis direction with a uniform pitch Λ. The pitch Λ of the PBP grating 820 may be half of the distance along the y-axis between repeated portions of the pattern. The pitch Λ may determine, in part, the optical properties of PBP grating 820. For example, a circularly polarized light incident along the optical axis (e.g., z-axis) of the PBP grating 820 may have a grating output including primary, conjugate, and leakage light corresponding to diffraction orders m=+1, −1, and 0, respectively. The pitch Λ may determine the diffraction angles of the diffracted light in the different diffraction orders. In some embodiments, the diffraction angle for a given wavelength of light may increase as the pitch Λ decreases.

In some embodiments, the PBP grating 820 may be a passive PBP grating having (or configurable to operate in) two optical states, a positive state and a negative state. The optical state of the PBP grating 820 may depend on the handedness of a circularly polarized input light and the handedness of the directors of the LC molecules 822 in the PBP grating 820. For example, the PBP grating 820 may operate in a positive state in response to an RHCP input light, and may diffract the RHCP input light at a specific wavelength to a positive angle (e.g., +0). The PBP grating 820 may operate in a negative state in response to an LHCP input light, and may diffract the LHCP input light at a specific wavelength to a negative angle (e.g., −0). In addition, the PBP grating 820 may reverse the handedness of a circularly polarized light transmitted through the PBP grating 820 in addition to diffracting the light. In some embodiments, the PBP grating 820 may operate in a positive state in response to an LHCP input light, and operate in a negative state in response to an RHCP input light. For an unpolarized input light at a specific wavelength, the PBP grating 820 may diffract an RHCP component and an LHCP component of the unpolarized input light to a positive angle (e.g., +0) and a negative angle (e.g., −θ), respectively. Thus, the PBP grating 820 may function as a circular polarization beam splitter. In some embodiments, a twist structure may be introduced along the thickness direction of the PBP grating 820 and compensated for by its mirror twist structure, which enables the PBP LC grating to have achromatic performance.

FIG. 8D schematically illustrates a y-z sectional view of orientations of directors of LC molecules 842 in a portion of a birefringent film 840, according to an embodiment of the present disclosure. The birefringent film 840 may include chiral nematic liquid crystals, and may function as a reflective PBP grating 840. The x-y sectional view of orientations of directors of the LC molecules 842 in the birefringent film 840 may be similar to the x-y sectional view of orientations of directors of the LC molecules 822 in the birefringent film 820 shown in FIG. 8C. That is, the in-plane orientations of the directors of the LC molecules 842 may vary in a linearly repetitive pattern along the y-axis direction with a uniform pitch Λ. The reflective PBP grating 840, due to its physical properties, may also be referred to as a reflective polarization volume grating (“PVG”) (e.g., a PVH grating). As shown in FIG. 8D, the orientations of the directors of the LC molecules 842 may twist in a helical fashion along a direction (e.g., the z-axis direction in FIG. 8D) perpendicular to a surface of the birefringent film 840. Such orientations of the directors of the LC molecules 842 may result in periodic and slanted planes 844 in the birefringent film 840, each of which may have a substantially same constant refractive index. In other words, the LC molecules 842 from different layers of LC molecules 842 having the same orientations of the directors may form slanted periodic planes 844 of a substantially same constant refractive index within the birefringent film 840.

Different from the transmissive PBP grating that diffracts an input light via modulating the phase of the input light, the reflective PVG 840 may diffract an input light through Bragg reflection (or slanted multiplayer reflection). The reflective PVG 840 may primarily diffract a circularly polarized light having a handedness that is the same as the handedness of the helical structure of the reflective PVG 840, and primarily transmit a light having other polarizations without changing the polarization of the transmitted light. For example, when a circularly polarized input light has a handedness that is opposite to the handedness of the helical structure of the reflective PVG 840, the input light may be primarily transmitted to the 0-th order, and the polarization of the transmitted light may be substantially retained (e.g., unaffected). The diffraction efficiency of the reflective PVG 840 may be a function of the thickness of the PVG 840. For example, the diffraction efficiency of the reflective PVG 840 may increase monotonically with the thickness and then gradually saturate (e.g., remain substantially constant).

Each of the birefringent films (e.g., PBP films) shown in FIGS. 8A-8D may be used as an embodiment of the birefringent film described above in connection with FIGS. 2A-2F, FIGS. 4A-4D, and FIGS. 5A-5F, FIG. 6, and FIG. 7. In other words, each of the birefringent films shown in FIGS. 8A-8D may be used to fabricate a PBP layer stack, in a manner similar to those described above. Similar to the birefringent film stacks shown in FIGS. 5A-5F, the PBP layer stack may include one or more barrier films alternatingly formed with the plurality of PBP layers. The PBP layer stack may function as a PBP lens stack (or a PBP lens assembly), a PBP grating stack, a PBP prism stack, etc.

Optical components or devices including a birefringent film stack in accordance with an embodiment of the present disclosure have with various applications in a number of fields, which are all within the scope of the present disclosure. For example, such optical components may be used as polarization management components, brightness enhancement components, display resolution enhancement components, optical path-folding components, eye-tracking components, accommodation components for multiple focus or variable focus, pupil steering elements, etc. Some exemplary applications in augmented reality (“AR”), virtual reality (“VR”), mixed reality (“MR)” fields or some combinations thereof will be explained below. Near-eye displays (“NEDs”) have been widely used in a large variety of applications, such as aviation, engineering, science, medicine, computer gaming, video, sports, training, and simulations. One application of NEDs is to realize VR, AR, MR or some combination thereof. Desirable characteristics of NEDs include compactness, light weight, high resolution, large field of view (“FOV”), and small form factor. An NED may include a display element configured to generate an image light and a lens system configured to direct the image light toward eyes of a user. The lens system may include a plurality of optical elements, such as lenses, waveplates, reflectors, etc., for focusing the image light to the eyes of the user. To achieve a compact size and light weight and to maintain satisfactory optical characteristics, an NED may adopt a pancake lens assembly in the lens system to fold the optical path, thereby reducing a back focal distance in the NED.

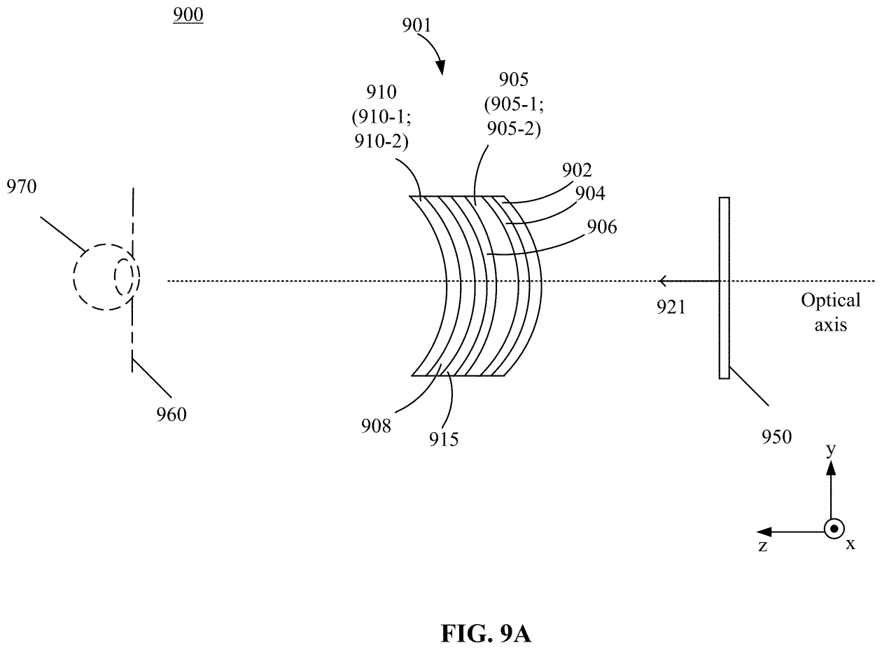

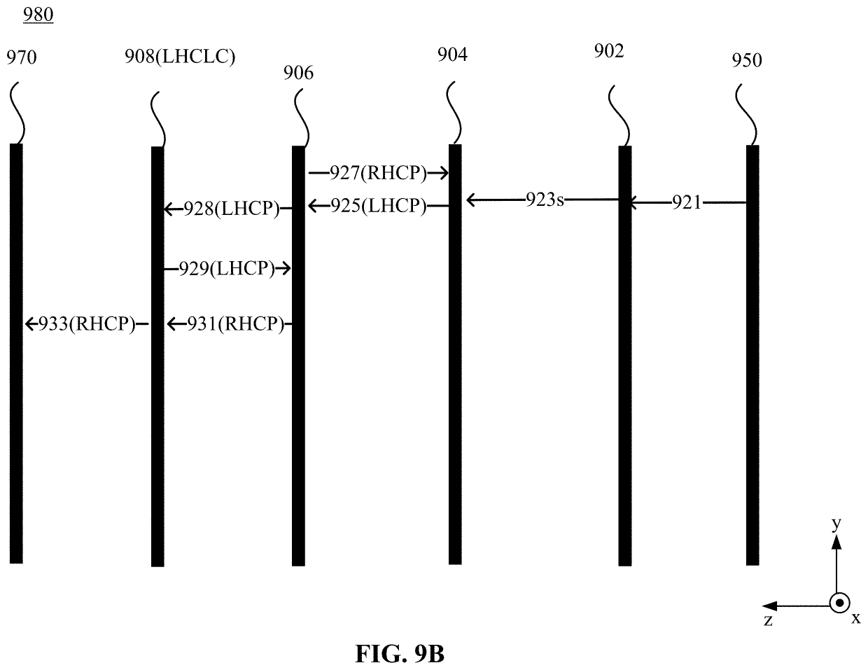

FIG. 9A illustrates a schematic diagram of an optical system 900 according to an embodiment of the present disclosure. The optical system 900 may include a pancake lens assembly 901 according to an embodiment of the present disclosure. The pancake lens assembly 901 may be implemented in an NED to fold the optical path, thereby reducing the back focal distance in the NED. As shown in FIG. 9A, the pancake lens assembly 901 may focus a light 921 emitted from an electronic display 950 (which may be other suitable light source) to an eye-box located at an exit pupil 960. Hereinafter, the light 921 emitted by the electronic display 950 for forming images is also referred to as an “image light.” The exit pupil 960 may be at a location where an eye 970 is positioned in an eye-box region when a user wears the NED. In some embodiments, the electronic display 950 may be a monochromatic display that includes a narrowband monochromatic light source (e.g., a 30-nm-bandwidth light source). In some embodiments, the electronic display 950 may be a polychromatic display (e.g., a red-green-blue (“RGB”) display) that includes a broadband polychromatic light source (e.g., 300-nm-bandwidth light source covering the visible wavelength range). In some embodiments, the electronic display 950 may be a polychromatic display (e.g., an RGB display) including a stack of a plurality of monochromatic displays, which may include corresponding narrowband monochromatic light sources respectively.

In some embodiments, the pancake lens assembly 901 may include a first optical element 905 and a second optical element 910. In some embodiments, the pancake lens assembly 901 may be configured as a monolithic pancake lens assembly without any air gaps between optical elements included in the pancake lens assembly. In some embodiments, one or more surfaces of the first optical element 905 and the second optical element 910 may be shaped (e.g., curved) to compensate for field curvature. In some embodiments, one or more surfaces of the first optical element 905 and/or the second optical element 910 may be shaped to be spherically concave (e.g., a portion of a sphere), spherically convex, a rotationally symmetric asphere, a freeform shape, or some other shape that can mitigate field curvature. In some embodiments, the shape of one or more surfaces of the first optical element 905 and/or the second optical element 910 may be designed to additionally compensate for other forms of optical aberration. The disclosed birefringent film stack may be formed on one or more curved surfaces of at least one of the first optical element 905 or the second optical element 910. In some embodiments, one or more of the optical elements within the pancake lens assembly 901 may have one or more coatings, such as an anti-reflective coating, to reduce ghost images and enhance contrast. In some embodiments, the first optical element 905 and the second optical element 910 may be coupled together by an adhesive 915. Each of the first optical element 905 and the second optical element 910 may include one or more optical lenses. In some embodiments, at least one of the first optical element 905 or the second optical element 910 may have at least one flat surface. Birefringent film stacks disclosed herein may be formed on the flat surface(s) of at least one of the first optical element 905 or the second optical element 910.

The first optical element 905 may include a first surface 905-1 facing the electronic display 950 and an opposing second surface 905-2 facing the eye 970. The first optical element 905 may be configured to receive an image light at the first surface 905-1 from the electronic display 950 and output an image light with an altered property at the second surface 905-2. The pancake lens assembly 901 may also include a linear polarizer 902, a waveplate 904, and a mirror 906 arranged in an optical series, each of which may be an individual layer, film, or coating disposed at (e.g., bonded to or formed at) the first optical element 905. The linear polarizer 902, the waveplate 904, and the mirror 906 may be disposed at (e.g., bonded to or formed at) the first surface 905-1 or the second surface 905-2 of the first optical element 905. For discussion purposes, FIG. 9A shows that the linear polarizer 902 and the waveplate 904 are disposed at (e.g., bonded to or formed at) the first surface 905-1, and the mirror 906 is disposed at (e.g., bonded to or formed at) the second surface 905-2. Other arrangements are also contemplated.

In some embodiments, the waveplate 904 may be a quarter-wave plate (“QWP”). A polarization axis of the waveplate 904 may be oriented relative to the polarization direction of the linearly polarized light to convert the linearly polarized light to a circularly polarized light or vice versa for a visible spectrum and/or an IR spectrum. In some embodiments, for an achromatic design, the waveplate 904 may include a multilayer birefringent material (e.g., polymer, liquid crystals, or a combination thereof) to produce quarter-wave birefringence across a wide spectral range. For example, an angle between the polarization axis (e.g., the fast axis) of the waveplate 904 and the transmission axis of the linear polarizer 902 may be configured to be in a range of about 35-50 degrees. In some embodiments, for a monochrome design, an angle between the polarization axis (e.g., the fast axis) of the waveplate 904 and the transmission axis of the linear polarizer 902 may be configured to be about 45 degrees. In some embodiments, the mirror 906 may be a partial reflector that is partially reflective to reflect a portion of a received light. In some embodiments, the mirror 906 may be configured to transmit about 50% and reflect about 50% of a received light, and may be referred to as a “50/50 mirror.” In some embodiments, the handedness of the reflected light may be reversed, and the handedness of the transmitted light may remain unchanged.

The second optical element 910 may have a first surface 910-1 facing the first optical element 905 and an opposing second surface 910-2 facing the eye 970. The pancake lens assembly 901 may also include a reflective polarizer 908, which may be an individual layer, film, or coating disposed at (e.g., bonded to or formed at) the second optical element 910. The reflective polarizer 908 may be disposed at (e.g., bonded to or formed at) the first surface 910-1 or the second surface 910-2 of the second optical element 910 and may receive a light output from the mirror 906. For discussion purposes, FIG. 9A shows that the reflective polarizer 908 is disposed at (e.g., bonded to or formed at) the first surface 910-1 of the second optical element 910. That is, the reflective polarizer 908 may be disposed between the first optical element 905 and the second optical element 910. For example, the reflective polarizer 908 may be disposed between the second surface 910-2 of the second optical element 910 and the adhesive layer 915. In some embodiments, the reflective polarizer 908 may be disposed at the first surface 910-1 of the second optical element 910.

The reflective polarizer 908 may include a reflective polarizing film (e.g., a CLC polarizing film) configured to primarily reflect a received light of a first polarization and primarily transmit a received light of a second polarization. The reflective polarizer 908 may be any embodiment of the reflective polarizer based on the birefringent film stack described above, such as the CLC layer stack 500, 501, 502, 550, 551, or 552, or an embodiment including a combination of one or more features from the CLC layer stack 500, 501, 502, 550, 551, or 552. Accordingly, the optical performance and reliability of the pancake lens assembly 801 may be significantly improved.

Referring to FIG. 9A, in some embodiments, the image light 921 emitted from the electronic display 950 may be an unpolarized light. The linear polarizer 902 and the waveplate 904 may be replaced by a circular polarizer, which may be configured to the convert the unpolarized light to a circularly polarized light, and direct the circularly polarized light toward the mirror 906. In some embodiments, the image light 921 emitted from the electronic display 950 may be a linearly polarized light, and the linear polarizer 902 may be omitted. A polarization axis of the waveplate 904 may be oriented relative to the polarization direction of the linearly polarized light to convert the linearly polarized light to a circularly polarized light or vice versa for a visible spectrum and/or an IR spectrum.

The pancake lens assembly 901 shown in FIG. 9A is merely for illustrative purposes. In some embodiments, one or more of the first surface 905-1 and the second surface 905-2 of the first optical element 905 and the first surface 910-1 and the second surface 910-2 of the second optical element 910 may be curved surface(s) or flat surface(s). In some embodiments, the pancake lens assembly 901 may have one optical element or more than two optical elements. In some embodiments, the pancake lens assembly 901 may further include other optical elements in addition to the first and second optical elements 905 and 910, such as one or more linear polarizers, one or more waveplate, one or more circular polarizers, etc.

FIG. 9B illustrates a schematic cross-sectional view of an optical path 980 of a light propagating in the pancake lens assembly 901 shown in FIG. 9A, according to an embodiment of the present disclosure. In the light propagation path 980, the change of polarization of the light is shown. Thus, the first optical element 905 and the second optical element 910, which are presumed to be lenses that do not affect the polarization of the light, are omitted for the simplicity of illustration. In FIG. 9B, the character “s” denotes that the corresponding light is s-polarized, RHCP and LHCP denote right-handed circularly polarized light and left-handed circularly polarized light, respectively. For discussion purposes, as shown in FIG. 9B, the linear polarizer 902 may be configured to transmit an s-polarized light and block a p-polarized light, and the reflective polarizer 908 may be a left-handed CLC (“LHCLC”) reflective polarizer. For illustrative purposes, the electronic display 950, the linear polarizer 902, the waveplate 904, the mirror 906, and the reflective polarizer 908 are illustrated as flat surfaces in FIG. 9B. In some embodiments, one or more of the electronic display 950, the linear polarizer 902, the waveplate 904, the mirror 906, and the reflective polarizer 908 may include a curved surface.

As shown in FIG. 9B, the electronic display 950 may generate the unpolarized image light 921 covering a predetermined spectrum, such as a portion of the visible spectral range or substantially the entire visible spectral range. The unpolarized image light 921 may be transmitted by the linear polarizer 902 as an s-polarized image light 923s, which may be transmitted by the waveplate 904 as an LHCP light 925. A first portion of the LHCP light 925 may be reflected by the mirror 906 as an RHCP light 927 toward the waveplate 904, and a second portion of the LHCP light 925 may be transmitted as an LHCP light 928 toward the CLC reflective polarizer 908. The LHCP light 928 incident onto the CLC reflective polarizer 908 may have the same handedness (e.g., the left handedness) as that of the helical twist structure of the CLC reflective polarizer 908. The LHCP light 928 may be reflected by the CLC reflective polarizer 908 as an LHCP light 929 toward the mirror 906. The LHCP light 929 may be reflected by the mirror 906 as an RHCP light 931, which may be transmitted through the CLC reflective polarizer 908 as an RHCP light 933. The RHCP light 933 may be focused onto the eye 970.

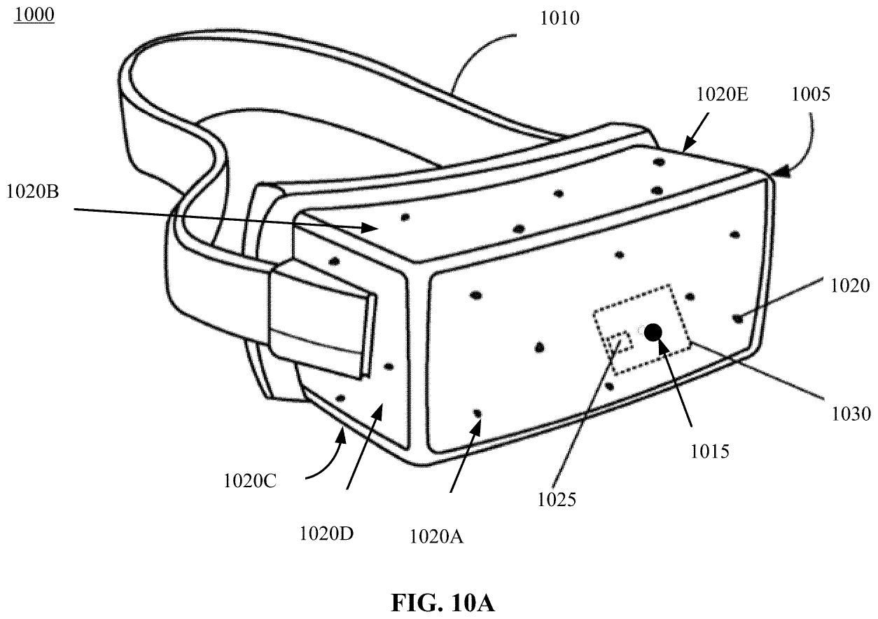

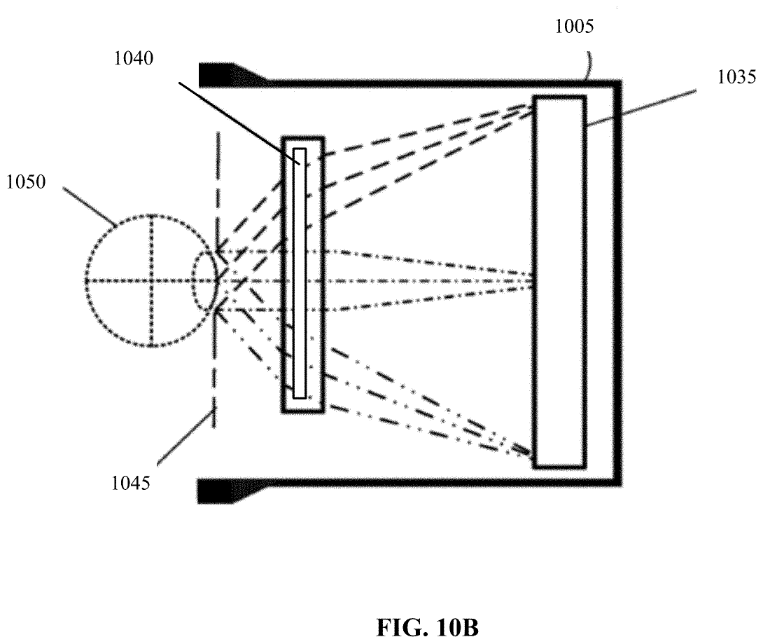

FIG. 10A illustrates a diagram of a near-eye display (“NED”) 1000, according to an embodiment of the present disclosure. As shown in FIG. 10A, the NED 1000 may include a front body 1005 and a band 1010. The front body 1005 may include one or more electronic display elements of an electronic display and one or more optical elements (not shown in detail in FIG. 10A), an inertial measurement unit (“IMU”) 1030, one or more position sensors 1025, and one or more locators 1020. In the embodiment shown in FIG. 10A, the one or more position sensors 1025 may be located within the IMU 1030. The locators 1020 may be located at various positions on the front body 1005 relative to a reference point 1015. In the embodiment shown in FIG. 10A, the reference point 1015 may be located at the center of the IMU 1030, or at any other suitable location. The locators 1020, or some of the locators 1020, may be located on a front side 1020A, a top side 1020B, a bottom side 1020C, a right side 1020D, and a left side 1020E of the front body 1005.

FIG. 10B is a cross-sectional view of a front body of the NED 1000 shown in FIG. 10A. As shown in FIG. 10B, the front body 1005 may include an electronic display 1035 and a pancake lens assembly 1040 configured to provide altered image lights to an exit pupil 1045. In some embodiments, the pancake lens assembly 1040 may be a pancake lens assembly in accordance with an embodiment of the present disclosure, such as the pancake lens assembly 901 in FIG. 9A. The exit pupil 1045 may be at a location of the front body 1005 where an eye 1050 of the user may be positioned. In some embodiments, the NED 1000 may include an eye-tracking device configured to track a position of the eye of the user. For example, the eye-tracking device may include a PBP grating stack or a CLC grating stack. In some embodiments, the NED may include a varifocal block configured to adjust a focal distance in accordance with instructions from the NED 1000 to, e.g., mitigate vergence accommodation conflict of eyes of the user. In some embodiments, the varifocal block may include a PBP lens stack. For illustrative purposes, FIG. 10B shows a cross-section of the front body 1005 associated with a single eye 1050, while another electronic display, separate from the electronic display 1035, may provide image lights altered by another pancake lens assembly, separate from the pancake lens assembly 1035, to another eye of the user.

The foregoing description of the embodiments of the disclosure have been presented for the purpose of illustration. It is not intended to be exhaustive or to limit the disclosure to the precise forms disclosed. Persons skilled in the relevant art can appreciate that modifications and variations are possible in light of the above disclosure.

Some portions of this description may describe the embodiments of the disclosure in terms of algorithms and symbolic representations of operations on information. These operations, while described functionally, computationally, or logically, may be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Embodiments of the disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Further, when an embodiment illustrated in a drawing shows a single element, it is understood that the embodiment or another embodiment not shown in the figures but within the scope of the present disclosure may include a plurality of such elements. Likewise, when an embodiment illustrated in a drawing shows a plurality of such elements, it is understood that the embodiment or another embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. An optical device, comprising:
a first birefringent film formed on a substrate;
a first barrier film formed on the first birefringent film; and
a second birefringent film formed on the first barrier film,
wherein the first birefringent film includes a first birefringent material, and
wherein the second birefringent film includes a second birefringent material.

2. The optical device of claim 1, further comprising an alignment structure formed between the first barrier film and the second birefringent film, wherein the alignment structure is configured to provide a predetermined alignment pattern, and optically anisotropic molecules of the second birefringent film are at least partially aligned in the predetermined alignment pattern.

3. The optical device of claim 1, further comprising an alignment structure formed between the first birefringent film and the substrate, wherein the alignment structure is configured to provide a predetermined alignment pattern, and optically anisotropic molecules of the first birefringent film are at least partially aligned in the predetermined alignment pattern.

4. The optical device of claim 1, wherein the first barrier film includes at least one of a water-borne barrier coating, a solvent-based barrier coating, a sol-gel barrier coating, or a solventless barrier coating.

5. The optical device of claim 1, wherein the first barrier film is an organic film, an inorganic film, or an organic-inorganic hybrid film.

6. The optical device of claim 1, wherein at least one of the first birefringent film or the second birefringent film is a liquid crystal polymer (“LCP”) film.

7. The optical device of claim 6, wherein the LCP film is at least one of a cholesteric liquid crystal film, a Pancharatnam Berry Phase film, a polarization volume hologram film, a compensation film, or a retardation film.

8. The optical device of claim 7, wherein the LCP film includes at least one of polymerized liquid crystals (“LCs”), polymer-stabilized LCs, or photopolymers.

9. The optical device of claim 8, wherein the LCs include at least one of nematic LCs, twist-bend LCs, chiral nematic LCs, or smectic LCs.

10. The optical device of claim 1, further comprising a second barrier film formed on the second birefringent film.

11. The optical device of claim 1, wherein optically anisotropic molecules of at least one of the first birefringent film or the second birefringent film have a photo-induced orientational pattern.

12. A method for fabricating an optical device, comprising:
dispensing a first composition on a substrate and polymerizing the first composition to form a first birefringent film on the substrate, the first birefringent film including a first birefringent material;
dispensing a second composition to form a first barrier film on the first birefringent film; and
dispensing a third composition on the first barrier film and polymerizing the third composition to form a second birefringent film on the first barrier film, the second birefringent film including a second birefringent material.

13. The method of claim 12, further comprising:
prior to dispensing the first composition to form the first birefringent film, dispensing a fourth composition to form a first alignment structure on the substrate,
wherein the first alignment structure is configured to provide a first predetermined alignment pattern,
wherein the first birefringent film is formed on the first alignment structure, and
wherein optically anisotropic molecules of the first birefringent material are at least partially aligned in the first predetermined alignment pattern.

14. The method of claim 13, further comprising:
prior to dispensing the third composition to form the second birefringent film, dispensing a fifth composition to form a second alignment structure on the first barrier film,
wherein the second alignment structure is configured to provide a second predetermined alignment pattern,
wherein the second birefringent film is formed on the second alignment structure, and
wherein optically anisotropic molecules of the second birefringent material are at least partially aligned in the second predetermined alignment pattern.

15. The method of claim 12, wherein dispensing the second composition to form the first barrier film on the first birefringent film comprises:
forming at least one of a water-borne barrier coating, a solvent-based barrier coating, a sol-gel barrier coating, or a solventless barrier coating on the first birefringent film.

16. The method of claim 12, wherein at least one of the first birefringent film or the second birefringent film is a liquid crystal polymer (“LCP”) film.

17. The method of claim 12, wherein dispensing the first composition on the substrate and polymerizing the first composition to form the first birefringent film on the substrate comprises:
coating a thin layer of the first composition on a surface of the substrate; and
polymerizing the thin layer of the first composition to form the first birefringent film.

18. The method of claim 17, wherein dispensing the second composition to form the first barrier film on the first birefringent film comprises:
after polymerizing the thin layer of the first composition to form the first birefringent film, coating a thin layer of the second composition on the first birefringent film, wherein the second composition is an organic coating composition; and
polymerizing the thin layer of the second composition to form the first barrier film prior to dispensing the third composition to form the second birefringent film.

19. The method of claim 12, further comprising:
dispensing a thin layer of a fourth composition on the second birefringent film, wherein the fourth composition is an organic coating composition;
polymerizing the thin layer of the fourth composition to form a second barrier film on the second birefringent film;
dispensing a fifth composition on the second barrier film; and
polymerizing the fifth composition to form a third birefringent film on the second barrier film.

20. The method of claim 12, wherein dispensing the first composition on the substrate and polymerizing the first composition to form the first birefringent film on the substrate comprises:
coating a thin layer of the first composition including a polarization sensitive material, wherein the polarization sensitive material is initially isotropic before being exposed to a polarized light irradiation and exhibits an induced optical anisotropy after being exposed to the polarized light irradiation; and
exposing the thin layer of the first composition to the polarized light irradiation to form the first birefringent film having anisotropic molecules arranged in a photo-induced orientational pattern.
